(19) United States
(12) Patent Application Publication
(10) Pub. No.: US 2025/0360741 A1
(43) Pub. Date: Nov. 27, 2025

(54) COMPOSITION AND USE OF PROGRAMABLE PARTICLES

(71) Applicant: Diametryx Inc., Cambridge, MA (US)

(72) Inventor: Michael J. NATAN, Cambridge, MA (US)

(21) Appl. No.: 18/872,537

(22) PCT Filed: Jun. 6, 2023
(86) PCT No.: PCT/US2023/024544

§ 371 Date: Dec. 6, 2024

Related U.S. Application Data
(60) Provisional application No. 63/349,796, filed on Jun. 7, 2022.

(51) Int. Cl. B41M 3/00; C09D 11/50

(52) U.S. Cl. CPC B41M 3/001; C09D 11/50

(57) ABSTRACT

The present disclosure provides, in part, compositions comprising stimuli-responsive particles and methods of preparing and using the same.

### CROSS-REFERENCE TO RELATED APPLICATIONS

This application claims the benefit of and priority to U.S. Provisional Application No. 63/349,796, filed Jun. 7, 2022, the contents of which are herein incorporated by reference in their entirety.

### FIELD

The present disclosure relates, in part, to compositions comprising orientable multiphasic particles responsive to magnetic fields, methods of preparing the same, and use thereof.

### BACKGROUND

Stimuli responsive nanoparticles and microparticles, which are capable of actively responding to external stimuli such as heat, light, mechanical stress, electrical fields have revolutionized various practical applications of such particles. For example, functionalized chromogenic stimuli-reactive particles, which undergo reversible color switching under an external field, have attracted great attention in the context of developing rewritable paper.

Among stimuli responsive particles, yolk-shell particles have attracted a great deal of attention due to their appealing structures and tunable physical and chemical properties. Yolk-shell particles (YSPs) are a class of hybrid materials including a movable core (yolk) inside a hollow cavity encircled by outer shell(s). The tailorability and functionality of both the yolks and hollow shells make YSPs promising for a range of remarkable applications. The configuration of yolks incorporated into the YSPs can be changed under external fields without any variation in space. This feature makes YSPs promising materials for switchable optical properties without reconfiguration or volume transitions.

There remains a need for hollow YSPs (HYSPs) that exhibit reversible, reusable optical signals properties that can be actuated in many environments, including wide ranges of temperature, in indoor and outdoor spaces, without ancillary equipment, and can be engineered to withstand a high degree of transitions between states, maintain directionality for state changes, and can accommodate a varied repertoire of transitions and effects.

### SUMMARY

Accordingly, the present disclosure provides, in part, compositions comprising a stimuli-responsive yolk-shell particle (HYSP) comprising at least one multiphasic orientable yolk comprising at least two colorants and at least one stimuli-responsive element, and at least one layer of a shell encapsulating the multiphasic orientable yolk, wherein at least a portion of the shell comprises a material that is transparent to at least a portion of the visible electromagnetic spectrum between about 380 nm to about 800 nm, and wherein the multiphasic orientable yolk is configured to move inside the shell in response to an applied force. In embodiments, the applied force is a magnetic field.

In embodiments, the HYSP comprises a dimension of about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, about or at least about 20 μm, or about or at least about 50 μm.

In embodiments, the HYSP comprises a space between the at least one multiphasic orientable yolk and the at least one layer of a shell of about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, or about or at least about 20 μm.

In embodiments, the HYSP comprises a shape, geometry, and/or morphology of one or more of spherical, ellipsoidal, spindle, rodlike, cubic, starlike, cylindrical, plate, tetrahedron, and dodecahedron.

In embodiments, the at least one multiphasic orientable yolk comprises a material comprising one or more of metals, metal oxides, silica, organic polymers, inorganic polymers, biological polymers, synthetic polymers, and combinations thereof.

In embodiments, the one or more synthetic polymers comprises plastics, thermally responsive polymers, latex, hydrocarbons, crude oil derivatives and/or petroleum derivatives. In embodiments, the one or more thermally responsive polymers comprise poloxamers, styrene-butadiene block copolymers, polymethylmethacrylate, polybutylmethacrylate, plasticized polyvinyl chloride, plasticized nylon, plasticized polyethylene terephthalate, polyethylene, polyacrylonitrile, polychlorotrifluoroethylene, poly-4,4′-isopropylidenediphenylene carbonate, polyethylene vinyl ester, polyvinyl chloride-diethyl fumarate, and/or combinations thereof.

In embodiments, the one or more synthetic polymers comprises poly(tert-butyl acrylate)-poly(3-(triethoxysilyl)propyl methacrylate) (PtBA-PTPM), polystyrene latex polymer, carboxylated latex polymer, aminated latex polymer, colored polystyrene polymer (dye-infused and/or pigment-infused), colored polystyrene-based carboxylated latex polymer (dye-infused and/or pigment-infused), fluorescent polystyrene-based polymers, fluorescent polystyrene-based carboxylated latex polymers, fluorescent aminated polystyrene-based polymer, surfactant-free polystyrene, carboxylated surfactant-free polymer, polymethyl methacrylate (PMMA) latex polymer, and/or divinylbenzene (DVB)-crosslinked polystyrene latex polymer.

In embodiments, the one or more biological polymers comprises nucleic acid (DNA, RNA), amino acid (peptide, protein), polysaccharide, and/or lipid. In embodiments, the one or more biological polymers comprise stranded nucleic acids arranged into one or more patterns and/or morphologies, and the one or more stranded nucleic acids are disposed on and/or within the at least one multiphasic yolk.

In embodiments, the at least one multiphasic orientable yolk comprises a dimension of about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, about or at least about 20 μm, or about or at least about 50 μm.

In embodiments, the at least one multiphasic orientable yolk comprises a dimension smaller than the HYSP. In embodiments, the at least one multiphasic orientable yolk comprises a dimension smaller than the HYSP by about or at least about 1 nm, about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 15 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, about or at least about 20 μm, or about or at least about 30 μm, or about or at least about 40 μm.

In embodiments, the at least one multiphasic orientable yolk comprises a structure, shape, geometry, and/or morphology, of one or more of spherical, ellipsoidal, spindle, rodlike, cubic, starlike, cylindrical, plate, regularly shaped, irregularly shaped, triangular, trapezoidal, octagonal, tetrahedron, and dodecahedron.

In embodiments, the at least one multiphasic orientable yolk comprises a Janus particle. In embodiments, the at least one multiphasic orientable yolk comprises one or more magnetic particles contained within a polymer bead.

In embodiments, the at least one multiphasic orientable yolk is coated with a protective coating. In embodiments, the protective coating comprises a chemical functionalization, lubricant, surface treatment, coating, polishing agent, and/or combinations thereof. In embodiments, the protective coating comprises polymeric materials, inorganic oxides, carbon materials, polytetrafluoroethylene (PTFE), hydroxylated self-assembled monolayers, vitreous enamel, ceria (cerium oxide), ceramic, anodized metal, silica, and/or combinations thereof.

In embodiments, the at least one multiphasic orientable yolk comprises a shape, geometry, and/or morphology that fits within a congruent shape, geometry, or morphology of an inner surface of at least one layer of the shell. In embodiments, the shape, geometry, or morphology of the at least one multiphasic orientable yolk comprises a pin that fits within a congruent groove of the at least one layer of shell.

In embodiments, the yolk is suspended in a fluid media, a semi-solid media, non-Newtonian fluid or media, and/or a combination thereof.

In embodiments, the at least one multiphasic orientable yolk is configured to rotate on its own axis upon exposure to a magnetic field. In embodiments, where the at least one multiphasic orientable yolk is suspended within the at least one layer of the shell and configured to move freely in response to a magnetic field.

In embodiments, the at least one multiphasic orientable yolk comprises a solid nanoparticle. In embodiments, the at least one multiphasic orientable yolk comprises a fluid, ferrofluid, semi-solid, and/or non-Newtonian fluid.

In embodiments, the at least one stimuli-responsive element comprises a magnetic material. In embodiments, the magnetic material is ferromagnetic, ferrimagnetic, antiferromagnetic, diamagnetic, paramagnetic, superparamagnetic, and/or antiferromagnetic. In embodiments, the magnetic material is organic, carbon-based, and/or biomolecule-based comprising one or more of tetracyanoethylene (TCNE) salts, [Fe(C5Me5)2]+[TCNE]·—, Li[TCNE], [MnlITPP][TCNE]· (TPP=tetraphenylporphyrin), [FeII(TCNE)(NCMe)2][FeIIICl4], MnII(TCNE)I(OH2), MnII(TCNE)[C4(CN)8]1/2, Fe(TCNE)[C4(CN)8]1/2, MnII(TCNE)3/2(I3)1/2, VII[TCNE]x (x≈2), C7H5CIN3Se4, magnetic organic polymers, and/or polymer-bonded magnets. In embodiments, the magnetic material comprises iron (Fe), cobalt (Co), nickel (Ni), zinc (Zn), manganese (Mn), chromium (Cr), samarium (Sm), alloys or oxides thereof; alloys, intermetallic, and/or oxides of Fe, Co, Ni, Zn, Mn, Sm; oxides are of iron, Fe2O3, FeO, and/or Fe3O4; ferrite material and/or doped materials of Co, Ni, Zn, and/or Mn:FexOy, and/or magnetite.

In embodiments, the magnetic material comprises magnetic particles and/or beads. In embodiments, the magnetic particles and/or beads comprise a dimension of about or at least about 5 nm, about or at least about 10 nm, about or at least about 50 nm, about or at least about 100 nm, about or at least about 500 nm, about or at least about 1 μm, about or at least about 5 μm, about or at least about 10 μm, about or at least about 50 μm, or comprise a range of dimensions from about or at least about 5 nm to about or at least about 50 nm, about or at least about 5 nm to about or at least about 100 nm, about or at least about 5 nm to about or at least about 500 nm, about or at least about 5 rim to about or at least about 1,000 nm, about or at least about 5 nm to about or at least about 2,000 nm, about or at least about 5 nm to about or at least about 5,000 nm, about or at least about 10 nm to about or at least about 5,000 nm, about or at least about 100 nm to about or at least about 5,000 nm, about or at least about 1,000 nm to about or at least about 5,000 nm.

In embodiments, the magnetic material is configured to create a magnetic field of about or at least about 200 gauss, about or at least about 500 gauss, about or at least about 800 gauss, about or at least about 1,000 gauss, about or at least about 2,500 gauss, about or at least about 12,500 gauss, about or at least about 15,000 gauss, about or at least about 20,000 gauss, or about or at least about 25,000 gauss; or a magnetic field having a range of about or at least about 200 gauss to about or at least about 25,000 gauss. In embodiments, the at least one stimuli-responsive element comprises magnetic material configured to be magnetized and/or produce a magnetic field.

In embodiments, the HYSP comprises 2 colorants, 3 colorants, 4 colorants, 5 colorants, 6 colorants, 7 colorants, colorants, colorants, or 10 or more colorants. In embodiments, the at least two colorants comprise a color in the visible electromagnetic spectrum comprising an extinction, absorption, emission, reflectance, scattering, and/or interference at a wavelength from about or at least about 350 nm to about or at least about 800 nm. In embodiments, the color comprises one or more of white, black, red, orange, yellow, green, blue, indigo, violet, and variations of hue, shade, and intensity therebetween.

In embodiments, the at least two colorants comprise a dye, pigment, stain, fluorophore, metallic salt, and/or chromophore.

In embodiments, the at least two colorants comprise one or more dyes. In embodiments, the dye is an organic or inorganic dye. In embodiments, the dye comprises one or more of Rhodamine B, Congo Red, Crystal Violet, Methylene Blue, Acridine Orange, Nile Red, Malachite Green, Eosin Y, Cresol Red, Fluorescein, and Indigo.

In embodiments, the two or more colorants comprises a pigment. In embodiments, the pigment comprises a water-soluble pigment. In embodiments, the water-soluble pigment is one or more of anthocyanin, anthraquinone, carotenoid, violacein, melanin, pyocyanin, prodiginines, asperversin, benzoquinone, anthraquinone, and derivatives thereof.

In embodiments, the pigment comprises one or more of Titanium White (PW6), Zinc White (PW4), Carbon Black (PBk7), Mars Black (PBk11), Iron Oxide Red (PR101), Cadmium Red (PR108), Alizarin Crimson (PR83), Cadmium Orange (PO20), Cadmium Yellow (PY35), Lemon Yellow (PY3), Chromium Green Oxide (PG17), Phthalo Green (PG7), Ultramarine Blue (PB29), Cobalt Blue (PB28), Cerulean Blue (PB35), Prussian Blue (PB27), Burnt Sienna (PBr7), Raw Umber (PBr7), Raw Sienna (PBr7), and Yellow Ochre (PY43).

In embodiments, the pigment is an organic pigment. In embodiments, the pigment is an inorganic pigment.

In embodiments, the organic pigment or inorganic pigment comprises a white pigment. In embodiments, the white pigment is one or more of lead white (2PbCO₃·Pb(OH)₂), kaolin, silica (SiO₂), titanium dioxide (TiO₂/rutile and anatase), zinc oxide (ZnO), zinc sulfide (ZnS), and/or lithopone (ZnS+BaSO₄).

In embodiments, the organic pigment or inorganic pigment comprises a black pigment. In embodiments, black pigment is one or more of coal (charcoal), groutite (α-MnOOH), manganite (γ-MnOOH), hausmannite (Mn₃O₄), carbon black, iron oxide black (Fe₃O₄), and/or spinel black (CuCr₂O₄).

In embodiments, wherein the organic pigment or inorganic pigment comprise a colored pigment.

In embodiments, the colored pigment comprises a yellow pigment. In embodiments, the yellow pigment comprises one or more of yellow ochre (α-FeOOH), auric pigment (As₂S₃), lead ochre (PbO), lead tin yellow (Pb₂SnO₄, PbSn₂SiO₇), Naples yellow (Pb(SbO₃)₂), zinc yellow (Zn₂CrO₄), Indian yellow (C₁₉H₁₆O₁₀), iron oxide yellow (α-FeOOH), chromium titanium yellow ((Ti,Cr,Sb)O₂), nickel titanium yellow ((Ti,Ni,Sb)O₂), lead yellow (PbCrO₄), cadmium yellow (CdS), bismuth yellow (BiVO₄).

In embodiments, the colored pigment comprises a red pigment. In embodiments, the red pigment comprises one or more of red ocher (α-Fe₂O₃), Terra di Siena (α-Fe₂O₃), vermilion (HgS), lead red (Pb₃O₄), alizarin madder varnish, alizarin red (C₁₄H₈O₄), iron oxide red (α-Fe₂O₃), molybdate red (Pb(Cr,S,Mo)O₄), cadmium red (Cd(S,Se)).

In embodiments, the colored pigment comprises a green pigment. In embodiments, the green pigment comprises one or more of green earth (Fe silicates), Schweinfurt green (C₄H₆As₆Cu₄O₁₆), chromium oxide green (Cr₂O₃), chromium oxide hydrate green (CrOOH), cobalt green (Co₂TiO₄).

In embodiments, the colored pigment comprises a blue pigment. In embodiments, the blue pigment comprises one or more of lazurite (lapis lazuli), Egyptian blue (CaCuSi₄O₁₀), azurite (2CuCO₃·Cu(OH)₂), malachite (CuCO₃·Cu(OH)₂), cobalt blue (CoAl₂O₄), ultramarine blue (Na₆Al₆Si₆O₂₄(NaSn)), iron blue (K[Fe^{III}Fe^{III}(CN)₆]·xH₂O).

In embodiments, the colored pigment comprises a brown pigment. In embodiments, the brown pigment comprises one or more of burnt umber (Fe₂O₃·xMnO₂), brown ocher (α-Fe₂O₃+Mn oxides), limonite (mixture of different Fe oxides).

In embodiments, the pigment is one or more of an oxide or oxide hydroxide pigment (TiO₂, ZnO, α-Fe₂O₃, α-FeOOH, γ-Fe₂O₃, Fe₃O₄, Cr₂O₃, CrOOH, PbO, PB304, Mn₃O₄, —MnOOH, Sb₂O₃), a complex oxide pigment (CoAl₂O₄, CuCr₂O₄, Co₂TiO₄, (Ti,Ni,Sb)O₂, (Ti,Cr,Sb)O₂), a carbonate hydroxide pigment (2PbCO₃·Pb(OH)₂, 2CuCO₃·Cu(OH)₂, CuCO₃·Cu(OH)₂), a sulfide/selenide pigment (ZnS, CdS, Cd(S,Se), CdSe, γ-Ce₂S₃, HgS, As₂S₃), a chromate/molybdate pigment (PbCrO₄, Pb(Cr,S)O₄, Pb(Cr,S,Mo)O₄, ZnCrO₄, BaCrO₄, SrCrO₄), a vanadate pigment (BiVO₄, 4BiVO₄·3Bi₂MoO₆), a stannate pigment (Pb₂SnO₄, PbSn₂SiO₇, Co₂SO₄, CoSnO₃), a phosphate pigment (Co₃(PO₄)₂), an antimonate pigment (Pb(SbO₃)₂), an arsenate pigment (Cu(AsO₃)₂), an ultramarine pigment (Na₆Al₆Si₆O₂₄(NaSn)), a hexacyanidoferrate/hexacyanoferrate pigment (K[FeIIIFeII(CN)₆]·χH₂O (χ=14-16)), an oxonitride pigment (CaTaO₂N, LaTaON₂), an elemental-based pigment (C, Al, Cu, Cu/Zn, Au), a spinel-based pigment, and/or a rutile-based metal pigment.

In embodiments, the inorganic pigment is one or more of a transparent effect pigment, goniochromatic pigments, pearlescent pigment, metallic pigment, interference pigment, metallic effect pigment, fluorescent pigment, luminescent pigment, phosphorescent pigment, magnetic pigment, and anticorrosive pigment.

In embodiments, the metallic pigment comprises one or more of aluminum, bronze, and copper metallic pigment.

In embodiments, the pearlescent pigment comprises one or more of mica, titanium dioxide, and bismuth oxychloride.

In embodiments, the fluorescent pigment comprises one or more fluorescent dye and pigment comprising a fluorescent mineral.

In embodiments, the phosphorescent pigment comprises zinc sulfide and/or strontium aluminate.

In embodiments, the interference pigment comprises titanium dioxide-coated mica and/or aluminum oxide-coated mica.

In embodiments, the two or more colorants comprises an anisotropic particle.

In embodiments, the anisotropic particle comprises a nanoparticle of the one or more metals, optionally comprising a nanorod of one or more of gold (Au), silver (Au), and aluminum (AI).

In embodiments, the one or more colorants comprises a plasmonic material. In embodiments, the plasmonic material comprises a pigment, particle, foil, and/or film. In embodiments, the film comprises a polymer-film loaded with noble metal nanoparticles.

In embodiments, the goniochromatic pigment comprises aluminum coated with magnesium fluoride embedded in chromium.

In embodiments, the at least one layer of shell comprises a single, uniform thickness and/or varying thicknesses. In embodiments, the at least one layer of shell comprises a thickness of about or at least about 1 nm, about or at least about 5 nm, about or at least about 10 nm, about or at least about 15 nm, about or at least about 20 nm, about or at least about 25 nm, about or at least about 30 nm, about or at least about 40 nm, about or at least about 50 nm, about or at least about 100 nm, about or at least about 200 nm, about or at least about 300 nm, about or at least about 400 nm, about or at least about 500 nm, about or at least about 600 nm, about or at least about 700 nm, about or at least about 800 nm, about or at least about 900 nm, about or at least about 1 μm, about or at least about 2 μm, about or at least about 3 μm, about or at least about 4 μm, about or at least about 5 μm, about or at least about 10 μm, about or at least about 15 μm, about or at least about 20 μm, about or at least about 25 μm, about or at least about 30 μm, about or at least about 35 μm, about or at least about 40 μm.

In embodiments, the at least one layer of shell comprises at least a portion that is opaque. In embodiments, the portion that is opaque optically absorbs, deflects, blocks, and/or scatters light in the visible electromagnetic range of about 380 nm to about 800 nm. In embodiments, the portion that is opaque comprises a thickness of about or at least about 1 nm, about or at least about 5 nm, about or at least about 10 nm, about or at least about 25 nm, about or at least about 50 nm, about or at least about 100 nm, about or at least about 250 nm, about or at least about 500 nm, about or at least about 1 μm, about or at least about 2.5 μm, about or at least about 5 μm, or about or at least about 10 μm.

In embodiments, the at least one layer of shell comprises a material comprising one or more of glass, quartz, plastic, polyethylene terephthalate, polycarbonate, polymethyl methacrylate (acrylic), polyethylene, polyurethane, polypropylene, thermoplastic elastomers (TPE), acrylonitrile butadiene styrene (ABS), epoxies and epoxy-based photoresists, hydrogels, cyclic olefin copolymer (COC) cyclic olefin polymer (COP), poly dimethyl siloxane (PDMS), poly ether ester ketone (PEEK), polyetherimide (ULTEM), nylon, thermally responsive polymer, and combinations thereof.

In embodiments, the at least one layer of shell is composed of and/or has disposed thereon one or more of polysaccharides, lipids, amino acids, DNA, RNA, plastics, thermally responsive polymers, hydrocarbon, crude oil, or petroleum derivatives, and combinations thereof.

In embodiments, the at least one layer of shell comprises one or more indentations, grooves, and spaces located on an internal surface to affix the at least one orientable multiphasic yolk.

In embodiments, the at least one layer of shell comprises one or more materials to reduce friction between an internal surface and the at least one orientable multiphasic yolk.

In embodiments, the HYSP is disposed on a surface and/or substrate. In embodiments, the surface and/or substrate is a polymer, paper, fabric, metal, clay board, ceramic, window, glass, plastic, computer chip, wood, construction material, and/or human or animal tissue or skin.

In embodiments, the surface and/or substrate is planar or non-planar. In embodiments, the surface and/or substrate comprises at least a portion that is convex, concave, or without a well-defined shape. In embodiments, the surface and/or substrate is on an interior surface of an object, an exterior surface of an object, or both, and wherein the object is a non-HYSP object.

In embodiments, the surface and/or substrate comprises indentations and/or divots. In embodiments, the indentations and/or divots are arranged in an array. In embodiments, the HYSP is disposed in and/or on the indentations and/or divots. In embodiments, the surface and/or substrate comprises pillars, posts, and/or stops. In embodiments, the HYSP is disposed in and/or on the pillars, posts, and/or stops. In embodiments, the surface and/or substrate comprises one or more grooves. In embodiments, the HYSP is disposed in and/or on the one or more grooves.

In embodiments, the surface and/or substrate changes color as a function of the presence of a magnetic field.

In embodiments, the HYSP is formulated into a fluid, suspension, ink, liquid film, and/or adhesive substrate, material, and/or surface. In embodiments, the fluid, suspension, ink, liquid film, and/or adhesive substrate, material, and/or surface is suitable to be applied to an object.

In embodiments, the HYSP is formulated into a foil, film, thin plastic, and/or paper substrate, material, and/or surface. In embodiments, the foil, film, thin plastic, and/or paper substrate, material, and/or surface is suitable to be affixed to, or embedded in, an object.

In embodiments, the HYSP is formulated into a fiber, thread, yarn, and/or twine substrate, material, and/or surface. In embodiments, the fiber, thread, yarn, and/or twine substrate, material, and/or surface is suitable to be woven into an article of clothing, a cloth, and/or a tarp.

In embodiments, the HYSP is positioned between a first substrate and a second substrate. In embodiments, at least one of the first substrate and the second substrate comprises a material that is transparent to at least a portion of the visible electromagnetic (EM) spectrum. In embodiments, the material comprises glass, quartz, plastic, polyethylene terephthalate, polycarbonate, polymethyl methacrylate (acrylic), polyethylene, polyurethane, polypropylene, thermoplastic elastomers (TPE), acrylonitrile butadiene styrene (ABS), epoxies and epoxy-based photoresists, hydrogels, cyclic olefin copolymer (COC) cyclic olefin polymer (COP), poly dimethyl siloxane (PDMS), poly ether ester ketone (PEEK), polyetherimide (ULTEM) and/or nylon. In embodiments, the material comprises a thickness of about or at least about 50 nm, is about or at least about 100 nm, is about or at least about 500 nm, about or at least about 1 μm, is about or at least about 10 μm, is about or at least about 100 μm, about or at least about 1 mm, about or at least about 5 mm, or about or at least about 10 mm.

In embodiments, the HYSP comprises at least a first surface with a shape that is complementary to a shape of a second surface of the HYSP. In embodiments, the HYSP is disposed on and/or embedded in a surface and/or substrate which is treated with one or more of a lubricant, adhesive, surface treatment, coating, and/or polishing agent.

In aspects, described herein, in embodiments, is a method of manufacturing a hollow yolk-shell particle (HYSP) comprising i) preparing at least one multiphasic orientable yolk, wherein the at least one multiphasic orientable yolk comprises at least two colorants and at least one stimuli-responsive element, ii) forming a dissolution layer disposed on the at least one multiphasic orientable yolk, iii) forming at least one layer of a shell encapsulating the multiphasic orientable yolk, wherein the at least one layer of shell comprises pores, iv) repositioning the dissolution layer through the pores in the at least one layer of shell to form a cavity between the at least one multiphasic orientable yolk and the at least one layer of a shell, and v) hardening the at least one layer of a shell to form a non-porous shell, wherein the multiphasic orientable yolk is configured to move inside the shell in response to exogenous energy. In embodiments, the exogenous energy is a magnetic field.

In embodiments, the method further comprises applying a coating to the at least one multiphasic orientable yolk prior to forming the dissolution layer. In embodiments, the coating comprises one or more of a protective coating, a chemical functionalization, lubricant, surface treatment, and/or polishing agent.

In embodiments, the method further comprises forming one or more additional shells encapsulating the at least one layer of shell.

In embodiments, the method further comprises disposing one or more materials into the cavity formed from the removing.

In embodiments, the one or more materials comprise thermally responsive polymers and/or a fluid media.

In embodiments, the at least one layer of shell comprises at least a portion of the shell comprises a material that is transparent to at least a portion of the visible electromagnetic spectrum between about 380 nm to about 800 nm.

In embodiments, one or more of: i) preparing at least one multiphasic orientable yolk, ii) forming a dissolution layer, and iii) forming at least one layer of a shell comprises assembling, gluing, and/or affixing two or more components; injection molding, and/or micro-injection molding; self-assembly, adsorption, coacervation, and/or mixing; polymerization, extrusion, and/or manipulation of polymers; additive manufacturing, CNC machining (Computer Numerical Control machining), urethane casting, microcontact printing, dip pen lithography, beam pen lithography, photolithography, e-beam lithography, and/or 3D printing.

In embodiments, forming the at least one layer of shell comprises performing one or more of mesoporous material synthesis, soft-templating, calcination, and/or extraction.

In embodiments, the at least one layer of shell comprising pores comprises a mesoporous silica and/or a porous organic framework. In embodiments, repositioning the dissolution layer comprises removing, dissolving, and/or etching the dissolution layer.

In embodiments, hardening the at least one layer of a shell to form a non-porous shell comprises compacting and forming a solid mass of shell material by heat and/or pressure.

In embodiments, preparing the at least one multiphasic orientable yolk comprises forming the yolk by injecting molten plastic, metal, and/or polymer-based material into a mold cavity.

In embodiments, preparing the at least one multiphasic orientable yolk comprises a DNA origami technique. In embodiments, the DNA origami technique comprises self-assembly of at least two DNA-coated colorants and at least one DNA-coated stimuli-responsive element.

In embodiments, one or more of: i) preparing at least one multiphasic orientable yolk, ii) forming a dissolution layer, and iii) forming at least one layer of a shell comprises 3D printing. In embodiments, 3D printing comprises performing one or more of fused deposition modeling (FDM), fused filament fabrication (FFF), stereolithography (SLA), selective laser sintering (SLS), binder jetting (BJ), direct energy deposition (DED), digital light process (DLP), liquid crystal display (LCD), polymer jetting (PolyJet), multi-jet fusion (MJF), direct metal laser sintering (DMLS), electron beam melting (EBM), laminated object manufacturing (LOM), continuous liquid interface production (CLIP), electron beam melting, and digital light processing (DLP).

In embodiments, one or more of the at least one multiphasic orientable yolk, the dissolution layer, and the at least one layer of shell comprises one or more of a thermally responsive polymer, resin, metal, ceramic, glass, quartz, plastic, polyethylene terephthalate, polycarbonate, polymethyl methacrylate (acrylic), polyethylene, polyurethane, polypropylene, thermoplastic elastomers (TPE), acrylonitrile butadiene styrene (ABS), epoxies and epoxy-based photoresists, hydrogels, cyclic olefin copolymer (COC) cyclic olefin polymer (COP), poly dimethyl siloxane (PDMS), poly ether ester ketone (PEEK), polyetherimide (ULTEM), nylon, and combinations thereof.

In embodiments, the one or more thermally responsive polymers and resins comprise one or more of poloxamers, styrene-butadiene block copolymers, polymethylmethacrylate, polybutylmethacrylate, plasticized polyvinyl chloride, plasticized nylon, plasticized polyethylene terephthalate, polyethylene, polyacrylonitrile, polychlorotrifluoroethylene, poly-4,4′-isopropylidenediphenylene carbonate, polyethylene vinyl ester, polyvinyl chloride-diethyl fumarate, and combinations thereof.

In embodiments, preparing the at least one multiphasic orientable yolk comprises forming Janus particles. In embodiments, the Janus particles comprise one or more of poly(tert-butyl acrylate)-poly(3-(triethoxysilyl)propyl methacrylate) (PtBA-PTPM), polystyrene latex polymer, carboxylated latex polymer, aminated latex polymer, colored polystyrene polymer (dye-infused and/or pigment-infused), colored polystyrene-based carboxylated latex polymer (dye-infused and/or pigment-infused), fluorescent polystyrene-based polymers, fluorescent polystyrene-based carboxylated latex polymers, fluorescent aminated polystyrene-based polymer, surfactant-free polystyrene, carboxylated surfactant-free polymer, polymethyl methacrylate (PMMA) latex polymer, divinylbenzene (DVB)-crosslinked polystyrene latex polymer, and combinations thereof.

In embodiments, preparing the at least one multiphasic orientable yolk comprises joining together at least two colorants and a stimuli-responsive element composed of a material that responds to a magnetic field.

In embodiments, forming at least one layer of a shell comprises forming the at least one layer of shell using one or more materials that is transparent to at least a portion of the visible electromagnetic (EM) spectrum. In embodiments, the one or more materials comprises glass, quartz, plastic, polyethylene terephthalate, polycarbonate, polymethyl methacrylate (acrylic), polyethylene, polyurethane, polypropylene, thermoplastic elastomers (TPE), acrylonitrile butadiene styrene (ABS), epoxies and epoxy-based photoresists, hydrogels, cyclic olefin copolymer (COC) cyclic olefin polymer (COP), poly dimethyl siloxane (PDMS), poly ether ester ketone (PEEK), polyetherimide (ULTEM), and/or nylon.

In embodiments, the method further comprises formulating the HYSP into a fluid, suspension, ink, liquid film, and/or adhesive substrate and/or material. In embodiments, the fluid, suspension, ink, liquid film, and/or adhesive substrate and/or material is suitable to be applied to a surface of an object.

In embodiments, the method further comprises formulating the HYSP into a foil, film, thin plastic, and/or paper substrate and/or material In embodiments, In embodiments, the foil, film, thin plastic, and/or paper substrate and/or material is suitable to be affixed to, or embedded in, an object.

In embodiments, the method further comprises formulating the HYSP into a fiber, thread, yarn, and/or twine substrate and/or material. In embodiments, the fiber, thread, yarn, and/or twine substrate, material, and/or surface is suitable to be woven into an article of clothing, a cloth, and/or a tarp.

In aspects, disclosed herein, in embodiments, is a method of using a hollow yolk-shell particle (HYSP) comprising providing the HYSP, as described herein, formulating the HYSP into a fluid, suspension, ink, liquid film, and/or adhesive substrate and/or material, formulating the HYSP into a foil, film, thin plastic, and/or paper substrate and/or material, or formulating the HYSP into a fiber, thread, yarn, and/or twine substrate and/or material, and applying the fluid, suspension, ink, liquid film, and/or adhesive substrate and/or material, the foil, film, thin plastic, and/or paper substrate and/or material, or the fiber, thread, yarn, and/or twine substrate and/or material to an object and/or surface. In embodiments, the object is polymer, paper, fabric, metal, clay board, ceramic, window, glass, plastic, computer chip, wood, construction material, and/or human or animal tissue. In embodiments, the object and/or surface exhibits optical property changing properties as a function of the application of a magnetic field.

In aspects, disclosed herein, in embodiments, is a method of authenticating a material comprising providing a formulation of an HYSP, as described herein, wherein the formulation comprises a fluid, suspension, ink, liquid film, and/or adhesive substrate and/or material; a foil, film, thin plastic, and/or paper substrate and/or material; or a fiber, thread, yarn, and/or twine substrate and/or material, tagging an object and/or surface with the formulation, and reading the tagging. In embodiments, the tagging is configured to be read by a sensor and/or optical imaging device. In embodiments, the reading comprises applying a magnetic field to determine an optical property change in the object and/or surface due to the presence of the HYSP.

### DESCRIPTION OF THE DRAWINGS

FIG. 1 depicts an illustrative, non-limiting diagrammatic representation of a stimuli-responsive hollow yolk shell particle (HYSP) 100 that reversibly changes its state from a first state (“State 1”) to a second state (“State 2”) in response to an external stimulus, e.g., a magnetic field and/or heat.

FIGS. 2A-2B depict illustrative, non-limiting diagrammatic representations of an exemplary HYSP 100 according to embodiments of the present disclosure. FIG. 2A depicts a multiphasic orientable yolk 20 including at least one stimuli-responsive element 40, including one or more particles that imparts at least one type of property, e.g., property 1 60, and including one or more particles that imparts a second type of property, e.g., property 2 80. FIG. 2B depicts a schematic top view of exemplary HYSP 100 wherein a multiphasic orientable yolk 20 reversibly orients itself in response to external stimuli. The multiphasic orientable yolk 20 in FIG. 2B comprises at least one stimuli-responsive element 40, one or more particles that imparts one type of property, e.g., property 1 60, and one or more particles that imparts a second type of property, e.g., property 2 80. FIG. 2B depicts how the observed optical property changes in response to an external stimulus (e.g., addition of stimulus A or Stimulus B).

FIG. 3 depicts an illustrative, non-limiting diagrammatic representation of an exemplary HYSP 100 wherein the multiphasic orientable yolk 20 reversibly orients itself in response to an external stimulus. The multiphasic orientable yolk 20 in FIG. 3 is a HYSP 100 comprising a first surface comprising at least one type of colorant 70 on a first side (top); a second surface comprising at least one type of a second colorant 90 on a second side (bottom); and comprising at least one type of stimuli-responsive element 40 disposed on any side or surface therein. FIG. 3 illustrates how the observed optical property would change from the top view (or bottom view) in response to an external stimuli (e.g., stimulus A or stimulus B) that would cause a 180° clockwise or counterclockwise rotation of the yolk 20.

FIG. 4 depicts an exemplary, non-limiting workflow of a method of preparing a HYSP.

FIG. 5 depicts an exemplary, non-limiting workflow of a method of preparing a HYSP including the use of thermally-responsive polymers.

FIG. 6 depicts an exemplary, non-limiting workflow of a method for preparing a DNA origami multiphasic orientable yolk.

FIG. 7 depicts an illustrative, non-limiting diagrammatic representation of multiplayers of HYSPs.

FIG. 8 depicts an illustrative, non-limiting workflow of a method of preparing a HYSP with a silica shell and etching technique.

FIG. 9 depicts an illustrative, non-limiting workflow of a method of preparing a HYSP using DNA origami attachment to a magnetic particle.

FIG. 10 depicts an illustrative, non-limiting workflow of a method of preparing a HYSP by attaching colorants to a DNA origami-magnetic particle.

FIG. 11 depicts an illustrative, non-limiting workflow of a method of preparing a DNA origami magnetic HYSP.

FIG. 12 depicts an illustrative, non-limiting diagrammatic representation of magnetochromatic HYSPs used for displaying a displaying graphics, markings, text, and/or patterns. Four types of color-shifting HYSPs are shown, encompassing 5 colors in total. Each HYSP shares one color, which matches the color of the substrate material the HYSPs are applied to, where the 4 particles are printed into a pattern of text and graphics/patterns. Appling a magnetic field from a small magnet causes the coloration of the particles to all simultaneously change to match the substrate background, making the graphics and text invisible against the substrate background. Re-applying the magnetic field in the opposite direction reverses the effect, showing the graphics and text.

FIG. 13 depicts an illustrative, non-limiting diagrammatic representation of magnetochromatic HYSPs used for security, authentication, and/or anti-counterfeit purposes. HYSPs are applied to a section of a surface of paper currency, e.g., square section on a banknote as shown, such that when a magnetic stimulus is applied (“+ stimulus”), the HYSPs alter their color, and when the stimulus is removed, or an anti-stimulus is applied (“− stimulus”), the HYSPs revert back to their original color.

### DETAILED DESCRIPTION

The present disclosure provides, in part, compositions of hollow yolk-shell particles (HYSPs), which represent a class of hybrid materials including an orientable core (e.g., referred to in embodiment as a “yolk”) inside a hollow cavity encircled by one or more “shells.” In embodiments, the presence of the cavity within HYSPs can provide rotational freedom to the yolk, while maintaining the protective effect of the shell, which is beneficial for preserving the distance-dependent properties of the yolk. In embodiments, the configuration of yolks incorporated into the HYSPs can be changed or otherwise altered under external fields without any variation in space (e.g., without translational motion). This feature, in embodiments, makes HYSPs promising materials for exhibiting switchable, or tunable, optical properties without reconfiguration or volume transitions. In embodiment, a HYSP with a yolk that has the ability to change its orientation in response to an external stimulus, e.g., a magnetic field, without perturbation of the shell, is referred to as a HYSP. In embodiments, the HYSP is a “magnetochromatic particle,” which is a particle that exhibits different optical properties in response to a magnetic field.

In embodiments, HYSPs work via energy being transferred to an HYSP to help it move, and the energy can be transferred in the form of force. In embodiments, the energy transferred by force to move any object is known as work or work done, and therefore, work and energy have a direct relationship. In embodiments, the terms “exogenous energy,” or “applied force,” as used herein refer to energy or work being applied to an HYPS or object to initiate an optical changing property, as described herein.

### Hollow Yolk-Shell Particles (HYSPs)

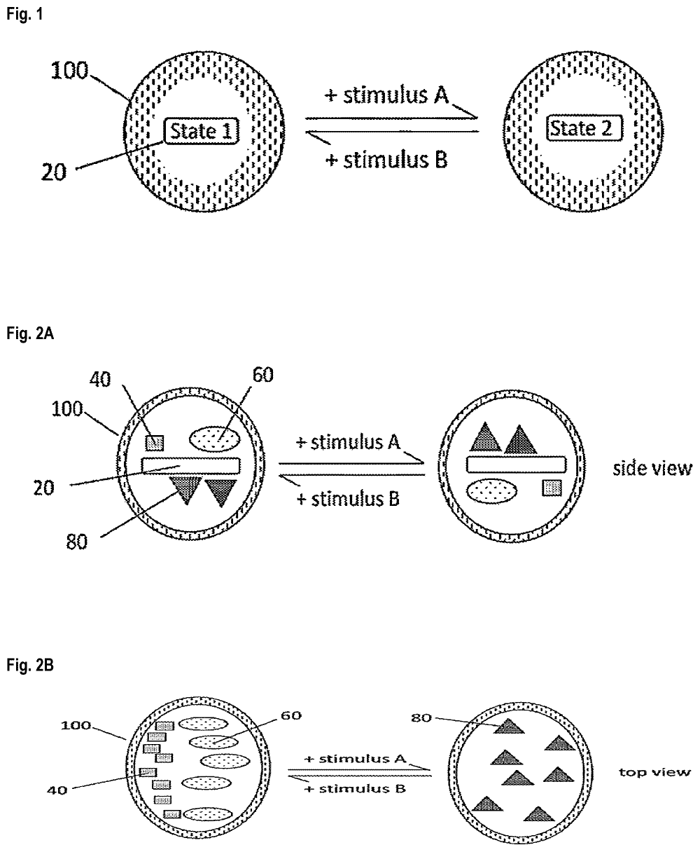

Described herein, in part, are “hollow yolk-shell particles,” or “HYSPs,” which, in embodiments, refer to a class of hybrid materials including at least one movable core (e.g., a yolk 20 in reference to FIGS. 1, 2A-2B, and 3-6) inside at least one hollow cavity encircled by at least one layer of an outer shell. HYSP are denoted, in embodiments, as “yolk-shell” configurations and are sometimes described as “yolk-void-shell.” In embodiments, the presence of the “void,” or vacant space located within a HYSP, will not be additionally indicated, with the denotation “yolk-shell” referring to both the yolk-shell structure and any space(s) encapsulated therein. In embodiments, where the shell consists of at least two layers, the designation takes the form of yolk-shell₁-shell₂-shellₙ, where n is any number of layers (with one or more spaces between the yolk-shell₁ and the shell₁-shell₂, etc.).

In embodiments, HYSPs disclosed herein can be designed using a wide range of chemical compositions and materials, including but not limited to metal-polymer, metal-silica, metal-carbon, metal-metal oxide, metal-silica, DNA-silica, DNA-polymer, DNA-carbon, DNA-metal oxide, polymer-polymer, polymer-silica, silica-polymer, silica-metal oxide, silica-carbon, metal oxide-silica, silica-metal oxide, or any possible combinations thereof including materials described herein. HYSPs disclosed herein, in embodiments, can have at least one layer of shell, wherein each layer of shell, as well as the yolk, can be composed of any combination of materials described herein. In embodiments, the polymer substrate can also be chosen from the classes including, but not limited to, biological polymers, polysaccharides, plastics, crude oil and/or petroleum (e.g., hydrocarbon) derivatives.

In embodiments, the HYSP size can be from about or at least about 1 nm to about or at least about 50 μm. In embodiments, the HYSP can have a dimension (e.g., radius, diameter, length, width) that is about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, about or at least about 20 μm, or about or at least about 50 μm.

In embodiments, the spacing between the yolk and the inner layer of the shell in a HYSP can be adjusted. In embodiments, the spacing can be 1 nanometer (nm) or less of spacing between the outer portion of the yolk and the inner layer of the shell. In embodiments, the spacing can range from about or at least about 1 nm to about or at least about 50 μm. In embodiments, the space can be about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, or about or at least about 20 μm.

In embodiments, the spacing between the yolk and the inner layer of the shell in a HYSP has portions that are uniform and/or non-uniform in distance. In embodiments, the spacing between the yolk and the inner layer of the shell in a HYSP is a range of distances, including for example about or at least about 1 nm to about or at least about 5 nm, about or at least about 5 nm to about or at least about 10 nm, about or at least about 10 nm to about or at least about 20 nm, about or at least about 20 nm to about or at least about 50 nm, about or at least about 50 nm to about or at least about 100 nm, about or at least about 100 nm to about or at least about 1000 nm (1 μm), about or at least about 1 μm to about or at least about 5 μm, about or at least about 5 μm to about or at least about 10 μm, about or at least about 10 μm to about or at least about 20 μm, or about or at least about 20 μm to about or at least about 50 μm.

In embodiments, the spacing between the yolk and the inner layer of the shell in a HYSP is variable, having varying distances. In embodiments, the varying distances are due to the mode of attachment between the yolk and the shell to keep the yolk suspended inside the cavity of the shell while maintaining a degree of rotational freedom. For example, in embodiments, the attachment can be a pin-and-groove fitting such that the yolk has a mass akin to a “pin” and the shell has a “groove” pattern such that the yolk is kept suspended in the cavity, maintaining a substantially uniform distance between the yolk and shell in the surface area outside of the pin-and-groove.

In embodiments, HYSPs can adopt various shapes, geometries, and/or morphologies, for example including but not limited to, spherical, ellipsoidal, spindle, rodlike, cubic, starlike, cylindrical, plate, tetrahedron, dodecahedron, etc. In embodiments, the shell adopts the same shape, geometry, and/or morphology as the core (e.g., yolk). In embodiments, the core, or yolk, adopts a different shape, geometry, and/or morphology than the one or more shells. In embodiments, the yolk maintains at least a portion that has a shape, geometry, and/or morphology that is a corresponding fit to a shape, geometry, and/or morphology present in the surface of the shell (e.g., such as for attachment purposes). In embodiments, the yolk does not necessarily need to be a solid particle (e.g., solid nanoparticle or microparticle), and can alternatively include a fluid (e.g., ferrofluid), semi-solid, or non-Newtonian fluid. In such embodiments, the shape, geometry, and/or morphology of the yolk is dictated by the shape, geometry, and/or morphology of the shell.

In embodiments, an average particle size of HYSPs provided herein are preferably from about 10 nm to about 50 μm. Different techniques can be used to characterize physicochemical properties of HYSPs, including in embodiments, the particle size and size distribution, morphology, hydrophilicity, among other physicochemical properties. In embodiments, such techniques include, but are not limited to, scanning electron microscopy (SEM), high-angle annular dark-field scanning transmission electron microscopy (HAADF-STEM), scanning tunneling microscope (STM), atomic force microscopy (AFM), confocal microscopy, light scattering, among other techniques used to determine physicochemical properties of HYSPs.

In embodiments, the HYSP, yolk, and/or shell can include one or more additional elements which provide and/or alter one or more properties. For example, in embodiments, these additional elements can aim to modify, alter, or otherwise confer chemical, physical, and/or biological properties to the shell structure, the yolk structure, or the entire HYSP. In embodiments, the one or more additional elements can include one or more of a lubricant (e.g., to change the frictional coefficient and/or force needed to move the yolk relative to the shell, or HYSP relative to a surface), colorant agent (e.g., dye, pigment, anisotropic particle, metal nanorod, plasmonic material, etc.), and material to alter geometry, shape, density, reflectivity, etc., including additional materials such as a metal, ceramic, polymer, plastic, etc.

In embodiments, the one or more additional elements can improve or help HYSPs become more stabilized, suspended, and/or dispersed in an ink, suspension, liquid, or fluid medium, for forming a film or fiber, and/or being applied to a surface. In embodiments, the additional elements can be present on at least a portion of the outside of the shell. In embodiment, the additional elements of the shell can protrude into, or be introduced into, the interior of the shell surface and/or outer surface or the yolk. Alternatively, in embodiments, these elements do not protrude into the interior of the shell, e.g., are only present on a surface of one or more shell layers and/or in a cavity of space between one or more shell layers. In embodiments, the additional elements can also be present on one or more inner surfaces of the shell, where it faces towards a cavity (e.g., a space between layers or a space between a layer and yolk).

In embodiments, the one or more additional elements introduced onto the outer surface can help to prevent drag between the HYSP and a substrate material (e.g., surface of skin, paper, fabric, metal, clay board, ceramic, plastic, polymer, metal, glass, etc.), or between the yolk (core) and shell, for instance when the yolk (core) is rotated upon application of external stimuli (e.g., a magnetic field). In embodiments, the additional elements are designed to make the surface of HYSPs adhesive so that HYSPs can more strongly attach to, or adhere to, a substrate. In such a case, in embodiments, the HYSP can adhere to, or be embedded in, a surface where the yolk (core) can freely move inside the shell of the HYSP in response to an external stimulus, e.g., a magnetic field, which would confer this property to the surface.

In embodiments, the one or more additional elements, e.g., that can modify the chemical, physical, and/or biological properties of the shell, are applied to an inner surface of the shell to overcome frictional force within the cavity of HYSPs so that the yolk can orient itself more easily upon exposure to the applied force or energy. In embodiments, the additional elements confer a low-friction behavior to the inner surface within the cavity in order to ease rotation of the yolk. In embodiments, the lack of such an additional element, or altering the amount thereof, can be used to fine tune the friction and thus the strength of magnetic field needed to move the yolk. In such an embodiment, HYSPs of variable response to applied force or energy (e.g., magnetic field) can be made by altering the frictional coefficients of each shell-yolk combination.

### Orientable Multiphase Yolk

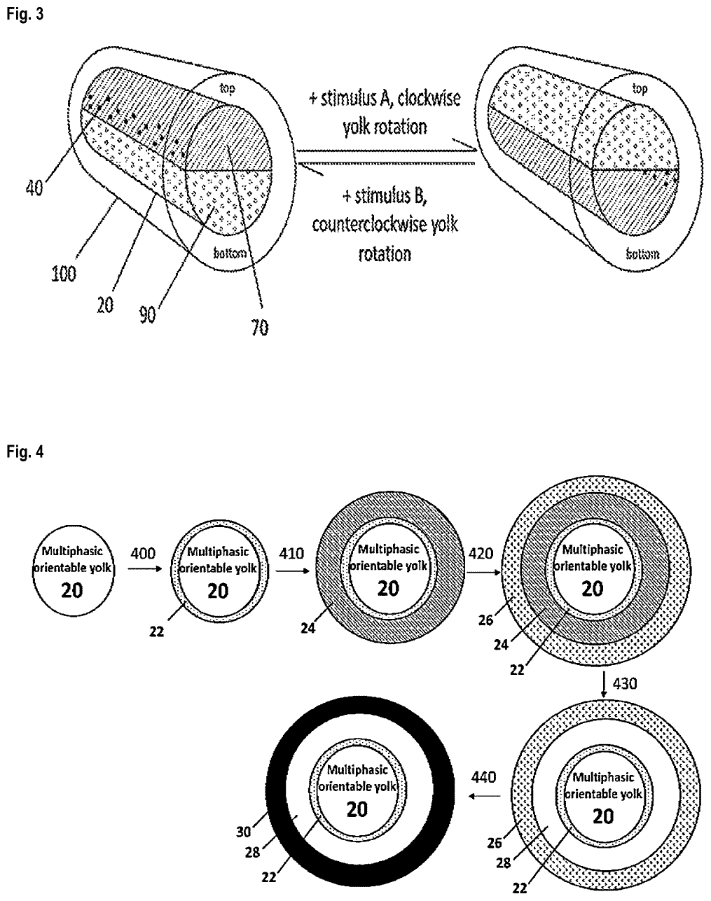

Described herein, in part, are orientable multiphase particle cores (i.e., “yolks”), which in embodiments, can respond to an external stimulus, e.g., a magnetic field. In embodiments, the cores (e.g., a yolk 20 in reference to FIGS. 1, 2A-2B, and 3-6) have at least one degree of freedom, e.g., rotational freedom. In embodiments, the response of the yolk after imposition of external stimuli, e.g., a magnetic field, is to change its orientation within the void space between core and the shell (e.g., a rotation), independent of any movement of the HYSP in space. In non-limiting embodiments, this is represented in FIG. 2A and FIG. 2B and in FIG. 3.

In embodiments, “the yolk” refers to a movable (orientable) core inside the cavity of a HYSP (independent of the presence of one or more shells). In embodiments, the yolk is capable of rotating on one or more of its own axes upon exposure to and/or after exposure to an external stimulus, e.g., a magnetic field. In embodiments, the yolk can be composed of a combination of different materials, as described herein. For example, in embodiments, the yolk can be the combination of materials such as, but not limited to, nucleic acids, biologics, colorants (e.g., dye, pigment, anisotropic particle, metal nanorod, plasmonic material, etc.), inorganic particles, metal, ceramic, polymer, and/or plastic.

In embodiments, the yolk inside the cavity of an HYSP is encapsulated with at least one layer of a shell. In embodiments, HYSPs incorporate at least one yolk (core) particle. In embodiments, only one yolk is encapsulated in the cavity of a single HYSP. In embodiments, more than one yolk is encapsulated in the cavity of a single HYSP.

In embodiments, the yolk can be formed by any type of material including, but not limited to, metals, metal oxides, silica, organic and/or inorganic polymers, lipids, DNA, RNA, and combinations thereof. In embodiments, the polymer substrate can be chosen from polymer classes including, but not limited to, biological polymers, polysaccharides, plastics, thermally responsive polymers, crude oil or petroleum (e.g., hydrocarbon) derivatives, and/or polymers compatible with additive manufacturing techniques, e.g., such as 3D printing. In embodiments, the yolk comprises and/or is a fluid (e.g., ferrofluid), a semi-solid material, and/or a non-Newtonian fluid or material.

In embodiments, the yolk is suspended in a fluid media, a semi-solid media, non-Newtonian fluid or media, and/or a combination thereof within the one or more layers of shell. In such embodiments, the yolk can maintain a uniform distance from the shell and reorient itself freely within the shell while suspended in the fluid media (e.g., ferrofluid), a semi-solid material, and/or a non-Newtonian fluid or media. In embodiments, the yolk is suspended within the fluid media to control friction between the yolk and shell.

In embodiments, the yolk particle size can be from about or at least about 1 nm to about or at least about 50 μm. In embodiments, the yolk can have a size or dimension (e.g., radius, diameter, length, width) that is about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, about or at least about 20 μm, or about or at least about 50 μm.

In embodiments, the yolk particle in a HYSP can have a range of sizes or dimensions (e.g., radius, diameter, length, width), including for example about or at least about 1 nm to about or at least about 5 nm, about or at least about 5 nm to about or at least about 10 nm, about or at least about 10 nm to about or at least about 20 nm, about or at least about 20 nm to about or at least about 50 nm, about or at least about 50 nm to about or at least about 100 nm, about or at least about 100 nm to about or at least about 1000 nm (1 μm), about or at least about 1 μm to about or at least about 5 μm, about or at least about 5 μm to about or at least about 10 μm, about or at least about 10 μm to about or at least about 20 μm, or about or at least about 20 μm to about or at least about 50 μm.

In embodiments, the average particle size of yolk provided herein is from about 10 nm to about 10 μm.

In embodiments, the yolk is smaller in size than the HYSP. In embodiments, the yolk is smaller in size or dimension than the HYSP by about or at least about 1 nm, about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 15 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, about or at least about 20 μm, or about or at least about 30 μm, or about or at least about 40 μm.

In embodiments, yolks can adopt various structures, shapes, geometries, and/or morphologies, including but not limited to spherical, ellipsoidal, spindle, rodlike, cubic, starlike, cylindrical, plate, regularly shaped (e.g., a regular polygon), irregularly shaped (e.g., a combination of two or more distinct shapes), triangular, trapezoidal, octagonal, tetrahedron, dodecahedron, etc. In embodiments, the yolk adopts the same shape, geometry, and/or morphology as the overall HYSP and/or shell. In embodiments, the yolk adopts a different shape, geometry, and/or morphology than the one or more shells and/or the overall HYSP. In embodiments, the yolk is a substantially solid nanoparticle In embodiments, the yolk comprises and/or is a fluid (e.g., ferrofluid), semi-solid, or non-Newtonian fluid which adapts to the shape of the cavity and/or shell it is contained within.

In embodiments, the yolk (i.e., core) particles of HYSPs have a surface that can be modified and/or functionalized. In embodiments, the surface can be functionalized using chemistry techniques known to those skilled in the art to enable assembly of other elements onto the surface of the yolk particles. For example, in embodiments, materials such as biological and/or synthetic molecules can be suitable for functionalization onto the surface of yolk particles.

In embodiments, “multiphase” or “multiphasic,” used herein in connection to yolks, and/or the overall HYSPs, refers to particles having at least two or more regions or areas (collectively called “phases”) at the surface of the particles (e.g., at the surface of the yolk), where the at least two phases are physically, structurally, and/or functionally discrete with respect to any other phases of that same particle. For example, in embodiments, a yolk can have two or more surfaces, each of which has distinct optical properties, such as exhibiting different coloration, brightness, fluorescence, reflectance, etc., where, as the yolk moves, different optical properties can be observed from any particular angle.

In embodiments, the “structure,” as used herein in reference to the yolk, refers to the physical aspects of each phase, including, for example and without limitation, its depth, size, shape, topography or texture. In embodiments, the “function,” as used herein in reference to the yolk, refers to the characteristics of a phase, such as, for example and without limitation, the optical property, chemical functionality, stimuli-responsive behavior, and the like, as described herein. In embodiments, the “function” can describe the characteristic(s) imparted to the products and/or surfaces contemplated herein from the application of HYSPs.

In embodiments, the orientable yolk is a multiphasic particle having a surface with at least two homogenous phases. In embodiments, each homogenous area on the surface of the yolk imparts a distinct property or function. In embodiments, and in reference to FIG. 2A, the multiphasic yolk 20 can include each of: at least one stimuli-responsive element 40, one or more particles that imparts an optical property (e.g., property 1 60), and/or one or more particles that imparts a second optical property (e.g., property 2 80).

In embodiments, the multiphasic orientable yolk is a multiphasic particle having a surface including (a) at least one first colorant on a first side of the surface of the yolk, (b) at least one second colorant on a second side of the surface of the yolk, and (c) at least one type of stimuli-responsive element on a first side of the surface, a second side of the surface, or within the yolk. In embodiments, the first side of the surface and the second side of the surface are opposite to each other through the surface of the orientable yolk. In embodiments, the stimuli-responsive element is a stimuli-responsive particle. In embodiments, the stimuli-responsive element that imparts the stimuli-responsive behavior is disposed on the first side of the surface of the yolk. In embodiments, the stimuli-responsive element that imparts the stimuli-responsive behavior is disposed on the second side of the surface of the yolk. In embodiments, the stimuli-responsive element that imparts the stimuli-responsive behavior is disposed on both the first side of the surface of the yolk and the second side of the surface of the yolk.

In embodiments, the yolk includes a first colorant and a second colorant. In embodiments, each colorant is independently selected from a dye, pigment, stain, fluorophore, and/or a combination thereof. In embodiments, the first colorant and the second colorant are different. In embodiments, the yolk includes at least 2 colorants, at least 3 colorants, at least 4 colorants, at least 5 colorants, at least 6 colorants, at least 7 colorants, at least 8 colorants, at least 9 colorants, at least 10 colorants.

In embodiments, the yolk includes colorant properties that are conferred from the material the yolk is composed of. For example, in embodiments, the yolk can be composed of one or more thermally responsive polymers which are selected because they possess a distinct coloration. In embodiments, the yolk can be composed of a stimuli-responsive element that also functions as a colorant, or example iron oxide particles which an appear black, brown, red, red-orange, and/or orange in color. Persons skilled in the art, with the benefit of this disclosure in its entirety, will understand the materials that possess colorant properties that can be used to make HYSPs.

In embodiments, and in reference to FIG. 3, the observed color of the orientable multiphasic yolk 20 can be changed upon and/or after exposure to an applied force or energy. Continuing in reference to FIG. 3, in embodiments, the stimuli-responsive element 40 is a magnetic particle on the surface of and/or within the yolk. In embodiments, the stimuli-responsive element is responsive to a magnetic field. For example, in embodiments, the orientable multiphasic yolk can change its optical properties by reorienting itself within the shell as a magnetic field is applied. In embodiments, the orientable multiphasic yolk can have several different colorants coating several surfaces of the yolk, such that as the direction of the applied magnetic field is changed, the colorant that is observable changes.

In embodiments, HYSPs include an orientable (i.e., movable) yolk (i.e., core) that is a Janus particle having a surface comprising: 1) at least one type of colorant (e.g., dye, pigment, anisotropic particle, metal nanorod, plasmonic material, etc.) on a first side of the surface, and 2) particle construction that imparts stimuli-responsive behavior on a second side of the surface. As used herein, in embodiments, a Janus particle has two areas with difference chemistry, polarity, functionalization, and/or other properties with roughly equal surface area.

In embodiments, HYSPs include an orientable (i.e., movable) yolk (i.e., core) that is a Janus particle having a surface comprising: 1) at least one type of colorant (e.g., dye, pigment, anisotropic particle, metal nanorod, plasmonic material, etc.) on a first side of the surface, 2) at least one second type of colorant (e.g., dye, pigment, anisotropic particle, metal nanorod, plasmonic material, etc.) on a second side of the surface, and 3) particle construction that imparts stimuli-responsive behavior on the first side of the surface and/or second side of the surface. In embodiments, the first and second colorant can be the same class or molecule, but exhibit different optical properties.

In embodiments, a variety of techniques focused on using polymers to generate 3D materials can be used to synthesize Janus particle yolks for HYSPs. For example, in embodiments, snowmen-shaped anisotropic Janus particles are described in KANG and HONCIUC, “Influence of Geometries on the Assembly of Snowman-Shaped Janus Nanoparticles”, ACS Nano, Vol. 12, No. 4:2018: pp. 3741-3750, which is hereby incorporated by reference in its entirety. For example, in embodiments, a Janus particle can be described as a prototypical “snowman particle,” i.e., with two parts, each part being a sphere or hemisphere, where ethe Janus particle has a bottom portion larger than a top portion (e.g., like a “snowman-shaped” particle), although the dimensions can be altered. In embodiments, such particles can be manufactured from poly(tert-butyl acrylate)-poly(3-(triethoxysilyl)propyl methacrylate) (PtBA-PTPM).

In embodiments, the synthesis of snowmen-shaped Janus particle-like yolks of HYSPs is via the formation of Janus particles. In embodiments, Janus particles are a type of particle characterized by having two distinct regions or “faces” with different physical and/or chemical properties. In embodiments, the two faces of Janus particles can have different surface chemistry, size, shape, or polarity, which makes them useful in a variety of applications, including drug delivery, catalysis, and self-assembly. In embodiments, “self-assembly,” can include chemical processes of arrangement that occurs spontaneously due to chemical forces, such as organization into ordered and/or functional structures or patterns as a consequence of specific, local interactions among the components themselves, without substantial external direction, such as can occur with polymers, colloids, via electrostatics, hydrophobics, hydrogen bonding, pi stacking, and shifts between equilibria in materials. In embodiments, snowmen-shaped Janus particles are attractive, because they are a unique class of anisotropic materials that are simple, but for which all the structural parameters can be completely controlled. In embodiments, each lobe in these anisotropic particles can be independently tuned in their dimensions and chemical compositions. In embodiments, Janus particle-based yolks and/or HYSPs can be synthesized at large scale, and under surfactant-free conditions. In embodiments, snowman-type Janus particles can be manufactured according to the methods of WALTHER and MULLER, “Janus Particles: Synthesis, Self-Assembly, Physical Properties, and Applications,” Chem. Rev., Vol. 113, 2013: pp. 5194-5261; VOGEL et al. “Advances in Colloidal Assembly: The Design of Structure and Hierarchy in Two and Three Dimensions,” Chem. Rev., Vol. 115, 2015: pp. 6265-6311; TANG et al., “Large Scale Synthesis of Janus Submicrometer Sized Colloids by Seeded Emulsion Polymerization,” Macromolecules, Vol. 43, 2010: pp. 5114-5120; and PHAM et al., “Synthesis of Polymeric Janus Nanoparticles and Their Application in Surfactant-Free Emulsion Polymerizations,” Polym. Chem. Vol. 6, 2015: pp. 426-435, each of which is hereby incorporated by reference in their entirety.

In embodiments, yolks can be manufactured, in part, from latex polymer snowmen-shaped particles, for example, using MAGSPHERE (micron-sized latex polymer particle), 15 μm diameter particle size. In embodiments, HYSPs and/or yolks can be manufactured from, in non-limiting examples, polystyrene latex polymer, carboxylated latex polymer, aminated latex polymer, colored polystyrene polymer (dye-infused and/or pigment-infused), colored polystyrene-based carboxylated latex polymer (dye-infused and/or pigment-infused), fluorescent polystyrene-based polymers, fluorescent polystyrene-based carboxylated latex polymers, fluorescent aminated polystyrene-based polymer, surfactant-free polystyrene, carboxylated surfactant-free polymer, polymethyl methacrylate (PMMA) latex polymer, divinylbenzene (DVB)-crosslinked polystyrene latex polymer.

In embodiments, the orientable Janus yolk (core) is spherical, ellipsoidal, spindle-like, cylindrical (e.g., rod shaped), and/or anisotropic-shaped. In embodiments, the stimuli-responsive element(s) are magnetic particles (e.g., magnetic particle 40 as shown in FIGS. 2A-2B and 3, or magnetic particle 30 as shown in FIGS. 4-6).

In embodiments, Janus yolks can be constructed using methods known in the art. For example, in embodiments, techniques including, but not limited to, electrohydrodynamic co-jetting, direct bulk synthesis, microfluidic synthesis, self-assembly techniques can be used to construct Janus yolks.

In embodiments, the cores (e.g., a yolk 20 in reference to FIGS. 1, 2A-2B, and 3-6) presented in this disclosure have at least one degree of freedom, e.g., rotational freedom. In embodiments, the response of the yolk after imposition of external stimuli, e.g., a magnetic field is to change its orientation within the void space between core and the shell (e.g., a rotation), independent of any movement of the HYSP in space. In non-limiting embodiments, this is represented in FIG. 2A and FIG. 2B and in FIG. 3.

In embodiments, the yolk is composed of a material that responds to a magnetic field with two or more different colorants disposed on the surface thereof, such that when an external magnetic field is applied, the yolk is configured to reorient itself (e.g., flip, rotate, etc.), revealing different portions of the surface having the two or more different colorants. For example, in such an embodiment, applying a magnetic field can change the yolk's orientation such that its color changes relative to an observer. In embodiments, the color can be “reset” to the original color by re-applying a magnetic field, or inverting the direction of the magnetic field.

### Stimuli-Responsive Elements

Described herein, in part, are stimuli-responsive elements present in the orientable multiphase particle cores (i.e., “yolks”). In embodiments, the stimuli-responsive elements confer responsiveness to an external stimulus, e.g., a magnetic field. In embodiments, the terms “applied force,” “external stimuli,” “exogenous energy,” and “external field,” are used interchangeably. In embodiments, “external stimuli,” as used herein refers to the exposure of the HYSPs, including any product/material HYSPs are integrated into (e.g., ink, fluid, suspension, film, fiber, etc.), to a force originating from outside the HYSP, product, or material in the form of an energy source. In embodiments, the external stimulus is provided by suitable apparatuses or devices. In embodiments, the external stimulus is magnetic. In embodiments, the energy source is configured to produce a magnetic field. In embodiments, the external stimulus includes moving an object, such as a magnet or electromagnet, into close proximity to the HYSP(s) to apply a magnetic field.

In embodiments, the stimuli-responsive element can be composed of a variety of materials and/or particles that change their associative properties or orientation and/or position in space when a magnetic field is applied.

In embodiments, the stimuli-responsive element(s) are magnetic particles and/or magnetic material. In embodiments, a “magnetic particle” or “magnetic material” as used herein can be composed of any suitable material known to the person skilled in the art that can respond to a magnetic field. In embodiments, the stimuli-responsive element can include magnetic particles and/or magnetic material having a variety of magnetic qualities, including one or more of being ferromagnetic, ferrimagnetic, antiferromagnetic, diamagnetic, paramagnetic, superparamagnetic, and/or antiferromagnetic.

In embodiments, the stimuli-responsive element includes one or more particles composed of magnetic material, including in non-limiting examples, iron (Fe), cobalt (Co), nickel (Ni), zinc (Zn), manganese (Mn), chromium (Cr), samarium (Sm), and the like, including chemical derivatives thereof. Typical derivatives, in embodiments, include alloys or oxides of metals, e.g., alloys, intermetallic, and/or oxides of Fe, Co, Ni, Zn, Mn, Sm, or any combination thereof. In embodiments, the oxides are of iron, e.g., Fe₂O₃, FeO, or Fe₃O₄. In embodiments, the magnetic particles are composed of ferrite material or of doped materials, including in non-limiting examples of one or more of Co, Ni, Zn, or Mn:FexOy.

In embodiments, the stimuli-responsive elements include one or more particles composed of organic, carbon-based, and/or biomolecule-based magnetic material including, for instance in non-limiting examples, one or more of tetracyanoethylene (TCNE) salts, [Fe(C₅Me₅)₂]⁺[TCNE]·⁻, Li[TCNE], [Mn^{II}(TPP][TCNE]· (TPP=tetraphenylporphyrin), [Fe^{II}(TCNE)(NCMe)₂][Fe^{III}Cl₄], Mn^{II}(TCNE)|(OH₂), Mn^{II}(TCNE)[C₄(CN)₈]_{1/2}, Fe(TCNE)[C₄(CN)₈]_{1/2}, Mn^{II}(TCNE)_{3/2}(I₃)_{1/2}, V^{II}[TCNE]ₓ (x=2), C₇H₅ClN₃Se₄, magnetic biopolymers.

In embodiments, the magnetic particles include or comprise a magnetite. In embodiments, a magnetite is a biodegradable, biocompatible, non-toxic molecule that has can be used as an imaging contract agent (e.g., an MRI contrast agent). In embodiments, other magnetic particles, such as red and/or black iron oxides (Fe₂O₃, FeO, and/or Fe₃O₄) can also be used.

In embodiments, the stimuli-responsive element is a transparent magnetic material. In embodiments, transparent magnetic materials are a class of materials that exhibit both transparency to visible light and magnetic properties. In embodiments, the transparent magnetic material of HYSPs can include materials used in other applications, such as optoelectronics, magneto-optical devices, and transparent electronics, for example as described in: Loste, et al., “Transparent polymer nanocomposites: An overview on their synthesis and advanced properties,” Progress in Polymer Science (2018), doi.org/10.1016/j.progpolymsci.2018.10.003; Kobayashi, et al., “Optically Transparent Ferromagnetic Nanogranular Films with Tunable Transmittance,” Sci Rep, Vol. 6, No. 34227, 2016, doi.org/10.1038/srep34227; Babu, et al., “Indium oxide: A transparent, conducting ferromagnetic semiconductor for spintronic applications,” Journal of Magnetism and Magnetic Materials (2016), doi.org/10.1016/j.jmmm.2016.05.007, Chavan, et al., “A Brief Review of Transparent Conducting Oxides (TCO): The Influence of Different Deposition Techniques on the Efficiency of Solar Cells,” Nanomaterials Vol. 13, No. 1226, 2023, doi.org/10.3390/nano13071226; Ye, et al., “Research and Progress of Transparent, Flexible Tin Oxide Ultraviolet Photodetector,” Crystals, 2021, Vol. 11, No. 1479. doi.org/10.3390/cryst11121479; Gul S, et al., “A Comprehensive Review of Magnetic Nanomaterials Modern Day Theranostics,” Front. Mater. Vol. 6, No, 179, 2019, doi: 10.3389/fmats.2019.00179; Rita Polícia, et al., “Transparent Magnetoelectric Materials for Advanced Invisible Electronic Applications,” Adv. Electron. Mater. 2019, 1900280, doi.org/10.1002/aelm.201900280, each of which is hereby incorporated by reference in their entirety.

In embodiments, transparent magnetic materials include the family of diluted magnetic semiconductors (DMS) or oxide-based transparent magnetic materials. In embodiments, DMS are formed by introducing a small concentration of magnetic ions, such as transition metal ions, into a semiconductor matrix, where the magnetic properties arise from the interaction between the magnetic ions and the host lattice. In embodiments, oxide-based transparent magnetic materials are typically composed of a transparent oxide matrix (e.g., indium tin oxide) doped with magnetic ions.

In embodiments, other types of transparent magnetic particles and materials include those based on iron oxide nanoparticles, such as magnetite (Fe₃O₄) and maghemite (γ-Fe₂O₃), which can be engineered to have a transparent nature while retaining their magnetic properties. In embodiments, stimuli-responsive elements include ferrite nanoparticles, like cobalt ferrite (CoFe₂O₄) or nickel ferrite (NiFe₂O₄), which can be synthesized in a way to achieve transparency. In embodiments, stimuli-responsive elements include rare earth iron garnets, such as yttrium iron garnet (Y₃Fe₅O₁₂), which can exhibit a strong magneto-optical effect while maintaining a degree of transparency. In embodiments, additional examples of transparent magnetic particles and materials include Sn-doped In₂O₃, FeSiB (Fe_{72.5}Si_{12.5}B₁₅), and Fe₉Co₅Al₁₉F₆₇. In embodiments, transparent magnetic particles and materials can be incorporated into polymers to form particles or beads that are suitable for the structures described herein.

In embodiments, the stimuli-responsive element can include magnetite (e.g., Fe₃O₄) alongside or in place of a number of components, e.g., including metals (e.g., magnetic elements, such as iron, nickel, cobalt, chromium, and/or manganese) and/or magnetic organic polymers (see, e.g., Rajca et al., “Magnetic Ordering in an Organic Polymer,” Science, 294, 2001: pp. 1503-1505, the entirety of which is hereby incorporated by reference). In embodiments, the particles can be composed of 100% metal oxide (e.g., magnetite), or can be composites including other components, e.g., including polymers, polymer-bonded magnets, and/or polymers comprising chromophores.

In embodiments, the stimuli-responsive element can include a magnetic bead. In embodiments, the stimuli-responsive element can include multiple magnetic particles contained within a polymer bead, e.g., polystyrene. In embodiments, the stimuli-responsive element is a spherical magnetic bead, or a spherical polymer-based bead with one or more magnetic particles contained therein.

In embodiments, the magnetic particles as stimuli-responsive elements for yolks of HYSPs can have a range of sizes, being for example from about or at least about 5 nm in size to about or at least about 50 μm in size. In embodiments, the magnetic particles are about or at least about 5 nm, about or at least about 10 nm, about or at least about 50 nm, about or at least about 100 nm, about or at least about 500 nm, about or at least about 1 μm, about or at least about 5 μm, about or at least about 10 μm, about or at least about 50 μm, including any sizes therein. In embodiments, the average particle size of magnetic particles can include a range of sizes, for example being about or at least about 5 nm to about or at least about 50 nm, about or at least about 5 nm to about or at least about 100 nm, about or at least about 5 nm to about or at least about 500 nm, about or at least about 5 rim to about or at least about 1,000 nm, about or at least about 5 nm to about or at least about 2,000 nm, about or at least about 5 nm to about or at least about 5,000 nm, about or at least about 10 nm to about or at least about 5,000 nm, about or at least about 100 nm to about or at least about 5,000 nm, about or at least about 1,000 nm to about or at least about 5,000 nm.

In embodiments, the stimuli-responsive elements include magnetic material (e.g., particles) which are magnetized, e.g., capable of being attached to iron (e.g., can project their own magnetic field), and are capable of producing a magnetic field outside themselves, either naturally or by induction. In embodiments, a magnetic field can be induced in the particles, e.g., during manufacture and/or after use, such as by exposing the particles to a strong magnetic field, e.g., an electromagnet.

In embodiments, the magnetic field (e.g., magnetic flux density) created is from about or at least about 200 gauss to about or at least about 25,000 gauss (10,000 gauss=1 Tesla). In embodiments, the magnetic field is about or at least about 200 gauss, about or at least about 500 gauss, about or at least about 800 gauss, about or at least about 1,000 gauss, about or at least about 2,500 gauss, about or at least about 12,500 gauss, about or at least about 15,000 gauss, about or at least about 20,000 gauss, or about or at least about 25,000 gauss. In embodiments, the magnetic particles retain the ability to project a magnetic field, i.e., they can become permanent magnets. In embodiments, the particles can lose the ability to produce a magnetic field over time, and a field can be re-induced by re-application of a strong magnetic field.

Magnetic particles can be prepared using any method known to those of skill in the art. For example, in embodiments, magnetic particles are formed by precipitation methods, high temperature methods, or other methods known to those skilled in the art. In embodiments, the magnetic particles can be fabricated by mechanical milling, supercritical CO₂-based precipitation of magnetite/polymer microparticles, or micelle synthesis. After fabrication, in embodiments, the particles can be sorted for size and quality, e.g., by centrifugation or filtration. A number of magnetic particles are commercially available, for example in embodiment, from Ademtech, 33600 Pessac, France; Bangs Laboratories, Inc., Fishers, IN, U.S.A.; Pea Ridge Iron Ore Co., Sullivan, MO, U.S.A.; Quantum Magnetics, Division of Clemente Associates, Inc., Madison, CT, U.S.A.; among others. In embodiments, magnetic particles can be sterilized using methods known in the cart, e.g., heat, chemical, or radiation sterilization.

In embodiments, the magnetic particles can be black, white, or colored, e.g., by coating with or synthesized with a chromophore or colorant, e.g., as described herein. In embodiments, the magnetic particles can be coated, e.g., with a clear coating, a substantially visibly transparent, biocompatible, indispersible, and/or biologically inert coating to protect the particles, or render them more inert. In embodiments, the magnetic particles are coated first with a chromophore, and then with a clear outer coating.

In embodiments, the surface of the magnetic particles can be functionalized by any chemistry techniques known to those skilled in the art to enable attachment of magnetic particles onto the surface of a yolk particle. For example, in embodiments, materials such as biological molecules and/or synthetic molecules are suitable to be used on the surface of the magnetic particles. In non-limiting embodiments, the surface of magnetic particles can be functionalized with biological molecules such as DNA sequences, RNA sequences, an oligomer, proteins and peptides, nucleic acid molecules (e.g., aptamers), or combinations thereof.

### Colorants

In embodiments, the HYSP(s) can change their optical properties in response to an external stimuli (e.g., in response to the application of a magnetic field), where the optical properties are due to the presence of one or more colorants. In embodiments, the term “colorant” refers to a chemical entity that has an optical property, including absorbing, reflecting, and/or scattering wavelength(s) of radiation in the visible spectrum, i.e., from about 380 nm to about 800 nm in wavelength. In embodiments, the term “colorant” refers to any composition of pigments, dyes, and/or unconventional substances (e.g., quantum dots, phosphorescent “glow-in-the-dark” pigments, fluorescent pigments).

In embodiments, the orientable, multiphasic yolk comprises at least one type of colorant. In embodiments, the orientable, multiphasic yolk comprises at least two types of colorants. In embodiments, colorants are attached to the surface of the orientable yolks and can range from metallic salts, such as iron oxide and titanium dioxide, to synthetic organic dyes. In embodiments, colorants can be obtained from natural sources, such as annatto extract, melanin, beta-carotene, B-Apo-8 carotenal, beet powder, canthaxanthin, caramel color, carrot oil, cochineal extract, ferrous gluconate, grape color extract, grape skin extract, paprika, riboflavin, saffron, turmeric, and vegetable juice.

In embodiments, the colorant is a chromophore that can be detected by human vision under normal lighting conditions (e.g., visible spectrum). In embodiments, the chromophore can be detected when exposed to ultraviolet (UV) radiation, near-UV radiation, infrared (IR) radiation, and/or near-IR radiation.

In embodiments, the colorant can be functionalized by any chemistry techniques known to those skilled in the art for attachment to the yolk particle. In embodiments, colorants can be attached on the surfaces of orientable, multiphasic yolks using methods known to those skilled in the art such as various covalent and/or non-covalent coupling reactions. In embodiments, the concentration of colorants attached depends upon the color and intensity of the colorant, as well as the color and texture of the substrate to which the colorant formulation (e.g., ink) is to be applied. In embodiments, the specific geometry of the orientable, multiphasic yolk influences the amount of colorant required to produce the desired effect.

In embodiments, a colorant possesses a color, brightness, fluorescence, reflectance, etc., that can be detected by human vision. In embodiments, a colorant is a pigment, dye, stain, fluorophore, metal nanoparticle, plasmonic material, anisotropic material, and/or is a combination thereof from any category.

Optical properties as described herein, in embodiments, refer to an HYSP (or an object decorated with HYSPs, or a material with HYSPs incorporated therein) having the ability to exhibit extinction, absorption, emission, reflectance, scattering, and interference properties with relation to electromagnetic radiation (e.g., light) within the visible electromagnetic spectrum having a wavelength of approximately 350 nm to about 800 nm. In embodiments, these properties include color, fluorescence, luminescence, and/or phosphorescence, among other properties, that can be observed based on electromagnetic wave (light) spectral properties.

In embodiments, the optical property is color. The color, in embodiments, includes one or more of white, black, red, orange, yellow, green, blue, indigo, and/or violet, and variations of hue, shade, and intensity therebetween.

In embodiments, the colorant includes one or more dye. In embodiments, the term “dyes” refers to substances imparting color and used, contrary to pigments, as a solution in an adequate solvent. The dye, in embodiments, includes Rhodamine B, Congo Red, Crystal Violet, Methylene Blue, Acridine Orange, Nile Red, Malachite Green, Eosin Y, Cresol Red, Fluorescein, and/or Indigo. In embodiments, the colorant is an organic or inorganic dye.

In embodiments, the colorant includes a water-soluble pigment. In embodiments, the colorant is an anthocyanin. Anthocyanins, in embodiments, are phenolic water-soluble pigments that confer a range of colors including shades and hues of red, purple, and blue to various plant materials. In embodiments, the colorant includes a microorganism-derived pigment, such as bacterial or fungal pigments, including in non-limiting examples anthraquinone, carotenoid, violacein, melanin, pyocyanin, prodiginines, asperversin, benzoquinone, anthraquinone, and derivatives thereof.

In embodiments, the colorant includes one or more pigment. In embodiments, the term “pigment” refers to the definition given in, for example DIN 55943:1993-11 and DIN EN 971-1:1 996-09 coloring materials manual, which is incorporated by reference herein in its entirety. In embodiments, pigments are materials in powder or flake form which are, contrary to dyes, not soluble in the surrounding medium.

In embodiments, the HYSP incorporates a colored pigment, including in non-limiting examples, one or more of Titanium White (PW6), Zinc White (PW4), Carbon Black (PBk7), Mars Black (PBk11), Iron Oxide Red (PR101), Cadmium Red (PR108), Alizarin Crimson (PR83), Cadmium Orange (PO20), Cadmium Yellow (PY35), Lemon Yellow (PY3), Chromium Green Oxide (PG17), Phthalo Green (PG7), Ultramarine Blue (PB29), Cobalt Blue (PB28), Cerulean Blue (PB35), Prussian Blue (PB27), Burnt Sienna (PBr7), Raw Umber (PBr7), Raw Sienna (PBr7), and/or Yellow Ochre (PY43), where the symbols in parentheses (e.g., PB29 for Ultramarine Blue) are the Pigment Color Index numbers widely used in art and elsewhere to classify colors of paint.

In embodiments, HYSPs can incorporate colorants, including pigments, for example as described in PFAFF, “The world of inorganic pigments,” Chem Texts, Vol. 8, No. 15, 2022:17 pages, the entirety of which is hereby incorporated by reference. In embodiments, the pigment is an organic pigment. In embodiments, the pigment is an inorganic pigment.

In embodiments, the HYSP exhibits one or more colors, where the one or more colors are conferred from a pigment with a chemical composition as described in one or more of Table 1 and/or Table 2.

TABLE 1
Illustrative chemical compositions for HYSP colorants.

| Illustrative | |
|---|---|
| Chemical Class | Illustrative Pigments |
| Oxide, oxide | TiO₂, ZnO, α-Fe₂O₃, α-FeOOH, γ-Fe₂O₃, |
| hydroxide | Fe₃O₄, Cr₂O₃, CrOOH, PbO, PB₃O₄, |
| | Mn₃O₄, —MnOOH, Sb₂O₃ |
| Complex oxide | CoAl₂O4, CuCr₂O₄, Co₂TiO₄, (Ti, Ni, Sb)O₂, |
| | (Ti, Cr, Sb)O₂ |
| Carbonate | 2PbCO₃•Pb(OH)₂, 2CuCO₃•Cu(OH)₂, |
| hydroxide | CuCO₃•Cu(OH)₂ |
| Sulfide, selenide | ZnS, CdS, Cd(S, Se), CdSe, γ-Ce₂S₃, HgS, As₂S₃ |
| Chromate, | PbCrO₄, Pb(Cr, S)O₄, Pb(Cr, S, Mo)O₄, ZnCrO₄, |
| molybdate | BaCrO₄, SrCrO₄ |
| Vanadate | BiVO₄, 4BiVO₄•3Bi₂MoO₆ |
| Stannate | Pb₂SnO₄, PbSn₂SiO₇, Co₂SnO₄, CoSnO₃ |
| Phosphate | Co₃(PO₄)₂ |
| Antimonate | Pb(SbO₃)₂ |
| Arsenate | Cu(AsO₃)₂ |
| Ultramarine | Na₆Al₆Si₆O₂₄(NaSₙ) |
| Hexacyanidoferrate; | K[Fe^{III}Fe^{II}(CN)₆]•xH₂O (x = 14-16) |
| hexacyanoferrate | |
| Oxonitride | CaTaO₂N, LaTaON₂ |
| Element | C, Al, Cu, Cu/Zn, Au |

TABLE 2
Illustrative color-chemical pairs as colorants for HYSPs.

| Illustrative | |
|---|---|
| Color | Illustrative Chemical |
| White | Lead white (2PbCO₃•Pb(OH)₂), kaolin, silica (SiO₂), Titanium dioxide (TiO₂/rutile |
| | and anatase), zinc oxide (ZnO), zinc sulfide (ZnS), lithopone (ZnS + BaSO₄) |
| Black | Coal (charcoal), groutite (α-MnOOH), manganite (γ-MnOOH), hausmannite |
| | (Mn₃O₄), Carbon black, iron oxide black (Fe₃O₄), spinel black (CuCr₂O₄) |
| Yellow | Yellow ochre (α-FeOOH), auric pigment (As₂S₃), lead ochre (PbO), lead tin yellow |
| | (Pb₂SnO₄, PbSn₂SiO₇), Naples yellow (Pb(SbO₃)₂), zinc yellow (Zn₂CrO₄), Indian |
| | yellow (C₁₉H₁₆O₁₀), Iron oxide yellow (α-FeOOH), chromium titanium yellow |
| | ((Ti, Cr, Sb)O₂), nickel titanium yellow ((Ti, Ni, Sb)O₂), lead yellow (PbCrO₄), |
| | cadmium yellow (CdS), bismuth yellow (BiVO₄) |
| Red | Red ocher (α-Fe₂O₃), Terra di Siena (α-Fe₂O₃), vermilion (HgS), lead red (Pb₃O₄), |
| | alizarin madder varnish, alizarin red (C₁₄H₈O₄), Iron oxide red (α-Fe₂O₃), |
| | molybdate red (Pb(Cr, S, Mo)O₄), cadmium red (Cd(S, Se)) |
| Green | Green earth (Fe silicates), Schweinfurt green (C₄H₆As₆Cu₄O₁₆), Chromium oxide |
| | green (Cr₂O₃), chromium oxide hydrate green (CrOOH), cobalt green (Co₂TiO₄) |
| Blue | Lazurite (lapis lazuli), Egyptian blue (CaCuSi₄O₁₀), azurite (2CuCO₃•Cu(OH)₂), |
| | malachite (CuCO₃•Cu(OH)₂), cobalt blue (CoAl₂O₄), Cobalt blue (CoAl₂O₄), |
| | ultramarine blue: (Na₆Al₆Si₆O₂₄(NaSn)), iron blue^{a} (K[Fe^{III}Fe^{II}(CN)₆]•xH₂O) |
| Brown | Burnt umber (Fe₂O₃•xMnO₂), brown ocher (α-Fe₂O₃ + Mn oxides), limonite |
| | (mixture of different Fe oxides) |
| Special | transparent effect pigment, goniochromatic pigments, pearlescent pigment, metallic |
| Color | pigment, interference pigment, metallic effect pigment, fluorescent pigment, |
| Effects | luminescent pigment, phosphorescent pigment, magnetic pigment, and/or |
| | anticorrosive pigment |

In embodiments, the HYSP includes an organic and/or inorganic pigment that is a white pigment. In embodiments, the white pigment is one or more of lead white (2PbCO₃·Pb(OH)₂), kaolin, silica (SiO₂), titanium dioxide (TiO₂/rutile and anatase), zinc oxide (ZnO), zinc sulfide (ZnS), and/or lithopone (ZnS+BaSO₄).

In embodiments, the HYSP includes an organic and/or inorganic pigment that is a black pigment. In embodiments, the black pigment is one or more of coal (charcoal), groutite (α-MnOOH), manganite (γ-MnOOH), hausmannite (Mn₃O₄), carbon black, iron oxide black (Fe₃O₄), and/or spinel black (CuCr₂O₄).

In embodiments, the HYSP includes an organic and/or inorganic pigment that is a colored pigment.

In embodiments, the colored pigment is a yellow pigment, including in non-limiting examples, one or more of yellow ochre (α-FeOOH), auric pigment (As₂S₃), lead ochre (PbO), lead tin yellow (Pb₂SnO₄, PbSn₂SiO₇), Naples yellow (Pb(SbO₃)₂), zinc yellow (Zn₂CrO₄), Indian yellow (C₁₉H₁₆O₁₀), iron oxide yellow (α-FeOOH), chromium titanium yellow ((Ti,Cr,Sb)O₂), nickel titanium yellow ((Ti,Ni,Sb)O₂), lead yellow (PbCrO₄), cadmium yellow (CdS), bismuth yellow (BiVO₄).

In embodiments, the colored pigment is a red pigment, including in non-limiting examples, one or more of red ocher (α-Fe₂O₃), Terra di Siena (α-Fe₂O₃), vermilion (HgS), lead red (Pb₃O₄), alizarin madder varnish, alizarin red (C₁₄H₈O₄), iron oxide red (α-Fe₂O₃), molybdate red (Pb(Cr,S,Mo)O₄), cadmium red (Cd(S,Se)).

In embodiments, the colored pigment is a green pigment, including in non-limiting examples, one or more of green earth (Fe silicates), Schweinfurt green (C₄H₆As₆Cu₄O₁₆), chromium oxide green (Cr₂O₃), chromium oxide hydrate green (CrOOH), cobalt green (Co₂TiO₄).

In embodiments, the colored pigment is a blue pigment, including in non-limiting examples, one or more of lazurite (lapis lazuli), Egyptian blue (CaCuSi₄O₁₀), azurite (2CuCO₃·Cu(OH)₂), malachite (CuCO₃·Cu(OH)₂), cobalt blue (CoAl₂O₄), ultramarine blue (Na₆Al₆Si₆O₂₄(NaSn)), iron blue (K[Fe^{III}Fe^{II}(CN)₆]·χH₂O).

In embodiments, the colored pigment is a brown pigment, including in non-limiting examples, one or more of burnt umber (Fe₂O₃·xMnO₂), brown ocher (α-Fe₂O₃+Mn oxides), limonite (mixture of different Fe oxides).

In embodiments, the HYSP includes an organic and/or inorganic pigment that includes one or more of an oxide or oxide hydroxide pigment (TiO₂, ZnO, α-Fe₂O₃, α-FeOOH, γ-Fe₂O₃, Fe₃O₄, Cr₂O₃, CrOOH, PbO, PB304, Mn₃O₄, —MnOOH, Sb₂O₃), a complex oxide pigment (CoAl₂O₄, CuCr₂O₄, Co₂TiO₄, (Ti,Ni,Sb)O₂, (Ti,Cr,Sb)O₂), a carbonate hydroxide pigment (2PbCO₃·Pb(OH)₂, 2CuCO₃·Cu(OH)₂, CuCO₃·Cu(OH)₂), a sulfide/selenide pigment (ZnS, CdS, Cd(S,Se), CdSe, γ-Ce₂S₃, HgS, As₂S₃), a chromate/molybdate pigment (PbCrO₄, Pb(Cr,S) O₄, Pb(Cr,S,Mo)O₄, ZnCrO₄, BaCrO₄, SrCrO₄), a vanadate pigment (BiVO₄, 4BiVO₄·3Bi₂MoO₆), a stannate pigment (Pb₂SnO₄, PbSn₂SiO₇, Co₂SnO₄, CoSnO₃), a phosphate pigment (Co₃(PO₄)₂), an antimonate pigment (Pb(SbO₃)₂), an arsenate pigment (Cu(AsO₃)₂), an ultramarine pigment (Na₆Al₆Si₆O₂₄(NaSn)), a hexacyanidoferrate/hexacyanoferrate pigment (K[FeIIIFeII(CN)₆]·χH₂O (χ=14-16)), an oxonitride pigment (CaTaO₂N, LaTaON₂), an elemental-based pigment (C, Al, Cu, Cu/Zn, Au), a spinel-based pigment, and/or a rutile-based metal pigment.

In embodiments, the colorant includes an organic and/or inorganic pigment that is a “special effect pigment,” including in non-limiting examples, transparent effect pigments, goniochromatic pigments, pearlescent pigments, metallic pigments, interference pigments, metallic effect pigments, fluorescent pigments, luminescent pigments, phosphorescent pigments, iridescent effect pigments, magnetic pigments, and/or anticorrosive pigments.

In embodiments, the colorant includes one or more metallic pigments. Metallic pigments, in embodiments, create a metallic effect by reflecting light, producing a shiny or glossy finish. In embodiments, the one or more metallic pigments include aluminum, bronze, and/or copper.

In embodiments, the colorant includes one or more pearlescent pigments. Pearlescent pigments, in embodiments, produce a pearly, iridescent effect by reflecting light in a diffused manner. In embodiments, the one or more pearlescent pigments include mica, titanium dioxide, and/or bismuth oxychloride.

In embodiments, the colorant includes one or more fluorescent pigments. Fluorescent pigments, in embodiments, emit light when exposed to UV light (e.g., absorbance), producing bright (e.g., emission), resulting in vivid coloration. In embodiments, the one or more fluorescent pigments include fluorescent dyes and/or pigments made from fluorescent minerals.

In embodiments, the colorant includes one or more phosphorescent pigments. Phosphorescent pigments, in embodiments, absorb light and emit light slowly over time, producing a glowing effect. In embodiments, the one or more phosphorescent pigments include zinc sulfide and/or strontium aluminate.

In embodiments, the colorant includes one or more interference pigments. Interference pigments, in embodiments, produce a unique, shimmering effect by reflecting light in different directions, depending on the angle of viewing. In embodiments, the one or more interference pigments include titanium dioxide-coated mica and/or aluminum oxide-coated mica.

In embodiments, the colorant exhibits optical effects observed that arise from structural colors. Structural color, in embodiments, arises from the physical structure of a material rather than from pigments or dyes. This phenomenon is observed in nature, where it is responsible for the vivid colors seen, for example, in peacock feathers, butterfly wings, and many other organisms. Structural color arises from the interference and diffraction of light waves as they interact with microscopic or nanoscopic structures within a material. These structures, in embodiments, can be arranged in layers, patterns, or other geometries on the surface of HYSPs that affect the way light is reflected, transmitted, or absorbed, resulting in a wide range of colors that can be iridescent, directional, and/or polarized.

In embodiments, the colorant exhibits optical property-changing effects due to the use of the mechanism of color, or changes in color, via plasmonics. Plasmonic materials, in embodiments, can control and manipulate light at the nanoscale and, by extension using engineered materials, to the micron scale, millimeter scale, and larger. Plasmonics, in embodiments, includes the interaction between light and metal surfaces, nanostructures, and/or nanoparticles. In embodiments, plasmonics focuses on the behavior of surface plasmons, which are collective oscillations of electrons in metals excited by light. In embodiments, the HYSP includes one or more colorants using plasmonics involving the propagation, confinement, and manipulation of surface plasmon polaritons (SPPs). SPPs, in embodiments, are electromagnetic waves that arise from the coupling between photons and surface plasmons.

In embodiments, the HYSP includes one or more colorants that is an anisotropic particle. In embodiments the anisotropic particle is a nanoparticle of one or more metals. In embodiments, the nanoparticle of the one or more metals comprises a nanorod of one or more of gold (Au), silver (Au), and/or aluminum (Al). In embodiments, the colorant is one or more anisotropic noble metal nanoparticles having plasmonic properties. In embodiments, the HYSP comprises a colorant including an anisotropic particle having a shape including, but not limited to, rods, star shapes, discs, core-shell particles, hollow particles, prisms, hemispheres, cubes, and/or pyramids. In embodiments, the HYSP comprises a colorant including an anisotropic particle exhibiting anisotropy due to an asymmetric organization of symmetric particles, for instance in non-limiting examples being a string of very closely-spaced 2, 3, 4, 5 or more spherical particles.

The colorant, in embodiments, includes anisotropic gold (Au) nanorods. For example, in embodiments, the HYSP contains a colorant that includes one or more Au nanorods, which produce changing optical properties as the HYSP yolk moves within the shell. In embodiments, the Au nanorods are approximately 50 nm in length and 10 nm in width. In embodiments, metal nanorods of a variety of lengths and widths can be used, for instance in non-limiting examples, the dimensions can be about or at least about 5 nm, about or at least about 10 nm, about or at least about 15 nm, about or at least about 20 nm, about or at least about 25 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 200 nm, about or at least about 300 nm, about or at least about 400 nm, about or at least about 500 nm, or about or at least about 1000 nm or more.

In embodiments, the optically active Au nanorods (and similar nanorods containing, in part, or in full Au, Ag, Al, among other plasmonic metals) exhibit optical properties that are favorable for incorporation into HYSPs. For example, in embodiments, the transverse mode-when the electromagnetic irradiation impinges on the ends of the nanorods—has a maximum extinction at around 520 nm, while the longitudinal plasmon-when the electromagnetic irradiation impinges on the longitudinal axis of the particle—is of lower energy, with a peak at around 810 nm. Thus, in embodiments, use of Au nanorods where an observer is viewing the Au nanorods, e.g., on a planar surface and irradiated from above, the longitudinal modes are excited, and the surface appears blue. In embodiments, use of Au nanorods where an observer that is viewing the same surface, where the surface of the yolk is rotated by 90°, such that the irradiation impinges on the ends of the rods, the transverse modes are excited, and a burgundy red color is observed.

In embodiments, a layer of metal nanorods are incorporated into a HYSP where the yolk is resting at stationary equilibrium along a plane, with the long axes parallel to a plane of observation. In embodiments, the layer of nanorods (among other shapes) can be located on the top portion of the yolk, at the bottom portion, and/or located any other place inside and/or on the surface of the yolk. In embodiments, the number of layers of anisotropic metal nanoparticles could be any integral number of layers, the metals used can be any metal that exhibits anisotropic optical properties, and the sizes of the nanoparticles can be any size that would be compatible with HYSPs described herein. In embodiments, the particles do not appear in a discrete layer, but are continuously (or discontinuously) dispersed within the HYSP, for example where the HYSP is composed of a transparent shell substrate, with metal nanoparticles disposed therein. In embodiments, the rods can be adsorbed to, bound, and/or affixed to a portion of the outer surface of the HYSP yolk, or within a portion of the yolk.

In embodiments, the colorant is a material that has plasmonic properties. In embodiments, the material is confined to the surface of the yolk of a HYSP and is a metal and/or propagates an optical property along the surface of a metal (depending on the geometry of the metal and the properties of the surrounding medium). In embodiments, there is plasmonic coupling between the yolk and surface/substrate on which the HYSP is disposed on, applied to, infused in, and/or placed on. In embodiments, the colorant is a plasmonic material that is or includes a continuous or discontinuous thin noble metal film and/or a surface that incorporates or contains plasmonic particles.

For example, in embodiments, the colorant is a polymer-film loaded with noble metal nanoparticles. In embodiments, the colorant is a plasmonic material, particle, foil, and/or film form of noble metal nanoparticles on or near a top portion of the yolk of the HYSP. In embodiments, the exact distance dependence of coupling between the optically active plasmonic materials depends on the size and shape, where the optical coupling is diminished exponentially with distance between surfaces. For instance, in embodiments, for a HYSP of roughly 1 μm in size, any coupling between the top of the HYSP and the surface it is disposed on is zero. However, in embodiments, when the HYSP yolk is moved due to a magnetic force, the plasmonic materials can be brought into close enough proximity to be optically coupled, where the optical properties change such that an observer can perceive a change in color, reflectance, brightness, or some other optical property. In embodiments, the HYSP can have disposed therein a colorant with plasmonic material on or nearer a bottom/side portion, such that rotation of the yolk brings the plasmonic colorant in proximity with a plasmonic surface the HYSPs are disposed on, resulting in a change of optical property. In embodiments, the degree of coupling is proportional to the change in color, reflectance, brightness, or some other optical property. In embodiments, the observed optical properties are the not sum of the independent optical properties of each material.

In embodiments, the colorant includes one or more goniochromatic materials and/or pigments. Goniochromatic materials/pigments, also known as gonioapparent or goniospectral materials/pigments, in embodiments, are materials/pigments that exhibit assorted colors or hues depending on the viewing angle or illumination direction. In embodiments, this effect is due to the presence of microscopic structures or surface features that cause light to be scattered and diffracted in a way that creates assorted colors when viewed from different angles. In embodiments, the color and appearance of goniochromatic materials/pigments is highly directional and changes dramatically as the viewing angle changes, and/or as the angle of light incidence changes. In embodiments, the one or more goniochromatic materials and/or pigments includes aluminum coated with magnesium fluoride embedded in chromium. In embodiments, the one or more goniochromatic materials and/or pigments includes silica-coated mica.

In embodiments, the goniochromatic pigment is CHROMAFLAIR (Viavi Solutions, pigments composed of thin, multi-layered flakes that have crystal structures that gives color-shifting properties). In embodiments, the HYSP includes one or more portions incorporated with CHROMAFLAIR coating or ink, creating a color-shifting effect that varies with the angle of observation (e.g., as the HYSP moves). In embodiments, the colorant is CHROMAFLAIR Green/Purple 190 (Viavi Solutions, pigment with a green face traveling though purple (at) 45° to magenta and gold). In embodiments, the goniochromatic pigment is a “color travel pigment” (such as XIRONA, Merck KgaA (Darmstadt, Germany)), including the specific pigments Nordic Sunset, Magic Mauve, Kiwi Rose, Caribbean Blue, Volcanic Fire, Golden Sky, Le Rouge, Volcanic Sparks, and Moonlight Sparks.

In embodiments, when such a yolk is at equilibrium (e.g., stationary), the goniochromatic material, with fixed incident light perpendicular to and irradiating yolk (or array of HYSPs, among other arrangements), a first baseline color (e.g., “Color 1”) can be observed. In embodiments, as a magnetic field is applied and the yolk reorients itself, a different color(s) (e.g., “Color 2”) can be observed, achieving a goniochrometric effect without the observer having to move. Typically, where goniochromic coloration is used (e.g., as car paint or in cosmetics), the observer must move to see a change in color; however, in embodiments, the observer can stay at a fixed angle, while the HYSP exhibits changing colors.

### HYSP Shells

Described herein, in embodiments, are HYSP shells which can encapsulate the orientable, multiphasic yolk. In embodiments, a HYSP can include a single, continuous shell that encapsulates the internally disposed yolk. In embodiments, the HYSP has multiple shells, or multiple layers of continuous shell. In embodiments, the shell can be made in several portions and then assembled into a continuous shell once the yolk is placed therein. In embodiments, the HYSP can have one or more noncontinuous shells, e.g., such as a porous shell.

In embodiments, the shell can have a single, uniform thickness, or have varying thicknesses. In embodiments, the shell material has a thickness of about or at least about 1 nm, about or at least about 5 nm, about or at least about 10 nm, about or at least about 15 nm, about or at least about 20 nm, about or at least about 25 nm, about or at least about 30 nm, about or at least about 40 nm, about or at least about 50 nm, about or at least about 100 nm, about or at least about 200 nm, about or at least about 300 nm, about or at least about 400 nm, about or at least about 500 nm, about or at least about 600 nm, about or at least about 700 nm, about or at least about 800 nm, about or at least about 900 nm, about or at least about 1 μm, about or at least about 2 μm, about or at least about 3 μm, about or at least about 4 μm, about or at least about 5 μm, about or at least about 10 μm, about or at least about 15 μm, about or at least about 20 μm, about or at least about 25 μm, about or at least about 30 μm, about or at least about 35 μm, about or at least about 40 μm, including sizes therebetween and ranges of sizes thereof.

In embodiments, the shell(s) can have at least a portion that is transparent to at least a portion of the visible electromagnetic spectrum (e.g., from about 380 nm to about 800 nm) such that the colorants on the yolk can be viewed through the shell(s).

In embodiments, the shell can have at least a portion that is opaque. For example, in embodiments, the shell can have a first portion that is opaque and a second portion that is transparent, so that optical properties (e.g., color change) are partially obscured through a particular viewing angle as the yolk changes its orientation inside the shell.

In embodiments, one or more shells or portions thereof can function as a blocking layer. In embodiments, a “blocking layer” refers to a shell, or a portion thereof, that functions to avoid optical bleed through, e.g., from top to bottom or side to side, that optically absorbs, deflects, blocks, or scatters light in the visible electromagnetic range (e.g., about 380 nm to about 800 nm). In embodiments, the blocking layer functions like a physical “band-pass filter,” which allows only a certain type of wavelength or band of wavelengths, and blocks or attenuates a certain type of wavelength or band of wavelengths. In embodiments, the blocking layer includes one or more opaque middle layers, for example made of one or more silica sheets (e.g., sheets of mica). In embodiments, the blocking layer can have a thickness of about or at least about 1 nm, about or at least about 5 nm, about or at least about 10 nm, about or at least about 25 nm, about or at least about 50 nm, about or at least about 100 nm, about or at least about 250 nm, about or at least about 500 nm, about or at least about 1 μm, about or at least about 2.5 μm, about or at least about 5 μm, or about or at least about 10 μm.

In embodiments, the shell material includes one or more of glass, quartz, plastic, polyethylene terephthalate, polycarbonate, polymethyl methacrylate (acrylic), polyethylene, polyurethane, polypropylene, thermoplastic elastomers (TPE), acrylonitrile butadiene styrene (ABS), epoxies and epoxy-based photoresists, hydrogels, cyclic olefin copolymer (COC) cyclic olefin polymer (COP), poly dimethyl siloxane (PDMS), poly ether ester ketone (PEEK), polyetherimide (ULTEM) and nylon. In embodiments, the shell material includes one or more thermally responsive polymer, for example a thermally responsive polymer that is compatible with additive manufacturing techniques, e.g., such as 3D printing.

In embodiments, the shell can be made composed of any material described herein. In embodiments, the shell material is composed of, at least in part, a polymer, including for example polymers of polysaccharides, lipids, amino acids, DNA, RNA, among other biological polymers, plastics, thermally responsive polymers, crude oil or petroleum (e.g., hydrocarbon) derivatives, and/or polymers compatible with additive manufacturing techniques, e.g., such as 3D printing.

In embodiments, the shell can have one or more indentations, grooves, or spaces, e.g., located on the internal surface of the shell, to affix the orientable, multiphasic yolk therein. For example, in embodiments, the shell and yolk can have a “tongue-in-groove” or “pin-in-groove” arrangement, among other mechanical couplings, which allow the yolk to fit inside and attach to the shell while still possessing degrees of freedom of movement. In embodiments, such an arrangement can be done to maintain a uniform distance between the yolk to the inside of the shell and/or to reduce friction between the yolk and shell, where only small, controllable surface areas remain in contact.

In embodiments, the shell can be functionalized with one or more materials to confer chemical, physical, and/or biological properties to the overall HYSP. Those skilled in the art, with the benefit of this disclosure in its entirety, will understand the methods used for functionalization of HYSP shells. In embodiments, the shell is functionalized with one or more materials to overcome frictional force within the cavity of HYSP so that the yolk(s) can orient themselves upon exposure to an applied force or exogenous energy. In embodiments, the mentioned elements can confer a greasy or low-friction behavior to the surface of the yolk within the HYSP cavity to ease rotation of the yolk.

In embodiments, the shell can have a stimuli-responsive element and/or be made from the material for the stimuli-responsive element. For example, in embodiments, the HYSP can have one or more shell composed of magnetic material.

### Methods of Preparation of Hollow Yolk Shell Particles (HYSPs)

In embodiments, HYSPs can be constructed using methods known to those skilled in the art. For example, the methods for preparing HYSPs can include the hard-templating method, the soft-templating method, the self-templating method, and the multi-method combination synthesis, among other methods known to those skilled in the art. The method used can vary depending on the material, shape, and the size of yolk(s) and layer(s). In embodiments, methods include different self-templating methods including galvanic replacement method, the Kirkendall method, the “ship-in-a-bottle” method, Ostwald ripening method, the selective-etching method, and the like.

In embodiments, the HYSPs are manufactured in a stepwise fashion. For example, a first part of one or more shells is prepared, then a yolk (which can be manufactured separately) is disposed therein, and a second part of the one or more shells can be placed thereon to encapsulate the yolk.

In embodiments, methods of manufacturing HYSP herein include i) preparing at least one multiphasic orientable yolk, wherein the at least one multiphasic orientable yolk comprises at least two colorants and at least one stimuli-responsive element, ii) forming a dissolution layer disposed on the at least one multiphasic orientable yolk, iii) forming at least one layer of a shell encapsulating the multiphasic orientable yolk, wherein the at least one layer of shell comprises pores, iv) repositioning the dissolution layer through the pores in the at least one layer of shell to form a cavity between the at least one multiphasic orientable yolk and the at least one layer of a shell, and v) hardening the at least one layer of a shell to form a non-porous shell. In embodiments, the multiphasic orientable yolk is configured to move inside the shell in response to an applied force or exogenous energy (e.g., magnetic field). In embodiments, repositioning the dissolution layer can include removing, dissolving, and/or etching, or otherwise applying a technique to place the material making up the dissolution layer into another configuration from where it was original deposited.

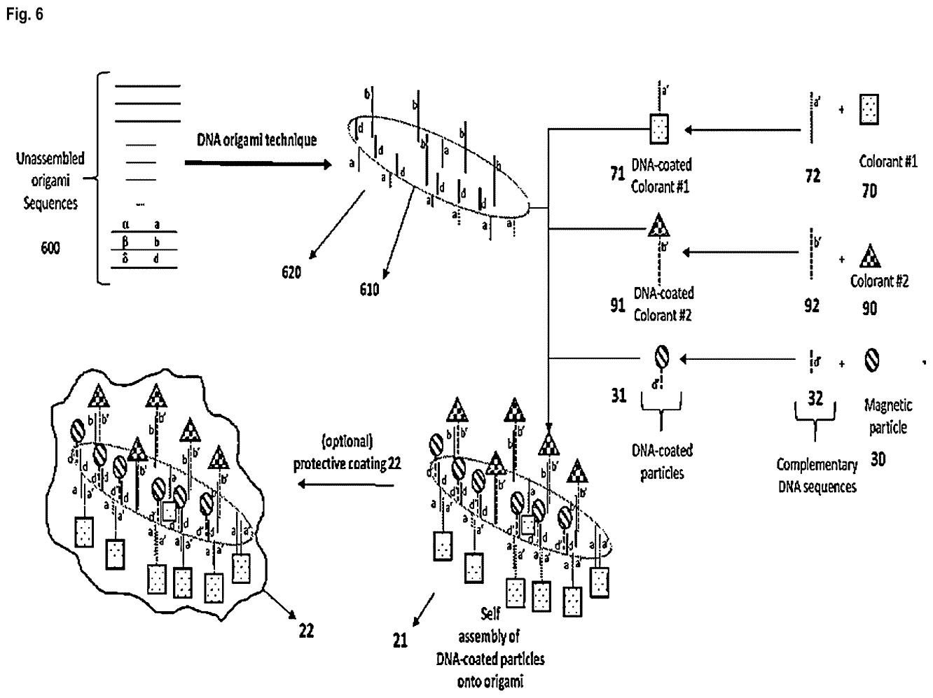

In embodiments, provided herein is a method of preparing HYSPs (e.g., as shown in FIG. 4) including a) at least one multiphasic orientable yolk and (b) at least one layer of shell. Referring to FIG. 4, in embodiments, the method includes i) preparing at least one multiphasic orientable yolk 20 (e.g., as shown in FIG. 6), ii) optionally applying a coating 400 such as a protective coating 22 (e.g., a functionalization, lubricant, surface treatment, coating, polishing agent, etc.), iii) forming a dissolution layer 410, where a dissolution layer 24 is disposed on the at least one multiphasic orientable yolk 20 or on the optional protective coating 22, iv) shell formation 420 of a shell 26 containing pores, v) etching 430 the dissolution layer 24 to form a cavity 28 in the hollow yolk-shell particles, vi) hardening 440 the shell 26 to form a non-porous shell 30, and vii) optionally forming one or more additional shells to form the hollow yolk-shell particles 100.

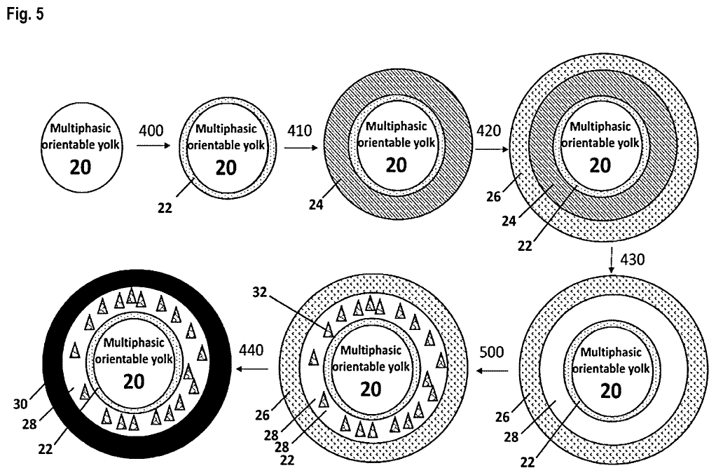

In embodiments, provided herein is a method of preparation (e.g., as shown in FIG. 5) of the hollow yolk-shell particles including a) at least one multiphasic orientable yolk, (b) at least one layer of shell; and c) thermally responsive polymers dispersed within a cavity of the hollow yolk-shell particles. Referring to FIG. 5, in embodiments, the method includes a) preparing at least one multiphasic orientable yolk 20 (e.g., as shown in FIG. 6), b) optionally coating 400 at least one multiphasic orientable yolk with a protective coating 22, c) forming a dissolution layer 410, where a dissolution layer 24 is disposed on the at least one multiphasic orientable yolk 20 or on the optional protective coating 22, d) shell formation 420 of a shell 26 containing pores, e) etching 430 the dissolution layer 24 to form a cavity 28 in the hollow yolk-shell particles, f) adding 500 thermally responsive polymers 32, where the thermal responsive polymers 32 are capable of passing through the pores of the shell to be dispersed within the cavity 28 of the hollow yolk-shell particles, g) hardening 440 the shell 26 to form a non-porous shell 30, and h) optionally forming one or more additional shells to form the hollow yolk-shell particles 100.

In embodiments, provided herein is a method of preparation (e.g., as shown in FIG. 8) of the hollow yolk-shell particles including: A) producing a silica core, B) coating the silica core with polystyrene (PSt) to form a polystyrene layer around the silica core (e.g., a dissolution layer); C) forming a silica (SiO₂) shell around the PSt layer; D) calcination at high temperature (500° C. for 4 hr.) to create a void space between the silica shell and core; and E) etching with NH₃. In embodiments, the method can include dispersing thermally responsive polymers within the void space or cavity of the hollow yolk-shell particles. In embodiments, the method includes applying one or more protective coating(s) to the core prior, for example in place of the PSt layer or in addition to. In embodiments, the method can include a hardening step after etching to close or seal any pores in the shell layer.

In embodiments, the thermally responsive polymers are selected from poloxamers, styrene-butadiene block copolymers, polymethylmethacrylate, polybutylmethacrylate, plasticized polyvinyl chloride, plasticized nylon, plasticized polyethylene terephthalate, polyethylene, polyacrylonitrile, polychlorotrifluoroethylene, poly-4,4′-isopropylidenediphenylene carbonate, polyethylene vinyl ester, polyvinyl chloride-diethyl fumarate, and combinations thereof. Alternatively, in lieu of thermally responsive polymers (e.g., as shown in FIG. 5), in embodiments, a variety of other materials can be used to fill the cavity, such materials that functions as lubricants or polishing agents, as well as materials used for chemical functionalization, surface treatment, and the like as described herein.

In embodiments, the term “protective coating” described herein is a chemically inert coating disposed onto the multiphasic orientable yolk to protect the yolk from exposure to any condition that can disrupt the assembly of the yolk. For example, in embodiments, the protective coating can be chosen from materials including, but not limited to, polymeric materials, inorganic oxides, carbon materials, and mixtures thereof. In some embodiments, protective coating is insoluble in an organic solvent.

In embodiments, the protective layer can include one or more of a chemical functionalization, lubricant, surface treatment, coating, polishing agent, etc., that comprises one or more of polytetrafluoroethylene (PTFE), hydroxylated self-assembled monolayers, vitreous enamel, ceria (cerium oxide), ceramics, anodized metals, and silica. In embodiments, the one or more functionalization, lubricant, surface treatment, coating, polishing agent, etc., is used as a mechanism to mitigate the impact of friction on the movement of a yolk inside the shell. These include but are not limited to, in embodiments, (a) adding a lubricant between the yolk and the shell, (b) surface treatments and/or coatings (e.g., TEFLON, polytetrafluoroethylene (PTFE), hydroxylated self-assembled monolayers, vitreous enamel, etc.), (c) polishing (e.g., with ceria (cerium oxide), etc.), (d) choosing materials with lower coefficients of friction (e.g., ceramics, anodized metals, silica, etc.), and/or (e) altering the dimensions and/or surface of the yolk/shell to minimize the impact of friction. In embodiments, the yolk/shell uses a combination of factors to reduce, mitigate, or otherwise control the impacts of friction on the HYSP to respond to external stimuli.

In embodiments, methods involving etching the dissolution layer include, for example, a step involving immersion in a chemical that dissolves the dissolution layer. In embodiments, etching includes a dry etching technique, such as reactive ion etching, ion beam etching, plasma etching, or laser ablation. In embodiments, etching includes a wet etching process, such as by using an acid or a base.

In embodiments, methods involving forming a shell comprising pores include, for example, forming a mesoporous shell (e.g., having pore sizes of about 2 nm to about 50 nm). Persons skill in the art, with the benefit of this disclosure in its entirety, will understand several strategies of mesoporous material synthesis that can be employed, such as those based on the use of organic template molecules as structure-directing agents around which the precursor condenses. In embodiments, a so-called soft-templating method can be used. In this approach, in embodiments, after the mesophase formation the organic template is removed by calcination and/or extraction. The removal of the template, in embodiments, results in the generation of ordered mesoporous structures whose mesopore sizes can be tuned, for example, by using different surfactants as the templates. In embodiments, various materials can be used in the template formation, including for example cationic, amphiphilic, and anionic surfactants, chiral peptide-modified surfactants, emulsions, vitamin derivatives, ionic liquids and biological materials can be distinguished. In embodiments, the soft-templating synthesis approach for generating mesoporous matrix precursors includes the use of materials such as tetraalkoxysilanes, organo-functionalized alkoxysilanes, metal alcoholanes, and fumed silica. In embodiments, this strategy allows precise control of the mesophase formation, particle morphology, pore diameter, micro- and mesoporosity via modification of synthesis conditions such as a swelling agent and a co-surfactant addition, presence of inorganic salts, matrix precursor/surfactant ratio, temperature variation, and many others.

In embodiments, methods herein make use of a hard template (e.g., mesoporous silica), such as is used for other mesoporous material preparations. This strategy is commonly applied in synthesis of mesoporous carbons. In embodiments, a mesoporous template is loaded with organic materials (e.g., sucrose), and then the organic filler is carbonized in a vacuum. In embodiments, dissolution of the silica shell can be achieved by a sufficiently strong base (e.g., sodium hydroxide) or acid (e.g., hydrofluoric acid), resulting in an uncovering of the carbon framework. Alternatively, in embodiments, a double replication procedure can be employed. In this preparation technique, in embodiments, a mesostructured silica can be used as a template for mesoporous carbon and this hard carbon matrix can serve as a replication matrix for mesoporous metal oxide.

In embodiments, the porous shell includes a mesoporous silica. In embodiments, the porous shell includes a porous organic framework.

In embodiments, the synthesis of porous organic frameworks (POFs) can be fabricated by the coupling of organic building blocks. For example, in embodiments, synthesized POFs can include covalent organic frameworks (COFs), crystalline triazine-based frameworks (CTFs), and porous aromatic frameworks (PAFs), among others which possess mesopores in the organic framework. In embodiments, COF materials with mesopores can be synthesized via condensation of diboronic acid with hydroxylated triphenylene or triptycene derivatives under mild reaction conditions. Alternatively, in embodiments, triazine-based polymer scaffolds can be formed by the polymerization of various aromatic nitriles under drastic reaction conditions (400° C. to 600° C., molten ZnCl₂). In embodiments, a porous aromatic framework with large pores can be synthesized via a Suzuki cross-coupling reaction of diphenyldiboric acid and tetrakis(4-bromophenyl) methane. In embodiments, the aforementioned materials are prepared without use of a template.

In embodiments, hardening of the porous shell can include a process of compacting and forming a solid mass of material by heat or pressure without melting it to the point of liquefaction such as, but not limiting to, sintering.

### DNA-Origami Multiphasic Particles

In embodiments, provided herein is a method of preparing a DNA-origami orientable multiphasic yolk (e.g., as shown in FIGS. 6 and 9-11). In embodiments, and in reference to FIG. 6, a non-limiting, exemplary workflow of preparing at least one multiphasic orientable yolk 21 using a “DNA origami” process is illustrated. In embodiments, “DNA origami,” as described herein, is the process by which stranded nucleic acid molecules (e.g., single-stranded or double-stranded DNA and/or RNA, linearized DNA and/or RNA, and/or circularized DNA and/or RNA) are folded into a variety of morphologies with the aid of one or more other nucleic acid molecules. In reference to FIG. 6, in embodiments, DNA molecules 600 are folded into desired morphologies with the aid of one or more additional DNA strands. In embodiments, the arrangement of DNA-based nanostructures into extended, higher order assemblies can yield the desired yolk structures where these yolk structures can optionally be coated with a protective coating 22.

In embodiments, the “DNA” refers to deoxyribonucleic acid, and can refer to genomic DNA, recombinant DNA, synthetic DNA, or cDNA. In embodiments, DNA refers to genomic DNA or cDNA. The term “DNA” is used herein to include a polymeric form of deoxyribonucleotides of any length or tertiary/quaternary structure/organization. In embodiments, where the term “DNA” is used herein, one of ordinary skill in the art will appreciate that the methods and devices described herein can be applied to other nucleic acids, for example, RNA.

In embodiments, yolk particles, e.g., multiphasic movable yolk, of the present disclosure can be constructed using DNA origami methods known to those skilled in the art. For example, DNA origami techniques including but not limited to multistranded approach or a scaffold-based approach can be used. In embodiments, DNA origami-based multiphasic yolks can be formed into any shape described herein.

In embodiments, a nucleic acid origami structure is a two-dimensional structure or a three-dimensional structure which is created from DNA. In embodiments, the DNA origami can have a mass on a mega Dalton (MDa) scale, for example having a mass of about or at least about 1 MDa, about or at least about 5 MDa, about or at least about 10 MDa, about or at least about 50 MDa, about or at least about 100 MDa, about or at least about 500 MDa, about or at least about 1,000 MDa.

Referring to FIG. 6, in embodiments, the DNA nanostructure is created from one or more of a plurality of DNA molecules 600. In embodiments, a nucleic acid origami structure is created from a scaffold strand 610 of a nucleic acid, such as DNA, which is arranged into a desired macromolecular object of a custom shape. In embodiments, staples strands of DNA (e.g., unassembled origami sequences as shown in FIG. 6 which may be shorter than the scaffold strand of DNA) can be used to direct the folding or orientation of the scaffold strand of DNA into a programmed arrangement. In embodiments, the term “origami” infers that one or more strands or building blocks of nucleic acid (e.g., DNA) can be folded or otherwise positioned into a desired structure or shape. In embodiments, the structure or shape can then be secured into the desired structure or shape by one or more other strands or building blocks of DNA, such as a plurality of staple strands of DNA molecules 600.

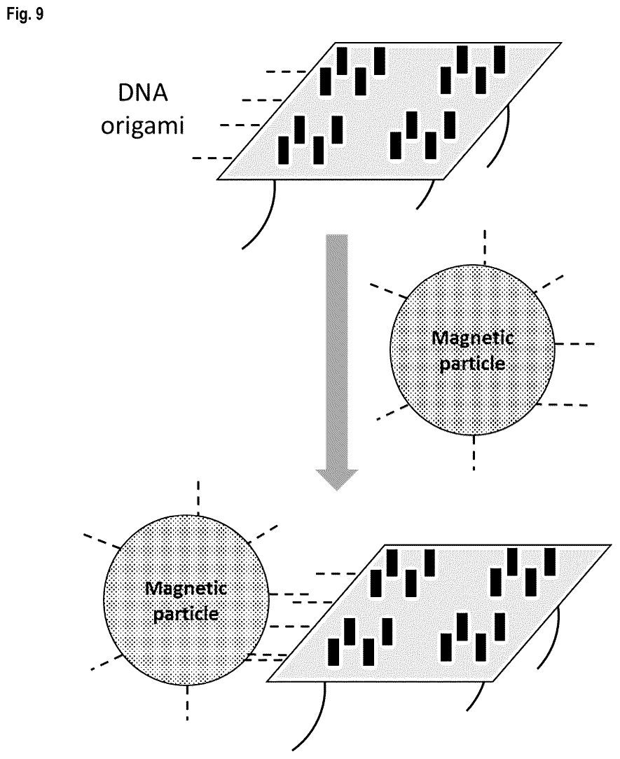

Referring to FIG. 9, in embodiments, HYSPs can be produced by assembling a DNA origami structure with one or more nucleic acid strands (e.g., single stranded DNA) which extend as “sticky ends” from the origami structure. In embodiments, these sticky ends can be complementary to one or more single stranded nucleic acids conjugated to a magnetic particle, where mixing the two in solution will result in the formation of a DNA origami-coated magnetic particle. In embodiments, the DNA origami structure can be conjugated directly to the magnetic particle.

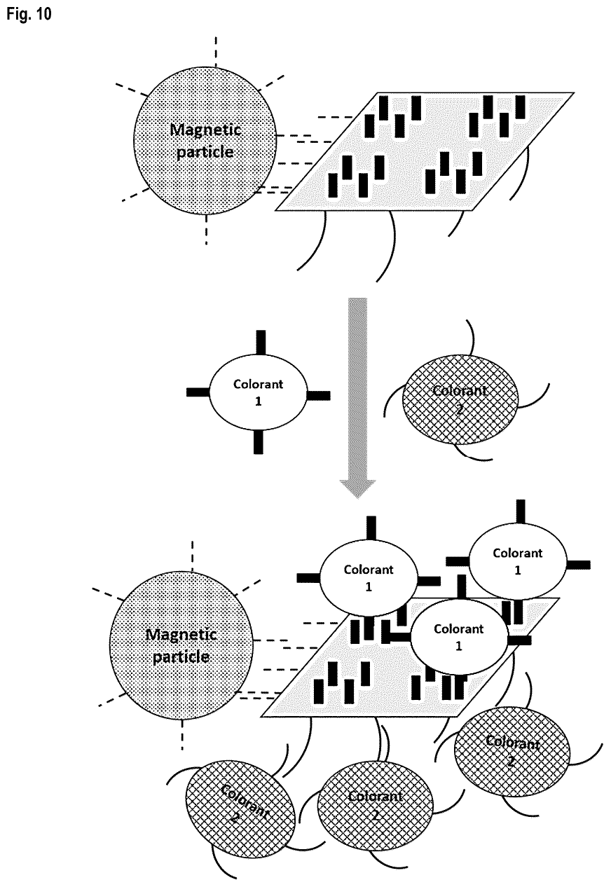

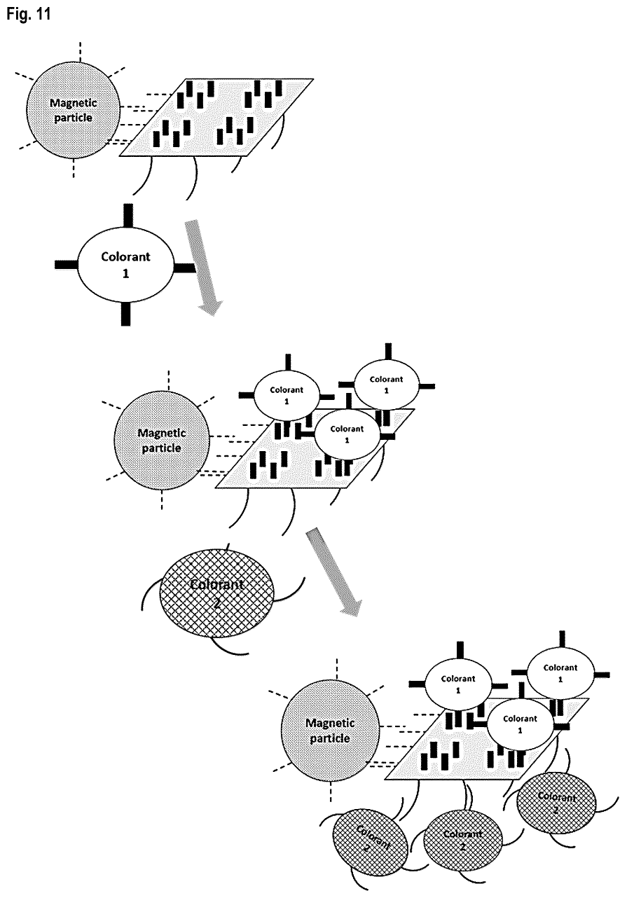

Referring to FIG. 10, in embodiments, HYSPs can be produced by designing colorants that can adhere to the DNA origami and/or magnetic particle. In embodiments, colorants can be assembled by conjugating nucleic acid (e.g., single stranded DNA) that is complementary to a nucleic acid in the origami structure, where combining the two in solution will result in the formation of a colorant-coated DNA origami particle and/or colorant-coated magnetic particle. In embodiments, the colorant can be conjugated directly to the magnetic particle.

Referring to FIG. 10, in embodiments, the application of colorants to the magnetic particle and/or DNA origami structure can be performed stepwise such that the colorant properties are confined to specific regions of the overall yolk structure.

In embodiments, the nucleic acid (e.g., single stranded DNA) is chemically modified. Chemical modification, in embodiments, can include thiolation, fluorophore, and/or chromophore conjugation. In embodiments, the chemical modification is used to produce nucleic acid that is more conducive to conjugation not one or more surface, e.g., metal nanoparticles, nanorods, magnetic material, etc. In embodiments, the magnetic particle can include metal nanoparticles, such as gold (Ag) nanoparticles or silver (Au) nanoparticles.

Methods of making DNA origami are known to those skilled in the art. In embodiments, representative methods of DNA origami can be found for example as described in: Rothemund, “Folding DNA to Create Nanoscale Shapes and Patterns”, Nature, Vol. 440, March 2006: pp. 297-302; Rothemund, “Design of DNA Origami”, Proceedings of the International Conference of Computer-Aided Design (IEEE/ACM), 2005: pp. 470-477; U.S. Pat. No. 7,842,793; Douglas et al, “Rapid prototyping of 3D DNA-origami shapes with caDNAno,” Nucleic Acids Res., Vol. 37, No. 15, 2009: pp. 5001-5006; Douglas et al., “Self-assembly of DNA into nanoscale three-dimensional shapes,” Nature, Vol. 459, 2009: pp. 414-418 (2009); Andersen et al., “Self-assembly of a nanoscale DNA box with a controllable lid,” Nature, Vol. 459, 2009: pp. 73-76; Dietz et al., “Folding DNA into Twisted and Curved Nanoscale Structures,” Science, Vol. 325, 2009: pp. 725-730; Han et al., “DNA Origami with Complex Curvatures in Three-Dimensional Space,” Science, Vol. 332, 2011: pp. 342-346; Liu et al., “Crystalline Two-Dimensional DNA Origami Arrays,” Angew. Chem. Int. Ed. Engl., Vol. 50, 2011: pp. 264-267; Zhao et al, “Organizing DNA Origami Tiles into Larger Structures Using Preformed Scaffold Frames,” Nano Lett., Vol. 11, No. 7, 2011: pp. 2997-3002; Woo et al., “Programmable molecular recognition based on the geometry of DNA nanostructures,” Nat. Chem. Vol. 3, 2011: pp. 620-627; Toning et al., “DNA origami: a quantum leap for self-assembly of complex structures,” Chem. Soc. Rev. Vol. 40, 2011: pp. 5636-5646; Berengut, et al., “Design and synthesis of pleated DNA origami nanotubes with adjustable diameters,” Nucleic Acids Res. Vol. 47, No, 22, 2019: pp. 11963-75; Chen, et al., “Nanoscale 3D spatial addressing and valence control of quantum dots using wireframe DNA origami,” Nat Comm. Vol. 13, No. 4935, 2022; Wang, et al., “Planar 2D wireframe DNA origami,” Sci. Adv. Vol. 8, No. 20, 2022; Peil, et al., “DNA Assembly of Modular Components into a Rotary Nanodevice,” ACS Nano, Vol. 16, 2022: pp. 5284-91; and Wintersinger, et al., “Multi-micron crisscross structures grown from DNA-origami slats,” Nat. Nanotechnol. Vol. 18, 2022: pp. 281-289, each of which is hereby incorporated by reference in their entirety.

In embodiments, the nucleic acid origami structure integrated into a multiphasic orientable yolk is not constructed of a scaffold strand and staple strands. In embodiments, the nucleic acid origami structure can be constructed by single stranded nucleic acid sequences which self-assemble into tiles to form lattices of any desired shape or size. In embodiments, such single stranded nucleic acid sequences can be designed and synthesized de novo. Such approaches include, in embodiments, programmed self-assembly of designed strands of nucleic acids to create a wide range of structures with desired shapes, for example as described in Wei et al., “Complex shapes self-assembled from single-stranded DNA tiles,” Nature, Vol. 485, 2012: pp. 623-627, the entirely of which is hereby incorporated by reference.

Those skilled in the art will understand that the principles of the present disclosure do not rely on any particular method of making DNA origami, or any particular two-dimensional or three-dimensional nucleic acid shape. Those skilled in the art with the benefit of this disclosure will understand that aspects of the ability of DNA origami to provide unique shapes, to provide locations to hybridize a nucleic acid sequence bearing a functional moiety or group or have directly labeled or tagged functional or detectable moieties are useful in embodiments of the present disclosure. Those skilled in the art with the benefit of this disclosure will understand that aspects of the ability to design DNA origami with desired hybridization sites or desired probes are useful in embodiments of the present methods e.g., for attaching colorant and/or stimuli-responsive elements.

In embodiments, a scanning instrument can be used to visualize and distinguish nucleic acid origami structures. In embodiments, the scanning instrument is an electron microscope, including a transmission electron microscope (TEM), a scanning electron microscope (SEM), a scanning transmission electron microscope (STEM), an environmental scanning electron microscope (ESEM), a cryo-electron microscope (cryo-EM), and other electron microscopes known to those of skill in the art. Transmission electron microscopes and methods of using ‘FEMs are known to those of skill in the art, for example as described in Morel, “Visualization of Nucleic Acids,” The Spreading of Nucleic Acids, p. 35-56, CRC Press, Boca Raton (1995).

In embodiments, in reference to FIG. 6, the DNA origami is constructed to be essentially planar, such that sequence “b” is nominally perpendicular to the plane and is available for binding throughout one plane (or face or side) of the origami structure, where sequence “a” is nominally perpendicular to the plane and is available for binding throughout the other side of the origami structure, and sequence d is nominally perpendicular to the plane and is available for binding only at one edge of one side of the plane. In embodiments and still in reference to FIG. 6, attaching DNA sequence which possess some level of complementarity to the DNA sequences in the origami structure (denoted a' 72 and b' 73) to colorant #1 70 and colorant #2 90, i.e., forming DNA-coated colorant #1 71 and DNA-coated colorant #2 91, can enable the DNA-colorant complexes to bind to opposite sides of the origami particle. In embodiments and continuing in reference to FIG. 6, attaching a third DNA sequence which possess some level of complementarity to the DNA sequences in the origami structure (denoted d′ 32) to a stimuli-responsive particle, e.g., magnetic particle 30, can enable the resultant DNA-coated particle 31 to bind to a face of the origami structure, for example at the edge of the plane.

In reference to FIG. 6, in embodiments, after obtaining the DNA origami shape 620, self-assembly chemistry can be used to attach, in a regiospecific fashion, stimuli-responsive elements (e.g., magnetic particle 30) and colorants imparting different type of properties (e.g., DNA-coated colorant #1 71, DNA-coated colorant #2 91) onto the surface of DNA origami-based yolk 620. These interactions, in embodiments, include a variety of biochemical interactions, such as but not limited to, ligand-receptor, DNA-DNA, antibody-antigen etc. In embodiments, other techniques known to those skilled in the art such as click chemistry, or -NHS coupling chemistry can be used to attach other elements and/or colorants on the surface of DNA origami-based yolk. In embodiments, the assembly of the stimuli-responsive elements (e.g., magnetic particle 30) and colorants (e.g., colorant #1 70 and colorant #2 90) to the DNA origami-based yolk 620 can be directed through a variety of noncovalent interactions (e.g., hydrogen bonding, hydrophobic forces, van der Waals forces, π-π interactions (pi-pi interactions), and/or electrostatics).

Continuing in reference to FIG. 6, in embodiments, a DNA-coated colorant #1 71, a DNA-coated colorant #2 91, and a DNA-coated particle 31 can be obtained separately and then be self-assembled on the DNA origami-based yolk 620 to obtain an exemplary multiphasic orientable yolk 21. In such an embodiment, the complementary DNA sequences (e.g., a′ 72, b′ 92, and d′ 32) are designed to be complementary to at least a portion of the surface-exposed DNA sequences of the DNA origami-based yolk 620, and can be attached to the colorants (e.g., colorant #1 70, colorant #2 90) and stimuli-responsive elements (e.g., magnetic particle 30) through covalent or non-covalent chemistries using methods known to those skilled in the art.

### Additive Manufacturing

In embodiments, HYSPs can be generated, prepared, and/or manufactured (or manufactured in part) by additive manufacturing techniques, for example, including forming the particle by assembling, gluing, screwing, and/or affixing of two or more components; injection molding, and/or micro-injection molding; self-assembly, adsorption, coacervation, and/or mixing; polymerization, extrusion, and/or manipulation of polymers; additive manufacturing, CNC machining (Computer Numerical Control machining), urethane casting, microcontact printing, dip pen lithography, beam pen lithography, photolithography, e-beam lithography, and/or 3D printing.

In embodiments, methods of manufacturing the HYSP can include a number of fabrication techniques used to generate particles on size scales from millimeters through microns down to nanometer dimensions. In embodiments, these methods include in non-limiting examples: (i) assembly of two or components (e.g., gluing, screwing, affixing a top portion and a bottom portion; or a left portion and a right portion), (ii) injection molding, micro-injection molding, or similar techniques which involve a mold or cast; (iii) by chemical or physical methods including but not limited to self-assembly, adsorption, coacervation, and/or mixing; (iv) polymerization, extrusion, and/or manipulation of polymers; (v) additive manufacturing, also known as 3D printing, (vi) photolithographic techniques; (vii) microcontact printing, (viii) other lithographic techniques such as beam pen lithography; among other (ix) miscellaneous methods.

In embodiments, the one or more materials used for generating HYSPs includes one or more thermally responsive polymers including one or more of poloxamers, styrene-butadiene block copolymers, polymethylmethacrylate, polybutylmethacrylate, plasticized polyvinyl chloride, plasticized nylon, plasticized polyethylene terephthalate, polyethylene, polyacrylonitrile, polychlorotrifluoroethylene, poly-4,4′-isopropylidenediphenylene carbonate, polyethylene vinyl ester, polyvinyl chloride-diethyl fumarate, and combinations thereof.

In embodiments, generating the HYSPs includes micro-injection molding, which is a manufacturing process used to create small, high-precision plastic parts. In embodiments, the process involves injecting molten plastic, metal, and/or polymer-based material into a mold cavity, which can be designed to the exact specifications of the desired part, or portions thereof. In embodiments, the mold is then cooled, and the part is removed from the mold. In embodiments, the technique typically produces parts that are on the scale of micrometers to a few millimeters in size. In embodiments, micro-injection molding is used for its high accuracy, repeatability, and efficiency, making it a suitable choice for mass production of small parts. Injection molding processes are used in a variety of industries, including in medical, electronics, and automotive industries, where small, complex parts are needed. Non-limiting examples of parts made by micro-injection molding include micro gears and other small mechanical parts for use in watches, cameras, and other precision devices or instruments, microfluidic devices for use in medical and laboratory applications, small components for electronic devices, such as micro connectors, micro switches, and micro lenses for cameras, small medical implants such as hearing aid components, and miniature automotive components, such as gears, valves, and connectors, used in engines and other mechanical systems. Thus, in embodiments, methods of manufacturing HYSPs and substrates, surfaces, and/or materials for HYSPs can use techniques for making any of the above objects.

In embodiments, HYSPs can be manufactured via 3D printing (referred to herein as “3DP”), a process of creating 3-dimensional objects by subsequent addition of layers of molten material via a printer device compatible with a variety of materials including plastics, polymers, ceramics, metals, etc. In embodiments, 3DP allows for the creation of complex shapes and structures that would be difficult to produce with traditional manufacturing methods. In embodiments, a digital model of the object is created using computer-aided design (CAD) software. In embodiments, the printer reads the digital model and adds successive layers of material, such as plastic, metal, or biological material, until the object is complete to the specifications described in the digital model. Additive manufacturing, in embodiments, can be used to print a wide range of materials, including plastics/polymers, metals, ceramics, composites, and biological substances, as well as more complex materials such as paper, wood, wax, and food.

In embodiments, 3DP has benefits over traditional manufacturing methods, including reduced waste, faster production times, and greater design flexibility. There are currently seven general classes of 3D printing methods: material extrusion, vat polymerization, powder bed fusion, material jetting, binder jetting, directed energy deposition, and sheet lamination. In embodiments, the size of dimensions available using 3DP depend on the specific type of 3D printing technology and the capabilities of the printers used; however, in general, the largest dimensions available using 3DP can be several meters in length, width, and height, and the smallest dimensions available using 3DP can be in the range of micrometers to sub-micrometers, achieved using advanced 3D printing technologies, such as stereolithography (SLA), digital light processing (DLP), or two-photon polymerization (2PP), which can print with high precision and high resolution. For example, in embodiments, commercial 3D printers based on 2-photon polymerization (2PP) are available through UPNANO (3D printer manufacturer) to produce polymeric objects spanning 12 orders of magnitude, from centimeters to nanometers in size.

In embodiments, HYSPs and components thereof can be 3D printed onto a substrate surface (e.g., such as a glass slide) and can be released from the substrate surface via several methods. In embodiments, 3D printed HYSPs and components can be removed by mechanical separation (e.g., with a razor). In embodiments, for example during scalable manufacturing, HYSPs can also be released by chemical separation (e.g., via applying a solvent), thermal separation (e.g., by heating), ultrasonic separation (e.g., by sonication), and/or by vacuum release. Depending on the 3D printer used, the method of 3D printing, the composition of the HYSP, and the type of substrate used, additional methods for release are known to those skilled in the art.

In embodiments, HYSPs can be generated using techniques for 3D printing, including but not limited to, fused deposition modeling (FDM), fused filament fabrication (FFF), stereolithography (SLA), selective laser sintering (SLS), binder jetting (BJ), direct energy deposition (DED), digital light process (DLP), liquid crystal display (LCD), polymer jetting (Poly Jet technology), multi-jet fusion (MJF), direct metal laser sintering (DMLS), electron beam melting (EBM), laminated object manufacturing (LOM), continuous liquid interface production (CLIP), electron beam melting, and/or digital light processing (DLP).

### Chemical Manufacturing

Alternatively, in embodiments, chemical techniques such as coacervation can be used to generate the HYSPs. Coacervation, in embodiments, is a process in which two or more polymers are mixed together in a solution and undergo phase separation to form two distinct phases. In embodiments, one phase is rich in polymer, while the other phase is depleted in polymer and mostly contains solvent. Coacervation, in embodiments, is used to produce microspheres or microcapsules, which are small, spherical particles that can be used for drug delivery, encapsulation, and other applications. During coacervation, in embodiments, the polymers undergo a process of self-assembly, where they form complex structures through non-covalent interactions such as electrostatic forces, hydrogen bonding, and van der Waals forces. The resulting microspheres or microcapsules can be tailored to have specific properties such as size, shape, and composition, making them useful in a variety of fields. In embodiments, generating the particles can include a combination of coacervation and molding parts for HYSPs.

In embodiments, generating particles for HYSPs includes the chemical method of click chemistry, a class of simple, atom-economy reactions commonly used for joining two molecular entities of choice. Click reactions, in embodiments, occur in a single vessel, are not sensitive to water, generate minimal byproducts, and are “spring-loaded”—characterized by a high thermodynamic driving force that quickly and irreversibly drives the reaction to high yield of a single reaction product, with high reaction specificity (in some cases, with both regio- and stereo-specificity). In embodiments, generating particles for HYSPs includes other chemical methods well-known (especially in life sciences) for joining two entities together including in non-limiting examples, streptavidin-biotin coupling, maleimide-based reactions, and carbodiimide-based reactions.

In embodiments, a variety of techniques focused on using polymers to generate 3D materials can be used to synthesize HYSPs. For example, in embodiments, snowmen-shaped anisotropic Janus particles are described in KANG and HONCIUC, “Influence of Geometries on the Assembly of Snowman-Shaped Janus Nanoparticles”, ACS Nano, Vol. 12, No. 4:2018: pp. 3741-3750, which is hereby incorporated by reference in its entirety. In embodiments, such particles can be manufactured from poly(tert-butyl acrylate)-poly(3-(triethoxysilyl)propyl methacrylate) (PtBA-PTPM).

Methods of manufacturing HYSPs herein, in embodiments, include formulating the HYSPs into a fluid, suspension, ink, liquid film, and/or adhesive substrate, material, and/or surface. In embodiments, the fluid, suspension, ink, liquid film, and/or adhesive substrate, material, and/or surface is suitable to be applied to an object. In embodiments, formulating the HYSPs into a fluid, suspension, ink, liquid film, and/or adhesive includes combining the HYSPs with one or more solvent. In embodiments, the solvent includes an aqueous solvent. In embodiments, the solvent includes a non-aqueous solvent. In embodiments, the solvent is an organic solvent. In embodiments, the media includes one or more of water, ketones, alcohols, esters, nitriles, and combinations thereof.

Methods of manufacturing HYSPs herein, in embodiments, include formulating the HYSPs into a foil, film, thin plastic, and/or paper substrate, material, and/or surface. In embodiments, the foil, film, thin plastic, and/or paper substrate, material, and/or surface is suitable to be affixed to, or embedded in, an object. In embodiments, formulating the HYSPs into a foil, film, thin plastic, and/or paper include formulation a liquid form of HYSPs and spraying a thin layer of suspended HYSPs onto a surface area of a foil, film, thin plastic, and/or paper.

Methods of manufacturing HYSPs herein, in embodiments, include formulating the GRP into a fiber, thread, yarn, and/or twine substrate, material, and/or surface. In embodiments, the fiber, thread, yarn, and/or twine substrate, material, and/or surface is suitable to be woven into an article of clothing, a cloth, and/or a tarp.

### Compositions of Hollow Yolk Shell Particles (HYSPs)

In embodiments, the HYSPs of the present disclosure can be used, for example, as coloring agents in a variety of compositions, such as in liquid ink (e.g., solvent-based ink, water-based ink), solid or phase change ink compositions, and the like. In embodiments, the ink composition presented herein can exist in various forms, including but not limited to, liquid, curable, solid, hot melt, phase change, gel, or the like. In embodiments, compositions comprise HYSPs in a suspension, fluid, and/or solvent (e.g., an aqueous solvent and/or inorganic solvent). In embodiments, compositions comprise an object and/or material coated with HYSPs. In embodiments, compositions comprise an object and/or material embedded with HYSPs.

In embodiments, the HYSP is formulated into a fluid, suspension, ink, liquid film, and/or adhesive substrate, material, and/or surface. In embodiments, the fluid, suspension, ink, liquid film, and/or adhesive substrate, material, and/or surface is suitable to be applied to an object, e.g., as a paint, ink, liquid film, etc. that can be painted onto a surface of an object where, after drying, the HYSPs can respond to a magnetic field and the paint, ink, liquid film, etc. will change its optical properties (e.g., color) as a function of the viewing angle and/or orientation of the yolk in response to the magnetic field.

In embodiments, the composition includes HYSPs formulated into a fluid, suspension, ink, liquid film, and/or adhesive substrate, material, and/or surface. In such embodiments, the HYSPs can be present in mass per volume, for example at about or at least about 0.001 mg/ml, about or at least about 0.01 mg/mL, about or at least about 0.1 mg/mL, about or at least about 1.0 mg/ml, about or at least about 10 mg/mL, about or at least about 50 mg/mL, about or at least about 100 mg/ml, about or at least about 150 mg/mL, about or at least about 200 mg/ml, about or at least about 250 mg/mL, about or at least about 300 mg/mL, about or at least about 350 mg/mL, or about or at least about 400 mg/ml or more.

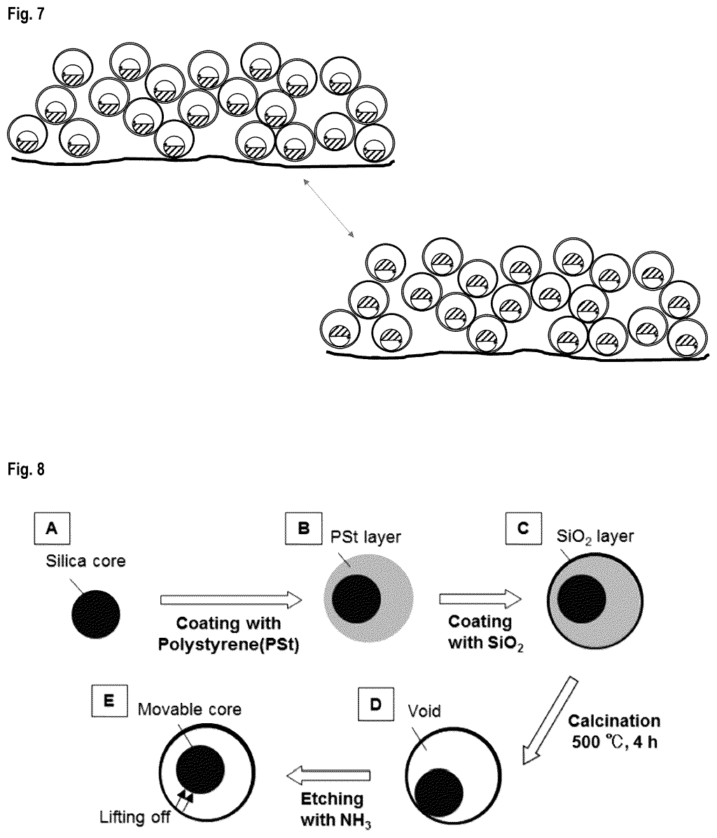

In embodiments, the ink composition, as used herein, refers to a fluid, suspension, and liquid film formulations of HYSPs which can be painted onto, or otherwise applied to, a surface. In reference to FIG. 7, in embodiments, the HYSPs can be deposited and/or disposed onto a surface or an object in multiple layers.

In embodiments, the ink compositions contain one or more colorant due to the HYSPs of the present disclosure. In embodiments, any colorant can be employed in the ink compositions, including one or more pigments, dyes, mixtures of pigment and dye, mixtures of pigments, mixtures of dyes, and the like.

In embodiments, the colorant of the composition is or comprises the HYSPs. For example, the colorant can typically be present in an amount of at least about 0.1 percent by weight of the ink, such as about or 0.2 percent by weight of the ink or at least about 0.5 percent by weight of the ink, and typically no more than about 90 percent by weight of the ink, such as no more than about 50 percent by weight of the ink or no more than about 30 percent by weight of the ink, although the amount can be outside of these ranges.

In embodiments, the disclosed particles and ink compositions can also comprise other substances than HYSPs of the present disclosure to improve the properties and applicability of ink composition on various surfaces. For example, the ink composition of the present technology may further comprise beneficial compounds including, but not limited to, viscosity modifiers; dispersants; surfactants; solvent carriers; antioxidants; viscosity controlling agents; additional colorants, resins, binders, or combinations thereof.

In embodiments, the ink compositions described herein are solvent-based ink compositions. The solvent-based ink compositions, in embodiments, include an ink solvent, an optional binder or binder resin, and one or more optional additive. The ink solvent, in embodiments, can be selected from the group consisting of, but not limiting to, water, ketones, alcohols, esters, nitriles, and combinations thereof. In embodiments, the ink solvent is present in an amount from about 10% to about 90% by weight, from about 20% to about 85% by weight, from about 50% to about 85% by weight, or from about 65% to about 80% by weight, based on the total weight of the ink composition.

In embodiments, the optional additive is selected from the group consisting of plasticizers, surfactants, light stabilizers, defoaming agents, antioxidants, UV stabilizers, bactericides, conducting agents, rub resistant agents, and combinations thereof. In embodiments, the additive comprises one or more plasticizers for solubilizing the binder.

In embodiments, the ink compositions described herein are polymer-based ink compositions. For example, in embodiments, the polymer-based ink compositions can include thermoplastic polymers (e.g., an acrylic), polymers curable by UV irradiation generally in the presence of photoinitiator, and the like.

In embodiments, the ink compositions described herein including HYSPs of the present disclosure can be formulated as an enamel ink composition. The enamel ink, in embodiments, can include a liquid medium (also known as a vehicle or carrier) for suspending the inorganic pigments and oxide fries so that they can be uniformly and homogeneously applied to the surface of the substrate before firing (e.g., prior to being placed in a kiln or heat source). In embodiments, the liquid medium can include a solvent (e.g., an alcohol), an organic oil (e.g., one or more terpenes), a polymer precursor (e.g., an acrylate precursor if the ink is to be cured by UV radiation), and/or a viscosity-adjusting additive (e.g., one or more glycols, such as butylene glycol). In embodiments, the liquid medium can be formulated such that it evaporates, or is otherwise removed, during the optional drying, pre-firing, or heat treatment process.

### Methods of Use of Hollow Yolk Shell Particles (HYSPs)

In embodiments, HYSPs particles and compositions thereof of the present disclosure can be applied to objects, surfaces, and/or substrates, including but not limited to, polymer, paper, fabric, metal, clay board, ceramic, window, glass, plastic, computer chip, wood, construction material, and/or human or animal tissue or skin for decorative, aesthetic, artistic, security, information storage, energy management, and/or cosmetic purposes. In embodiments, the stimuli responsive HYSPs can be functionalized by any element and/or encapsulated into any element in order to increase applicability of the composition and/or use in desired form.

In embodiments, the surface and/or substrate is planar or non-planar. In embodiments, the surface and/or substrate comprises at least a portion that is convex, concave, or without a well-defined shape. In embodiments, the surface and/or substrate is on an interior surface of an object, an exterior surface of an object, or both, and wherein the object is a non-HYSP object.

In embodiments, the surface and/or substrate comprises indentations and/or divots. In embodiments, the indentations and/or divots are arranged in an array. In embodiments, the HYSP is disposed in and/or on the indentations and/or divots. In embodiments, the surface and/or substrate comprises pillars, posts, and/or stops. In embodiments, the HYSP is disposed in and/or on the pillars, posts, and/or stops. In embodiments, the surface and/or substrate comprises one or more grooves. In embodiments, the HYSP is disposed in and/or on the one or more grooves.

In embodiments, methods herein of using HYSPs include providing the HYSP, formulating the HYSP is formulated into a fluid, suspension, ink, liquid film, and/or adhesive substrate and/or material, and applying the fluid, suspension, ink, liquid film, and/or adhesive substrate and/or material to an object and/or surface. In embodiments, applying further includes spraying, gluing, embedding, writing, printing, and/or blotting, for example as is appropriate for applying a fluid, suspension, ink, liquid film, and/or adhesive. In embodiments, formulating can include combining, suspending, and/or homogenizing the HYSPs with one or more solvents or components, as described herein. In embodiments, the object is polymer, paper, fabric, metal, clay board, ceramic, window, glass, plastic, computer chip, wood, construction material, and/or human or animal tissue. In embodiments, the object and/or surface exhibits optical property changing properties as a function of the application of a magnetic field.

In embodiments, the fluid, suspension, ink, liquid film, and/or adhesive substrate, material, and/or surface is suitable to be applied to an object. For example, in non-limiting embodiments such compositions of HYSPs can be sprayed, written, printed, and/or blotted onto a surface and/or substrate material. In embodiments, ink compositions comprising HYSPs can be applied to a substrate of interest under external stimuli, e.g., a magnetic field to ensure the proper alignment of HYSPs on the surface of the substrate. For example, the proper orientation of HYSPs can be determine by the form of magnetic field (e.g., strength, direction, etc.) and can depend on the properties (e.g., alignment, physicochemical properties, etc.) of stimuli-responsive element(s) attached to the yolk.

In embodiments, methods herein of using HYSPs include providing the HYSP, formulating the HYSP is formulated into a foil, film, thin plastic, and/or paper substrate and/or material, and applying the foil, film, thin plastic, and/or paper substrate and/or material to an object and/or surface. In embodiments, applying further includes spraying, gluing, embedding, writing, printing, and/or blotting, for example as is appropriate for applying a foil, film, thin plastic, and/or paper substrate and/or material. In embodiments, formulating can include combining, suspending, and/or homogenizing the HYSPs with one or more solvents or components, as described herein. In embodiments, the object is polymer, paper, fabric, metal, clay board, ceramic, window, glass, plastic, computer chip, wood, construction material, and/or human or animal tissue. In embodiments, the object and/or surface exhibits optical property changing properties as a function of the application of a magnetic field.

In embodiments, the foil, film, thin plastic, and/or paper substrate, material, and/or surface is suitable to be applied to, affixed to, or embedded in, an object. For example, in non-limiting embodiments, such compositions of HYSPs could be glued onto a surface. In non-limiting embodiments, the HYSPs can be sprayed onto a surface and dried into a foil, film, thin plastic, and/or paper substrate or material.

In embodiments, methods herein of using HYSPs include providing the HYSP, formulating the HYSP is formulated into a fiber, thread, yarn, and/or twine substrate and/or material, and applying the foil, fiber, thread, yarn, and/or twine substrate and/or material to an object and/or surface. In embodiments, applying further includes weaving and/or embedding, for example as is appropriate for applying a fiber, thread, yarn, and/or twine substrate and/or material. In embodiments, formulating can include combining, weaving, and/or extruding the HYSPs with one or more solvents or components, as described herein. In embodiments, the object is polymer, paper, fabric, metal, clay board, ceramic, window, glass, plastic, computer chip, wood, construction material, and/or human or animal tissue. In embodiments, the object and/or surface exhibits optical property changing properties as a function of the application of a magnetic field.

In embodiments, the fiber, thread, yarn, and/or twine substrate, material, and/or surface is suitable to be woven into an article of clothing, a cloth, and/or a tarp.

In embodiments, objects can have HYSPs applied to them to confer stimuli-responsive behavior. In embodiments, the object includes a consumer good with HYSPs incorporated therein, for example, packaging with HYSPs incorporated therein, fabrics with HYSPs woven therein, paper/foil products coated with HYSPs, such as in currency, etc.

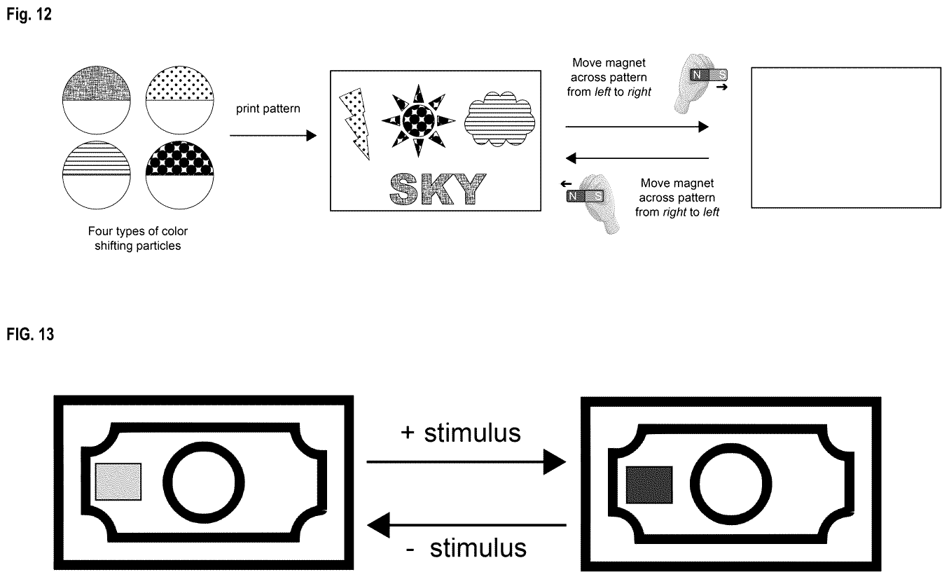

In embodiments, HYSPs can be used to imbue an object with stimuli-responsive behavior for displaying graphics, markings, text, and/or patterns. For example, in reference to FIG. 12, in embodiments, several types of color-shifting HYSPs (e.g., the 4 used to make the illustration) can be printed in a particular pattern on a surface where, upon application of a magnetic field, the pattern can disappear, reappear, or change to display a difference in the graphics, text, or pattern. In embodiments, the graphics, text, and/or patterns can incorporate any number of HYSPs, such as 2, 3, 4, 5, 6, or more distinct HYSPs, each having the same of different colorants.

In embodiments, HYSPs can be used to imbue an object with stimuli-responsive behavior as a security measure, for example for authentication and/or anti-counterfeit measures of paper currency, authenticity markers of documents, and the like. For example, in reference to FIG. 13, in embodiments, a marking a graphic, marking, message, and/or pattern can be imbued within and/or on the surface of paper currency where, upon application of a magnetic stimulus, the graphic, marking, message, and/or pattern can change its optical property, such as its coloration. In embodiments, can be used as a security element or security feature of bank notes and other documentation. In embodiments, the terms “security element” or “security feature,” as used herein, denotes an image or graphic element that can be used for authentication purposes. The security element or security feature can, in embodiments, be an overt and/or a covert security element. In embodiments, the compositions described herein (e.g., ink composition) allows the use of HYSPs in the field of the protection of the security documents against illegal or unsanctioned actions/use such as counterfeiting. In embodiments, HYSPs can be assembled onto a surface in the form of typeset, print, and/or imagery. In embodiments, the object and/or surface can change its coloration and/or fluorescent property after applying a magnetic field, or changing the direction of the magnetic field.

In embodiments, described herein is a method of tagging a material including providing at least one HYSP or formulation thereof, as described herein, and associating a material with the at least one HYSP or formulation, thereby forming a tagged material.

In embodiments, described herein is a method of authenticating a material and/or object including a) providing a formulation of an HYSP, as described herein, wherein the formulation includes a fluid, suspension, ink, liquid film, and/or adhesive substrate and/or material; a foil, film, thin plastic, and/or paper substrate and/or material; or a fiber, thread, yarn, and/or twine substrate and/or material, and tagging an object and/or surface with the formulation, and reading the tagging. In embodiments, the tagging is configured to be read by a sensor and/or optical imaging device. In embodiments, the reading comprises applying a magnetic field to determine an optical property change in the object and/or surface due to the presence of the HYSP.

In embodiments, HYSPs can be applied to a surface or object as a singular “taggant,” or in combination with one or more additional taggants. In embodiments, HYSPs can be composed of non-toxic starting materials for tagging consumer-facing objects without causing any adverse effects to individuals handling the, for example skin irritation or staining, etc. In embodiments, HYSPs can be combined with covert taggants to generate a feature with both overt and covert readout characteristics and a unique signature. Alternatively, in embodiments, the size of the overt features can be reduced to a size where a sensor or optical imaging device would be required for authentication. In embodiments, HYSP features involve one or more optical attributes including the use of a sensor-based authentication measurement of one or more wavelengths, amplitudes, or frequencies. The measurements, in embodiments, can be continuous or intermittent, or can involve a single acquisition. In embodiments, existing sensors used, for example in the banknote industry, can read HYSP-based security features, such as a handheld reading device (for quality control after ink incorporation), large-format sheet readers (at the printer), shoebox-sized high-speed readers (for banknote sorters), and portable, pocket-sized readers (for use in the field).

In embodiments, packaging, including adhesives, paper, plastics, labels, and seals; agrochemicals, seeds, and crops; artwork and memorabilia; computer chips; cosmetics and perfumes; compact disks (CDs), digital video disks (DVDs), and videotapes; documents, money, and other paper products (e.g., labels, passports, stock certificates); inks, paints, and dyes; electronic devices; automobiles and manufacturing components; explosives; food and beverages, tobacco; textiles, clothing, footwear, designer products, and apparel labels; polymers; hazardous waste; movie props and memorabilia, sports memorabilia and apparel; manufacturing parts; petroleum, fuel, lubricants, oil; pharmaceuticals and vaccines.

In embodiments, HYSPs can be used in applications of ink compositions in the field of tissue markings, for example in cosmetics, tattoos, and/or semi-permanent makeup. In embodiments, HYSPs are biologically inert particles that are less than about 10 μm in size that can be disposed on, or embedded within, a layer of the skin. For example, in embodiments, HYSPs that are about 10 μm and smaller can be used to confer color-changing properties to the materials used in cosmetics, tattoos, and/or semi-permanent makeup. In embodiments, the cosmetics, tattoos, and/or semi-permanent makeup changes its optical property (e.g., color) as a function of exposure to a magnetic field.

In embodiments, HYSPs can be used as camouflage. In embodiments, the camouflage is adaptive camouflage and/or thermal camouflage. In embodiments, HYSPs can obscure signals emanating through various ranges of electromagnetic radiation. For example, in embodiments, HYSPs can be coated on and/or embedded into fabric, sheets, or films which can be used to filter, scatter, reduce, or otherwise block an infrared signal (i.e., infrared signature), thus providing adaptive and/or thermal camouflage. In embodiments, HYSPs can be used as adaptive camouflage by changing optical properties as a function of a magnetic field being applied to portions of the fabric, sheets, or films with HYSPs. In embodiments, HYSPs can be used as thermal camouflage by obscuring the apparent temperature difference and the contrast radiant intensity of the object coated in HYSPs (or materials incorporating HYSPs) in relation to the object's environment or background.

In embodiments, HYSPs can be used for electronic memory and storage purposes. In embodiments, HYSPs can be arranged in an array where an optical state (e.g., two or more different optical properties) can be assigned to each HYSP in an array to store and/or retrieve information. For example, in embodiments, the information can be retrieved by reading the optical states of an array of HYSPs, where the HYSPs can be read, or otherwise decoded, based on the storage mode, e.g., using each HYSP as a “bit” and reading sets of 8 HYSPs in an array as a byte of information. In embodiments, the optical state is binary, e.g., where each HYSP exhibits either a first optical property or colorant, or a second optical property or color, as the yolk is oriented. In embodiments, the optical state is changed by the application of a magnetic field.

In embodiments, the HYSP is positioned between a first substrate and a second substrate. For example, in embodiments, HYSPs can be used as obscurants, “sandwiched” between two or more substrates (e.g., glass, quartz, plexiglass, etc.) for use in windows, mirrors, skylights, doors, etc. In embodiments, HYSPs used as obscurants can be placed between two or more surfaces with one or more layers of HYSPs therebetween such that when a magnetic field is applied, the view across the two or more transparent materials is blurred, obscured, or otherwise blocked. In embodiments, at least one of the first substrate and the second substrate can be composed a material that is transparent to at least a portion of the visible electromagnetic (EM) spectrum, as described herein. In embodiments, the material can have a thickness of about or at least about 50 nm, is about or at least about 100 nm, is about or at least about 500 nm, about or at least about 1 μm, is about or at least about 10 μm, is about or at least about 100 μm, about or at least about 1 mm, about or at least about 5 mm, or about or at least about 10 mm.

In embodiments, the surface and/or substrate changes color as a function of the presence of a magnetic field. In embodiments, wherein the HYSP comprises at least a first surface with a shape that is complementary to a shape of a second surface of the HYSP, for instance for more close packing of HYSPs arranged on a surface.

In embodiments, the surface and/or substrate is treated with one or more of a lubricant, surface treatment, adhesive, coating, and/or polishing agent, as described herein. For example, the surface and/or substrate treatment can be to affix HYSPs to an object.

In embodiments, the disclosure is directed to the following embodiments:

Embodiment 1. An ink composition comprising stimuli responsive hollow yolk-shell particles, wherein hollow-yolk shell particles comprising: a) at least one multiphasic orientable yolk, and (b) at least one layer of shell.

Embodiment 2. The ink composition of embodiment 1, wherein at least. one multiphasic orientable yolk is capable of rotating on its own axis upon exposure to magnetic field.

Embodiment 3. The ink composition of embodiment 1, wherein a cavity of the hollow yolk-shell particles comprises thermally responsive polymers.

Embodiment 4. The ink composition of embodiment 3, wherein the thermally responsive polymers are selected from poloxamers, styrene-butadiene block copolymers, polymethylmethacrylate, polybutylmethacrylate, plasticized polyvinyl chloride, plasticized nylon, plasticized polyethylene terephthalate, polyethylene, polyacrylonitrile, polychlorotrifluoroethylene, poly-4,4′-isopropylidenediphenylene carbonate, polyethylene vinyl ester, polyvinyl chloride diethyl fumarate, and combinations thereof.

Embodiment 5. The ink composition of embodiment 3, wherein at least one multiphasic orientable yolk is capable of rotating on its own axis upon exposure to magnetic field and heat.

Embodiment 6. The ink composition of embodiment 1, wherein at least one multiphasic orientable yolk is coated with a protective coating.

Embodiment 7. The ink composition of embodiment 1, wherein the protective coating is selected from the group consisting of polymeric materials, inorganic oxides, carbon materials and mixtures thereof.

Embodiment 8. The ink composition of embodiment 1, wherein at least one layer of shell comprises silica.

Embodiment 9. The ink composition of embodiment 1, wherein at least one multiphasic orientable yolk is a multiphasic particle having a surface comprising: (a) at least one first colorant on. a first side of the surface; (b) at least one second colorant on a second side of the surface; and (c) at least one stimuli responsive element on any one of the sides of the surface, wherein the first side of the surface and the second side of the surface are opposing each other.

Embodiment 10. The ink composition of embodiment 9, the colorant is selected from a dye, a pigment or combination thereof.

Embodiment 11. The ink composition of embodiment 9, at least one stimuli responsive element is selected from polymers, organic nanoparticles, organic micro particles, inorganic nanoparticles, inorganic microparticles, metals, metal salts, lipids, DNA, or combination thereof.

Embodiment 12. The ink composition of embodiment 9, at least one stimuli responsive element is responsive to magnetic field.

Embodiment 13. The ink composition of embodiment 12, wherein the stimuli responsive element is selected from magnetic field responsive particles.

Embodiment 14. The ink composition of any of the embodiments 1-13 for use in decorative, aesthetic. artistic and security applications.

Embodiment 15. A method of preparing at least one multiphasic orientable yolk of embodiment 1 comprises DNA origami technique.

Embodiment 16. A hollow yolk-shell particle comprising: (a) at least one multiphasic orientable yolk; and (b) at least one layer of shell, wherein at least one multiphasic orientable yolk is a multiphasic particle having a surface comprising: (a) at least one first colorant on. a first side of the surface; (b) at least one second colorant on a second side of the surface; and (c) at least one stimuli. responsive element on any one of the sides of the surface.

Embodiment 17. A hollow yolk-shell particle of embodiment 16, wherein the first side of the surface of the orientable yolk and second side of the surface of the orientable yolk are opposite to each other through the surface of the orientable yolk.

Embodiment 18. A hollow yolk-shell particle of embodiment 16, wherein at least one layer of shell comprises a silica.

Embodiment 19. A hollow yolk-shell particle of embodiment 16, wherein at least one stimuli responsive element is selected from. magnetic field responsive particles.

Embodiment 20. A hollow yolk-shell particle of embodiment 19, wherein magnetic field responsive particles are selected from ferromagnetic particles, ferromagnetic particles, diamagnetic particles, paramagnetic particles, superparamagnetic particles, antiferromagnetic particles, or combination thereof.

Embodiment 21. A hollow yolk-shell particle of embodiment 16, a cavity of the hollow yolk-shell particle comprises thermally responsive polymers.

Embodiment 22. A hollow yolk-shell particle of embodiment 21, wherein the thermally responsive polymers are selected from poloxamers, styrene-butadiene block copolymers, polymethylmethacrylate, polybutylmethacrylate, plasticized polyvinyl chloride, plasticized nylon, plasticized polyethylene terephthalate, polyethylene, polyacrylonitrile, polychlorotrifluoroethylene, poly-4,4′-isopropylidenediphenylene carbonate, polyethylene vinyl ester, polyvinyl chloride-diethyl fumarate, and combinations thereof.

Embodiment 23. A hollow yolk-shell particle of embodiment 16 and embodiment 21 for use in ink compositions.

Embodiment 24. A method of preparation of the hollow yolk-shell particles of embodiment 16 comprising: a. preparing at least one multiphasic orientable yolk; b. optionally coating at least one multiphasic orientable yolk with a protective coating; c. forming a dissolution layer, wherein a dissolution layer is disposed on the at least one multiphasic orientable yolk or on the optional protective coating; d. forming a shell comprising pores; e, etching the dissolution layer to form a cavity of the hollow yolk-shell particles; f. hardening the shell to form a non-porous shell; and e. optionally forming one or more shells to form the hollow yolk-shell particles of embodiment 16.

Embodiment 25. The method of embodiment 24, wherein preparing at least one multiphasic orientable yolk comprises DNA origami technique.

Embodiment 26. The method of embodiment 25, wherein preparing at least one multiphasic orientable yolk further comprises self-assembly of a DNA-coated at least one first colorant, a DNA-coated at least one second colorant and a DNA-coated at least one stimuli responsive element.

Embodiment 27. A method of preparation of the hollow yolk-shell particles of embodiment 21 comprising: a. preparing at least one multiphasic orientable yolk; b. optionally coating at least one multiphasic orientable yolk with a protective coating; c. forming a dissolution layer, wherein a dissolution layer is disposed on the at least one multiphasic orientable yolk or on the optional protective coating; d. forming a shell comprising pores; e, etching the dissolution layer to form a cavity of the hollow yolk-shell particles; f. adding thermally responsive polymers, wherein the thermal responsive polymers are capable of passing through the pores of the shell to be dispersed within the cavity of the hollow yolk-shell particles; g. hardening the shell to form a non-porous shell; and h. optionally forming one or more shells to form the hollow yolk-shell particles of embodiment 21.

Embodiment 28. A hollow yolk-shell particle comprising: a) at least one multiphasic orientable yolk; and (b) at least one layer of shell.

Embodiment 29. The hollow yolk-shell particle of embodiment 26, wherein at least one multiphasic orientable yolk is capable of rotating on its own axis upon exposure to magnetic field.

Embodiment 30. The hollow yolk-shell particle of embodiment 26, wherein at least one multiphasic orientable yolk is formed using a technique comprising DNA. origami.

Embodiment 31. The hollow yolk-shell particle of embodiment 26, wherein a cavity of the hollow yolk-shell particles comprises thermally responsive polymers.

Embodiment 32. The hollow yolk-shell particle of embodiment 29, wherein at least one multiphasic orientable yolk is capable of rotating on its own axis upon exposure to magnetic field and heat.

Embodiment 33. The hollow yolk-shell particle of embodiment 26, wherein at least one multiphasic orientable yolk is coated with a protective coating.

Embodiment 34. The hollow yolk-shell particle of embodiment 26, wherein the protective coating is selected from the group consisting of polymeric materials, inorganic oxides, carbon materials and mixtures thereof.

Embodiment 35. The hollow yolk-shell particle of embodiment 26, wherein at least one layer of shell comprises silica.

Embodiment 36. The hollow yolk-shell particle of embodiment 26, wherein at least one multiphasic orientable yolk is a multiphasic particle having a surface comprising (a) at least one first colorant on a first side of the surface; (b) at least one second colorant on a second side of the surface; and (c) at least one stimuli responsive element on any one of the sides of the surface, wherein the first side of the surface and the second side of the surface are opposing each other.

Embodiment 37. The hollow yolk-shell particle of embodiment 34, wherein the colorant is selected from a dye, a pigment or combination thereof.

Embodiment 38. The hollow yolk-shell particle of embodiment 34, wherein at least one stimuli responsive element is selected from polymers, organic nanoparticles, organic micro particles, inorganic nanoparticles, inorganic microparticles, metals, metal salts, lipids, DNA, or combination thereof.

Embodiment 39. The hollow yolk-shell particle of embodiment 34, wherein at least one stimuli responsive element is responsive to magnetic field.

Embodiment 40. The hollow yolk-shell particle of any of the embodiments 26-37 for use in ink compositions.

In embodiments, the disclosure is directed to the following embodiments:

Embodiment 1001. A stimuli-responsive hollow yolk-shell particle (HYSP) comprising: a) at least one multiphasic orientable yolk comprising at least two colorants and at least one stimuli-responsive element; and b) at least one layer of a shell encapsulating the multiphasic orientable yolk, wherein at least a portion of the shell comprises a material that is transparent to at least a portion of the visible electromagnetic spectrum between about 380 nm to about 800 nm; and wherein the multiphasic orientable yolk is configured to move inside the shell in response to an applied force or exogenous energy.

Embodiment 1002. The stimuli-responsive HYSP of embodiment 1001, wherein the applied force or exogenous energy is a magnetic field.

Embodiment 1003. The stimuli-responsive HYSP of embodiment 1001 or 1002, wherein the HYSP comprises a dimension of about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, about or at least about 20 μm, or about or at least about 50 μm.

Embodiment 1004. The stimuli-responsive HYSP of any one of the preceding embodiments, wherein the HYSP comprises a space between the at least one multiphasic orientable yolk and the at least one layer of a shell of about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, or about or at least about 20 μm.

Embodiment 1005. The stimuli-responsive HYSP of any one of the preceding embodiments, wherein the HYSP comprises a shape, geometry, and/or morphology of one or more of spherical, ellipsoidal, spindle, rodlike, cubic, starlike, cylindrical, plate, tetrahedron, and dodecahedron.

Embodiment 1006. The stimuli-responsive HYSP of any one of the preceding embodiments, wherein the at least one multiphasic orientable yolk comprises a material comprising one or more of metals, metal oxides, silica, organic polymers, inorganic polymers, biological polymers, synthetic polymers, and combinations thereof.

Embodiment 1007. The stimuli-responsive HYSP of embodiment 1006, wherein the one or more synthetic polymers comprises plastics, thermally responsive polymers, latex, hydrocarbons, crude oil derivatives and/or petroleum derivatives.

Embodiment 1008. The stimuli-responsive HYSP of embodiment 1007, wherein the one or more thermally responsive polymers comprise poloxamers, styrene-butadiene block copolymers, polymethylmethacrylate, polybutylmethacrylate, plasticized polyvinyl chloride, plasticized nylon, plasticized polyethylene terephthalate, polyethylene, polyacrylonitrile, polychlorotrifluoroethylene, poly-4,4′-isopropylidenediphenylene carbonate, polyethylene vinyl ester, polyvinyl chloride-diethyl fumarate, and/or combinations thereof.

Embodiment 1009. The stimuli-responsive HYSP of embodiment 1006, wherein the one or more synthetic polymers comprises poly(tert-butyl acrylate)-poly(3-(triethoxysilyl)propyl methacrylate) (PtBA-PTPM), polystyrene latex polymer, carboxylated latex polymer, aminated latex polymer, colored polystyrene polymer (dye-infused and/or pigment-infused), colored polystyrene-based carboxylated latex polymer (dye-infused and/or pigment-infused), fluorescent polystyrene-based polymers, fluorescent polystyrene-based carboxylated latex polymers, fluorescent aminated polystyrene-based polymer, surfactant-free polystyrene, carboxylated surfactant-free polymer, polymethyl methacrylate (PMMA) latex polymer, and/or divinylbenzene (DVB)-crosslinked polystyrene latex polymer.

Embodiment 1010. The stimuli-responsive HYSP of embodiment 1006, wherein the one or more biological polymers comprises nucleic acid (DNA, RNA), amino acid (peptide, protein), polysaccharide, and/or lipid.

Embodiment 1011. The stimuli-responsive HYSP of embodiment 1006, wherein the one or more biological polymers comprise stranded nucleic acids arranged into one or more patterns and/or morphologies, and the one or more stranded nucleic acids are disposed on and/or within the at least one multiphasic yolk.

Embodiment 1012. The stimuli-responsive HYSP of any one of the preceding embodiments, wherein the at least one multiphasic orientable yolk comprises a dimension of about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, about or at least about 20 μm, or about or at least about 50 μm.

Embodiment 1013. The stimuli-responsive HYSP of any one of the preceding embodiments, wherein the at least one multiphasic orientable yolk comprises a dimension smaller than the HYSP.

Embodiment 1014. The stimuli-responsive HYSP of embodiment 1013, wherein the at least one multiphasic orientable yolk comprises a dimension smaller than the HYSP by about or at least about 1 nm, about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 15 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, about or at least about 20 μm, or about or at least about 30 μm, or about or at least about 40 μm.

Embodiment 1015. The stimuli-responsive HYSP of any one of the preceding embodiments, wherein the at least one multiphasic orientable yolk comprises a structure, shape, geometry, and/or morphology, of one or more of spherical, ellipsoidal, spindle, rodlike, cubic, starlike, cylindrical, plate, regularly shaped, irregularly shaped, triangular, trapezoidal, octagonal, tetrahedron, and dodecahedron.

Embodiment 1016. The stimuli-responsive HYSP of any one of the preceding embodiments, wherein the at least one multiphasic orientable yolk comprises a Janus particle.

Embodiment 1017. The stimuli-responsive HYSP of any one of the preceding embodiments, wherein the at least one multiphasic orientable yolk comprises one or more magnetic particles contained within a polymer bead.

Embodiment 1018. The stimuli-responsive HYSP of any one of the preceding embodiments, wherein the at least one multiphasic orientable yolk is coated with a protective coating.

Embodiment 1019. The stimuli-responsive HYSP of embodiment 1018, wherein the protective coating comprises a chemical functionalization, lubricant, surface treatment, coating, polishing agent, and/or combinations thereof.

Embodiment 1020. The stimuli-responsive HYSP of embodiment 1018, wherein the protective coating comprises polymeric materials, inorganic oxides, carbon materials, polytetrafluoroethylene (PTFE), hydroxylated self-assembled monolayers, vitreous enamel, ceria (cerium oxide), ceramic, anodized metal, silica, and/or combinations thereof.

Embodiment 1021. The stimuli-responsive HYSP of any one of the preceding embodiments, wherein the at least one multiphasic orientable yolk comprises a shape, geometry, and/or morphology that fits within a congruent shape, geometry, or morphology of an inner surface of at least one layer of the shell.

Embodiment 1022. The stimuli-responsive HYSP of embodiment 1021, wherein the shape, geometry, or morphology of the at least one multiphasic orientable yolk comprises a pin that fits within a congruent groove of the at least one layer of shell.

Embodiment 1023. The stimuli-responsive HYSP of any one of the preceding embodiments, wherein the yolk is suspended in a fluid media, a semi-solid media, non-Newtonian fluid or media, and/or a combination thereof.

Embodiment 1024. The stimuli-responsive HYSP of any one of the preceding embodiments, wherein the at least one multiphasic orientable yolk is configured to rotate on its own axis upon exposure to a magnetic field.

Embodiment 1025. The stimuli-responsive HYSP of any one of the preceding embodiments, wherein the at least one multiphasic orientable yolk is suspended within the at least one layer of the shell and configured to move freely in response to a magnetic field.

Embodiment 1026. The stimuli-responsive HYSP of any one of the preceding embodiments, wherein the at least one multiphasic orientable yolk comprises a solid nanoparticle.

Embodiment 1027. The stimuli-responsive HYSP of any one of embodiments 1001-1025, wherein the at least one multiphasic orientable yolk comprises a fluid, ferrofluid, semi-solid, and/or non-Newtonian fluid.

Embodiment 1028. The stimuli-responsive HYSP of any one of the preceding embodiments, wherein the at least one stimuli-responsive element comprises a magnetic material.

Embodiment 1029. The stimuli-responsive HYSP of embodiment 1028, wherein the magnetic material is ferromagnetic, ferrimagnetic, antiferromagnetic, diamagnetic, paramagnetic, superparamagnetic, and/or antiferromagnetic.

Embodiment 1030. The stimuli-responsive HYSP of embodiment 1028 or 1029, wherein the magnetic material is organic, carbon-based, and/or biomolecule-based comprising one or more of tetracyanoethylene (TCNE) salts, [Fe(C5Me5)2]⁺[TCNE]·⁻, Li[TCNE], [MnlITPP][TCNE]. (TPP=tetraphenylporphyrin), [FeII(TCNE)(NCMe)2][FeIIICl4], MnII(TCNE)I(OH2), MnII(TCNE)[C4(CN)8]1/2, Fe(TCNE)[C4(CN)8]1/2, MnII(TCNE)3/2(I3)1/2, VII[TCNE]x (x≈2), C7H5ClN3Se4, magnetic organic polymers, and/or polymer-bonded magnets.

Embodiment 1031. The stimuli-responsive HYSP of embodiment 1028 or 1029, wherein the magnetic material comprises iron (Fe), cobalt (Co), nickel (Ni), zinc (Zn), manganese (Mn), chromium (Cr), samarium (Sm), alloys or oxides thereof; alloys, intermetallic, and/or oxides of Fe, Co, Ni, Zn, Mn, Sm; oxides are of iron, Fe2O3, FeO, and/or Fe3O4; ferrite material and/or doped materials of Co, Ni, Zn, and/or Mn:FexOy, and/or magnetite.

Embodiment 1032. The stimuli-responsive HYSP of any one of embodiments 1028-1031, wherein the magnetic material comprises magnetic particles and/or beads.

Embodiment 1033. The stimuli-responsive HYSP of embodiment 1032, wherein the magnetic particles and/or beads comprise a dimension of about or at least about 5 nm, about or at least about 10 nm, about or at least about 50 nm, about or at least about 100 nm, about or at least about 500 nm, about or at least about 1 μm, about or at least about 5 μm, about or at least about 10 μm, about or at least about 50 μm, or comprise a range of dimensions from about or at least about 5 nm to about or at least about 50 nm, about or at least about 5 nm to about or at least about 100 nm, about or at least about 5 nm to about or at least about 500 nm, about or at least about 5 rim to about or at least about 1,000 nm, about or at least about 5 nm to about or at least about 2,000 nm, about or at least about 5 nm to about or at least about 5,000 nm, about or at least about 10 nm to about or at least about 5,000 nm, about or at least about 100 nm to about or at least about 5,000 nm, about or at least about 1,000 nm to about or at least about 5,000 nm.

Embodiment 1034. The stimuli-responsive HYSP of any one of embodiments 1028-1033, wherein the magnetic material is configured to create a magnetic field of about or at least about 200 gauss, about or at least about 500 gauss, about or at least about 800 gauss, about or at least about 1,000 gauss, about or at least about 2,500 gauss, about or at least about 12,500 gauss, about or at least about 15,000 gauss, about or at least about 20,000 gauss, or about or at least about 25,000 gauss; or a magnetic field having a range of about or at least about 200 gauss to about or at least about 25,000 gauss.

Embodiment 1035. The stimuli-responsive HYSP of any one of the preceding embodiments, wherein the at least one stimuli-responsive element comprises magnetic material configured to be magnetized and/or produce a magnetic field.

Embodiment 1036. The stimuli-responsive HYSP of any one of the preceding embodiments, wherein the HYSP comprises 2 colorants, 3 colorants, 4 colorants, 5 colorants, 6 colorants, 7 colorants, colorants, colorants, or 10 or more colorants.

Embodiment 1037. The stimuli-responsive HYSP of any one of the preceding embodiments, wherein the at least two colorants comprise a color in the visible electromagnetic spectrum comprising an extinction, absorption, emission, reflectance, scattering, and/or interference at a wavelength from about or at least about 350 nm to about or at least about 800 nm.

Embodiment 1038. The stimuli-responsive HYSP of any one of the preceding embodiments, wherein the color comprises one or more of white, black, red, orange, yellow, green, blue, indigo, violet, and variations of hue, shade, and intensity therebetween.

Embodiment 1039. The stimuli-responsive HYSP of any one of the preceding embodiments, wherein the at least two colorants comprise a dye, pigment, stain, fluorophore, metallic salt, and/or chromophore.

Embodiment 1040. The stimuli-responsive HYSP of embodiment 1039, wherein the at least two colorants comprise one or more dyes.

Embodiment 1041. The stimuli-responsive HYSP of embodiment 1040, wherein the dye is an organic or inorganic dye.

Embodiment 1042. The stimuli-responsive HYSP of embodiment 1040, wherein the dye comprises one or more of Rhodamine B, Congo Red, Crystal Violet, Methylene Blue, Acridine Orange, Nile Red, Malachite Green, Eosin Y, Cresol Red, Fluorescein, and Indigo.

Embodiment 1043. The stimuli-responsive HYSP of any one of the preceding embodiments, wherein the two or more colorants comprises a pigment.

Embodiment 1044. The stimuli-responsive HYSP of embodiment 1043, wherein the pigment comprises a water-soluble pigment.

Embodiment 1045. The stimuli-responsive HYSP of embodiment 1044, wherein the water-soluble pigment is one or more of anthocyanin, anthraquinone, carotenoid, violacein, melanin, pyocyanin, prodiginines, asperversin, benzoquinone, anthraquinone, and derivatives thereof.

Embodiment 1046. The stimuli-responsive HYSP of embodiment 1043, wherein the pigment comprises one or more of Titanium White (PW6), Zinc White (PW4), Carbon Black (PBk7), Mars Black (PBk11), Iron Oxide Red (PR101), Cadmium Red (PR108), Alizarin Crimson (PR83), Cadmium Orange (PO20), Cadmium Yellow (PY35), Lemon Yellow (PY3), Chromium Green Oxide (PG17), Phthalo Green (PG7), Ultramarine Blue (PB29), Cobalt Blue (PB28), Cerulean Blue (PB35), Prussian Blue (PB27), Burnt Sienna (PBr7), Raw Umber (PBr7), Raw Sienna (PBr7), and Yellow Ochre (PY43).

Embodiment 1047. The stimuli-responsive HYSP of embodiment 1043, wherein the pigment is an organic pigment.

Embodiment 1048. The stimuli-responsive HYSP of embodiment 1043, wherein the pigment is an inorganic pigment.

Embodiment 1049. The stimuli-responsive HYSP of embodiment 1047 or 1048, wherein the organic pigment or inorganic pigment comprises a white pigment.

Embodiment 1050. The stimuli-responsive HYSP of embodiment 1049, wherein the white pigment is one or more of lead white (2PbCO₃·Pb(OH)₂), kaolin, silica (SiO₂), titanium dioxide (TiO₂/rutile and anatase), zinc oxide (ZnO), zinc sulfide (ZnS), and lithopone (ZnS+BaSO₄).

Embodiment 1051. The stimuli-responsive HYSP of embodiment 1047 or 1048, wherein the organic pigment or inorganic pigment comprises a black pigment.

Embodiment 1052. The stimuli-responsive HYSP of embodiment 1051, wherein the black pigment is one or more of coal (charcoal), groutite (α-MnOOH), manganite (γ-MnOOH), hausmannite (Mn₃O₄), carbon black, iron oxide black (Fe₃O₄), and spinel black (CuCr₂O₄).

Embodiment 1053. The stimuli-responsive HYSP of embodiment 1047 or 1048, wherein the organic pigment or inorganic pigment comprise a colored pigment.

Embodiment 1054. The stimuli-responsive HYSP of embodiment 1053, wherein the colored pigment comprises a yellow pigment.

Embodiment 1055. The stimuli-responsive HYSP of embodiment 1054, wherein the yellow pigment comprises one or more of yellow ochre (α-FeOOH), auric pigment (As2S3), lead ochre (PbO), lead tin yellow (Pb2SnO4, PbSn2SiO7), Naples yellow (Pb(SbO3)2), zinc yellow (Zn2CrO4), Indian yellow (C19H16O10), iron oxide yellow (α-FeOOH), chromium titanium yellow ((Ti,Cr,Sb)O2), nickel titanium yellow ((Ti,Ni,Sb)O2), lead yellow (PbCrO4), cadmium yellow (CdS), and bismuth yellow (BiVO₄).

Embodiment 1056. The stimuli-responsive HYSP of embodiment 1053, wherein the colored pigment comprises a red pigment.

Embodiment 1057. The stimuli-responsive HYSP of embodiment 1056, wherein the red pigment comprises one or more of red ocher (α-Fe2O3), Terra di Siena (α-Fe2O3), vermilion (HgS), lead red (Pb3O4), alizarin madder varnish, alizarin red (C14H8O4), iron oxide red (α-Fe2O3), molybdate red (Pb(Cr,S,Mo)O4), and cadmium red (Cd(S,Se)).

Embodiment 1058. The stimuli-responsive HYSP of embodiment 1053, wherein the colored pigment comprises a green pigment.

Embodiment 1059. The stimuli-responsive HYSP of embodiment 1058, wherein the green pigment comprises one or more of green earth (Fe silicates), Schweinfurt green (C4H6As6Cu4O16), chromium oxide green (Cr2O3), chromium oxide hydrate green (CrOOH), and cobalt green (Co2TiO4).

Embodiment 1060. The stimuli-responsive HYSP of embodiment 1053, wherein the colored pigment comprises a blue pigment.

Embodiment 1061. The stimuli-responsive HYSP of embodiment 1060, wherein the blue pigment comprises one or more of lazurite (lapis lazuli), Egyptian blue (CaCuSi4O10), azurite (2CuCO3·Cu(OH)2), malachite (CuCO3·Cu(OH)2), cobalt blue (CoAl2O4), Cobalt blue (CoAl2O4), ultramarine blue: (Na6Al6Si6O24(NaSn), and iron blue (K[FeIIIFeII(CN)6]·xH2O).

Embodiment 1062. The stimuli-responsive HYSP of embodiment 1053, wherein the colored pigment comprises a brown pigment.

Embodiment 1063. The stimuli-responsive HYSP of embodiment 1062, wherein the brown pigment comprises one or more of burnt umber (Fe2O3·xMnO2), brown ocher (α-Fe2O3+Mn oxides), and limonite (mixture of different Fe oxides).

Embodiment 1064. The stimuli-responsive HYSP of embodiment 1043, wherein the pigment is one or more of an oxide or oxide hydroxide pigment (TiO2, ZnO, α-Fe2O3, α-FeOOH, γ-Fe2O3, Fe3O4, Cr2O3, CrOOH, PbO, PB3O4, Mn3O4, —MnOOH, Sb2O3), a complex oxide pigment (CoAl2O4, CuCr2O4, Co2TiO4, (Ti,Ni,Sb)O2, (Ti,Cr,Sb)O2), a carbonate hydroxide pigment (2PbCO3·Pb(OH)2, 2CuCO3·Cu(OH)2, CuCO3·Cu(OH)2), a sulfide/selenide pigment (ZnS, CdS, Cd(S,Se), CdSe, γ-Ce2S3, HgS, As2S3), a chromate/molybdate pigment (PbCrO4, Pb(Cr,S)O4, Pb(Cr,S,Mo)O4, ZnCrO4, BaCrO4, SrCrO4), a vanadate pigment (BiVO4, 4BiVO4·3Bi2MoO6), a stannate pigment (Pb2SnO4, PbSn2SiO7, Co2SnO4, CoSnO3), a phosphate pigment (Co3(PO4)2), an antimonate pigment (Pb(SbO3)2), an arsenate pigment (Cu(AsO3)2), an ultramarine pigment (Na6Al6Si6O24(NaSn)), a hexacyanidoferrate/hexacyanoferrate pigment (K [FeIIIFeII(CN)6]·xH2O(x=14-16)), an oxonitride pigment (CaTaO2N, LaTaON2), an elemental-based pigment (C, Al, Cu, Cu/Zn, Au), a spinel-based pigment, and a rutile-based metal pigment.

Embodiment 1065. The stimuli-responsive HYSP of embodiment 1048, wherein the inorganic pigment is one or more of a transparent effect pigment, goniochromatic pigments, pearlescent pigment, metallic pigment, interference pigment, metallic effect pigment, fluorescent pigment, luminescent pigment, phosphorescent pigment, magnetic pigment, and anticorrosive pigment.

Embodiment 1066. The stimuli-responsive HYSP of embodiment 1065, wherein the metallic pigment comprises one or more of aluminum, bronze, and copper metallic pigment.

Embodiment 1067. The stimuli-responsive HYSP of embodiment 1065, wherein the pearlescent pigment comprises one or more of mica, titanium dioxide, and bismuth oxychloride.

Embodiment 1068. The stimuli-responsive HYSP of embodiment 1065, wherein the fluorescent pigment comprises one or more fluorescent dye and pigment comprising a fluorescent mineral.

Embodiment 1069. The stimuli-responsive HYSP of embodiment 1065, wherein the phosphorescent pigment comprises zinc sulfide and/or strontium aluminate.

Embodiment 1070. The stimuli-responsive HYSP of embodiment 1065, wherein the interference pigment comprises titanium dioxide-coated mica and/or aluminum oxide-coated mica.

Embodiment 1071. The stimuli-responsive HYSP of claim any one of the preceding embodiments, wherein the two or more colorants comprises an anisotropic particle.

Embodiment 1072. The stimuli-responsive HYSP of embodiment 1071, wherein the anisotropic particle comprises a nanoparticle of the one or more metals, optionally comprising a nanorod of one or more of gold (Au), silver (Au), and aluminum (Al).

Embodiment 1073. The stimuli-responsive HYSP of any one of the preceding embodiments, wherein the one or more colorants comprises a plasmonic material.

Embodiment 1074. The stimuli-responsive HYSP of embodiment 1073, wherein the plasmonic material comprises a pigment, particle, foil, and/or film.

Embodiment 1075. The stimuli-responsive HYSP of embodiment 1074, wherein the film comprises a polymer-film loaded with noble metal nanoparticles.

Embodiment 1076. The stimuli-responsive HYSP of embodiment 1065, wherein the goniochromatic pigment comprises aluminum coated with magnesium fluoride embedded in chromium.

Embodiment 1077. The stimuli-responsive HYSP of any one of the preceding embodiments, wherein the at least one layer of shell comprises a single, uniform thickness and/or varying thicknesses.

Embodiment 1078. The stimuli-responsive HYSP of embodiment 1077, wherein the at least one layer of shell comprises a thickness of about or at least about 1 nm, about or at least about 5 nm, about or at least about 10 nm, about or at least about 15 nm, about or at least about 20 nm, about or at least about 25 nm, about or at least about 30 nm, about or at least about 40 nm, about or at least about 50 nm, about or at least about 100 nm, about or at least about 200 nm, about or at least about 300 nm, about or at least about 400 nm, about or at least about 500 nm, about or at least about 600 nm, about or at least about 700 nm, about or at least about 800 nm, about or at least about 900 nm, about or at least about 1 μm, about or at least about 2 μm, about or at least about 3 μm, about or at least about 4 μm, about or at least about 5 μm, about or at least about 10 μm, about or at least about 15 μm, about or at least about 20 μm, about or at least about 25 μm, about or at least about 30 μm, about or at least about 35 μm, about or at least about 40 μm.

Embodiment 1079. The stimuli-responsive HYSP of any one of the preceding embodiments, wherein the at least one layer of shell comprises at least a portion that is opaque.

Embodiment 1080. The stimuli-responsive HYSP of embodiment 1079, wherein the portion that is opaque optically absorbs, deflects, blocks, and/or scatters light in the visible electromagnetic range of about 380 nm to about 800 nm.

Embodiment 1081. The stimuli-responsive HYSP of embodiment 1079 or 1080, wherein the portion that is opaque comprises a thickness of about or at least about 1 nm, about or at least about 5 nm, about or at least about 10 nm, about or at least about 25 nm, about or at least about 50 nm, about or at least about 100 nm, about or at least about 250 nm, about or at least about 500 nm, about or at least about 1 μm, about or at least about 2.5 μm, about or at least about 5 μm, or about or at least about 10 μm.

Embodiment 1082. The stimuli-responsive HYSP of any one of the preceding embodiments, wherein the at least one layer of shell comprises a material comprising one or more of glass, quartz, plastic, polyethylene terephthalate, polycarbonate, polymethyl methacrylate (acrylic), polyethylene, polyurethane, polypropylene, thermoplastic elastomers (TPE), acrylonitrile butadiene styrene (ABS), epoxies and epoxy-based photoresists, hydrogels, cyclic olefin copolymer (COC) cyclic olefin polymer (COP), poly dimethyl siloxane (PDMS), poly ether ester ketone (PEEK), polyetherimide (ULTEM), nylon, thermally responsive polymer, and combinations thereof.

Embodiment 1083. The stimuli-responsive HYSP of any one of the preceding embodiments, wherein the at least one layer of shell is composed of and/or has disposed thereon one or more of polysaccharides, lipids, amino acids, DNA, RNA, plastics, thermally responsive polymers, hydrocarbon, crude oil, or petroleum derivatives, and combinations thereof.

Embodiment 1084. The stimuli-responsive HYSP of any one of the preceding embodiments, wherein the at least one layer of shell comprises one or more indentations, grooves, and spaces located on an internal surface to affix the at least one orientable multiphasic yolk.

Embodiment 1085. The stimuli-responsive HYSP of any one of the preceding embodiments, wherein the at least one layer of shell comprises one or more materials to reduce friction between an internal surface and the at least one orientable multiphasic yolk.

Embodiment 1086. The stimuli-responsive HYSP of any one of the preceding embodiments, wherein the HYSP is disposed on a surface and/or substrate.

Embodiment 1087. The stimuli-responsive HYSP of embodiment 1086, wherein the surface and/or substrate is a polymer, paper, fabric, metal, clay board, ceramic, window, glass, plastic, computer chip, wood, construction material, and/or human or animal tissue or skin.

Embodiment 1088. The stimuli-responsive HYSP of embodiment 1086 or 1087, wherein the surface and/or substrate is planar or non-planar.

Embodiment 1089. The stimuli-responsive HYSP of any one of embodiments 1086-1088, wherein the surface and/or substrate comprises at least a portion that is convex, concave, or without a well-defined shape.

Embodiment 1090. The stimuli-responsive HYSP of any one of embodiments 1086-1089, wherein the surface and/or substrate is on an interior surface of an object, an exterior surface of an object, or both, and wherein the object is a non-HYSP object.

Embodiment 1091. The stimuli-responsive HYSP of any one of embodiments 1086-1090, wherein the surface and/or substrate comprises indentations and/or divots.

Embodiment 1092. The stimuli-responsive HYSP of embodiment 1091, wherein the indentations and/or divots are arranged in an array.

Embodiment 1093. The stimuli-responsive HYSP of embodiments 1091 or 1092, wherein the HYSP is disposed in and/or on the indentations and/or divots.

Embodiment 1094. The stimuli-responsive HYSP of any one of embodiments 1086-1093, wherein the surface and/or substrate comprises pillars, posts, and/or stops.

Embodiment 1095. The stimuli-responsive HYSP of embodiment 1094, wherein the HYSP is disposed in and/or on the pillars, posts, and/or stops.

Embodiment 1096. The stimuli-responsive HYSP of any one of embodiments 1086-1095, wherein the surface and/or substrate comprises one or more grooves.

Embodiment 1097. The stimuli-responsive HYSP of embodiment 1096, wherein the HYSP is disposed in and/or on the one or more grooves.

Embodiment 1098. The stimuli-responsive HYSP of any one of embodiments 1086-1097, wherein the surface and/or substrate changes color as a function of the presence of a magnetic field.

Embodiment 1099. The stimuli-responsive HYSP of any one of the preceding embodiments, wherein the HYSP is formulated into a fluid, suspension, ink, liquid film, and/or adhesive substrate, material, and/or surface.

Embodiment 1100. The stimuli-responsive HYSP of embodiment 1099, wherein the fluid, suspension, ink, liquid film, and/or adhesive substrate, material, and/or surface is suitable to be applied to an object.

Embodiment 1101. The stimuli-responsive HYSP of any one of embodiments 1001-1098, wherein the HYSP is formulated into a foil, film, thin plastic, and/or paper substrate, material, and/or surface.

Embodiment 1102. The stimuli-responsive HYSP of embodiment 1101, wherein the foil, film, thin plastic, and/or paper substrate, material, and/or surface is suitable to be affixed to, or embedded in, an object.

Embodiment 1103. The stimuli-responsive HYSP of any one of embodiments 1001-1098, wherein the HYSP is formulated into a fiber, thread, yarn, and/or twine substrate, material, and/or surface.

Embodiment 1104. The stimuli-responsive HYSP of embodiment 1103, wherein the fiber, thread, yarn, and/or twine substrate, material, and/or surface is suitable to be woven into an article of clothing, a cloth, and/or a tarp.

Embodiment 1105. The stimuli-responsive HYSP of any one of the preceding embodiments, wherein the HYSP is positioned between a first substrate and a second substrate.

Embodiment 1106. The stimuli-responsive HYSP of embodiment 1105, wherein at least one of the first substrate and the second substrate comprises a material that is transparent to at least a portion of the visible electromagnetic (EM) spectrum.

Embodiment 1107. The stimuli-responsive HYSP of embodiment 1106, wherein the material comprises glass, quartz, plastic, polyethylene terephthalate, polycarbonate, polymethyl methacrylate (acrylic), polyethylene, polyurethane, polypropylene, thermoplastic elastomers (TPE), acrylonitrile butadiene styrene (ABS), epoxies and epoxy-based photoresists, hydrogels, cyclic olefin copolymer (COC) cyclic olefin polymer (COP), poly dimethyl siloxane (PDMS), poly ether ester ketone (PEEK), polyetherimide (ULTEM) and/or nylon.

Embodiment 1108. The stimuli-responsive HYSP of embodiment 1106 or 1107, wherein the material comprises a thickness of about or at least about 50 nm, is about or at least about 100 nm, is about or at least about 500 nm, about or at least about 1 μm, is about or at least about 10 μm, is about or at least about 100 μm, about or at least about 1 mm, about or at least about 5 mm, or about or at least about 10 mm.

Embodiment 1109. The stimuli-responsive HYSP of any one of any one of the preceding embodiments, wherein the HYSP comprises at least a first surface with a shape that is complementary to a shape of a second surface of the HYSP.

Embodiment 1110. The stimuli-responsive HYSP of any one of the preceding embodiments, wherein the HYSP is disposed on and/or embedded in a surface and/or substrate which is treated with one or more of a lubricant, adhesive, surface treatment, coating, and/or polishing agent.

Embodiment 1111. A method of manufacturing a hollow yolk-shell particle (HYSP) of any one of embodiments 1-1110 comprising: i) preparing at least one multiphasic orientable yolk, wherein the at least one multiphasic orientable yolk comprises at least two colorants and at least one stimuli-responsive element; ii) forming a dissolution layer disposed on the at least one multiphasic orientable yolk; iii) forming at least one layer of a shell encapsulating the multiphasic orientable yolk, wherein the at least one layer of shell comprises pores; iv) repositioning the dissolution layer through the pores in the at least one layer of shell to form a cavity between the at least one multiphasic orientable yolk and the at least one layer of a shell; and v) hardening the at least one layer of a shell to form a non-porous shell, wherein the multiphasic orientable yolk is configured to move inside the shell in response to an applied force or exogenous energy.

Embodiment 1112. The method of embodiment 1111, wherein the applied force or exogenous energy is a magnetic field.

Embodiment 1113. The method of embodiment 1111 or 1112, further comprising applying a coating to the at least one multiphasic orientable yolk prior to forming the dissolution layer.

Embodiment 1114. The method of embodiment 1113, wherein the coating comprises one or more of a protective coating, a chemical functionalization, lubricant, surface treatment, and/or polishing agent.

Embodiment 1115. The method of any one of embodiments 1111-1114, further comprising forming one or more additional shells encapsulating the at least one layer of shell.

Embodiment 1116. The method of any one of embodiments 1111-1115, further comprising disposing one or more materials into the cavity formed from the removing.

Embodiment 1117. The method of any one of embodiments 1111-1116, wherein the one or more materials comprise thermally responsive polymers and/or a fluid media.

Embodiment 1118. The method of any one of embodiments 1111-1117, wherein the at least one layer of shell comprises at least a portion of the shell comprises a material that is transparent to at least a portion of the visible electromagnetic spectrum between about 380 nm to about 800 nm.

Embodiment 1119. The method of any one of embodiments 1111-1118, wherein one or more of: i) preparing at least one multiphasic orientable yolk, ii) forming a dissolution layer, and iii) forming at least one layer of a shell comprises assembling, gluing, and/or affixing two or more components; injection molding, and/or micro-injection molding; self-assembly, adsorption, coacervation, and/or mixing; polymerization, extrusion, and/or manipulation of polymers; additive manufacturing, CNC machining (Computer Numerical Control machining), urethane casting, microcontact printing, dip pen lithography, beam pen lithography, photolithography, e-beam lithography, and/or 3D printing.

Embodiment 1120. The method of any one of embodiments 1111-1119, wherein forming the at least one layer of shell comprises performing one or more of mesoporous material synthesis, soft-templating, calcination, and/or extraction.

Embodiment 1121. The method of any one of embodiments 1111-1120, wherein the at least one layer of shell comprising pores comprises a mesoporous silica and/or a porous organic framework.

Embodiment 1122. The method of any one of embodiments 1111-1121, wherein repositioning the dissolution layer comprises removing, dissolving, and/or etching the dissolution layer.

Embodiment 1123. The method of any one of embodiments 1111-1122, wherein hardening the at least one layer of a shell to form a non-porous shell comprises compacting and forming a solid mass of shell material by heat and/or pressure.

Embodiment 1124. The method of any one of embodiments 1111-1123, wherein preparing the at least one multiphasic orientable yolk comprises forming the yolk by injecting molten plastic, metal, and/or polymer-based material into a mold cavity.

Embodiment 1125. The method of any one of embodiments 1111-1124, wherein preparing the at least one multiphasic orientable yolk comprises a DNA origami technique.

Embodiment 1126. The method of embodiment 1125, wherein the DNA origami technique comprises self-assembly of at least two DNA-coated colorants and at least one DNA-coated stimuli-responsive element.

Embodiment 1127. The method of any one of embodiments 1111-1126, wherein one or more of: i) preparing at least one multiphasic orientable yolk, ii) forming a dissolution layer, and iii) forming at least one layer of a shell comprises 3D printing.

Embodiment 1128. The method of embodiment 1127, wherein 3D printing comprises performing one or more of fused deposition modeling (FDM), fused filament fabrication (FFF), stereolithography (SLA), selective laser sintering (SLS), binder jetting (BJ), direct energy deposition (DED), digital light process (DLP), liquid crystal display (LCD), polymer jetting (PolyJet), multi-jet fusion (MJF), direct metal laser sintering (DMLS), electron beam melting (EBM), laminated object manufacturing (LOM), continuous liquid interface production (CLIP), electron beam melting, and digital light processing (DLP).

Embodiment 1129. The method of any one of embodiments 1111-1128, wherein one or more of the at least one multiphasic orientable yolk, the dissolution layer, and the at least one layer of shell comprises one or more of a thermally responsive polymer, resin, metal, ceramic, glass, quartz, plastic, polyethylene terephthalate, polycarbonate, polymethyl methacrylate (acrylic), polyethylene, polyurethane, polypropylene, thermoplastic elastomers (TPE), acrylonitrile butadiene styrene (ABS), epoxies and epoxy-based photoresists, hydrogels, cyclic olefin copolymer (COC) cyclic olefin polymer (COP), poly dimethyl siloxane (PDMS), poly ether ester ketone (PEEK), polyetherimide (ULTEM), nylon, and combinations thereof.

Embodiment 1130. The method of embodiment 1129, wherein the one or more thermally responsive polymers and resins comprise one or more of poloxamers, styrene-butadiene block copolymers, polymethylmethacrylate, polybutylmethacrylate, plasticized polyvinyl chloride, plasticized nylon, plasticized polyethylene terephthalate, polyethylene, polyacrylonitrile, polychlorotrifluoroethylene, poly-4,4′-isopropylidenediphenylene carbonate, polyethylene vinyl ester, polyvinyl chloride-diethyl fumarate, and combinations thereof.

Embodiment 1131. The method of any one of embodiment 1111-1130, wherein preparing the at least one multiphasic orientable yolk comprises forming Janus particles.

Embodiment 1132. The method of embodiment 1131, wherein the Janus particles comprise one or more of poly(tert-butyl acrylate)-poly(3-(triethoxysilyl)propyl methacrylate) (PtBA-PTPM), polystyrene latex polymer, carboxylated latex polymer, aminated latex polymer, colored polystyrene polymer (dye-infused and/or pigment-infused), colored polystyrene-based carboxylated latex polymer (dye-infused and/or pigment-infused), fluorescent polystyrene-based polymers, fluorescent polystyrene-based carboxylated latex polymers, fluorescent aminated polystyrene-based polymer, surfactant-free polystyrene, carboxylated surfactant-free polymer, polymethyl methacrylate (PMMA) latex polymer, divinylbenzene (DVB)-crosslinked polystyrene latex polymer, and combinations thereof.

Embodiment 1133. The method of any one of embodiments 1111-1132, wherein preparing the at least one multiphasic orientable yolk comprises joining together at least two colorants and a stimuli-responsive element composed of a material that responds to a magnetic field.

Embodiment 1134. The method of any one of embodiments 1111-1133, wherein forming at least one layer of a shell comprises forming the at least one layer of shell using one or more materials that is transparent to at least a portion of the visible electromagnetic (EM) spectrum.

Embodiment 1135. The method of embodiment 1134, wherein the one or more materials comprises glass, quartz, plastic, polyethylene terephthalate, polycarbonate, polymethyl methacrylate (acrylic), polyethylene, polyurethane, polypropylene, thermoplastic elastomers (TPE), acrylonitrile butadiene styrene (ABS), epoxies and epoxy-based photoresists, hydrogels, cyclic olefin copolymer (COC) cyclic olefin polymer (COP), poly dimethyl siloxane (PDMS), poly ether ester ketone (PEEK), polyetherimide (ULTEM), and/or nylon.

Embodiment 1136. The method of any one of embodiments 1111-1135, further comprising formulating the HYSP into a fluid, suspension, ink, liquid film, and/or adhesive substrate and/or material.

Embodiment 1137. The method of embodiment 1136, wherein the fluid, suspension, ink, liquid film, and/or adhesive substrate and/or material is suitable to be applied to a surface of an object.

Embodiment 1138. The method of any one of embodiments 1111-1135, further comprising formulating the HYSP into a foil, film, thin plastic, and/or paper substrate and/or material.

Embodiment 1139. The method of embodiment 1138, wherein the foil, film, thin plastic, and/or paper substrate and/or material is suitable to be affixed to, or embedded in, an object.

Embodiment 1140. The method of any one of embodiments 1111-1135, further comprising formulating the HYSP into a fiber, thread, yarn, and/or twine substrate and/or material.

Embodiment 1141. The method of embodiment 1140, wherein the fiber, thread, yarn, and/or twine substrate, material, and/or surface is suitable to be woven into an article of clothing, a cloth, and/or a tarp.

Embodiment 1142. A method of using a hollow yolk-shell particle (HYSP) of any one of embodiments 1001-1100 comprising: a) providing the HYSP of any one of claims 1001-1110; b) formulating the HYSP into a fluid, suspension, ink, liquid film, and/or adhesive substrate and/or material; and c) applying the fluid, suspension, ink, liquid film, and/or adhesive substrate and/or material to an object and/or surface.

Embodiment 1143. The method of embodiment 1142, wherein applying further comprises spraying, gluing, embedding, writing, printing, and/or blotting.

Embodiment 1144. The method of embodiment 1142 or 1143, wherein the object is polymer, paper, fabric, metal, clay board, ceramic, window, glass, plastic, computer chip, wood, construction material, and/or human or animal tissue.

Embodiment 1145. The method of any one of claims 1142-1144, wherein the object and/or surface exhibits optical property changing properties as a function of the application of a magnetic field.

Embodiment 1146. A method of using a hollow yolk-shell particle (HYSP) of any one of embodiments 1001-1110 comprising: a) providing the HYSP of any one of embodiments 1001-1110; and b) formulating the HYSP into a foil, film, thin plastic, and/or paper substrate and/or material; and c) applying the foil, film, thin plastic, and/or paper substrate and/or material to an object and/or surface.

Embodiment 1147. The method of embodiment 1146, wherein applying further comprises spraying, gluing, embedding, writing, printing, and/or blotting.

Embodiment 1148. The method of embodiments 1146 or 1147, wherein the object is polymer, paper, fabric, metal, clay board, ceramic, window, glass, plastic, computer chip, wood, construction material, and/or human or animal tissue.

Embodiment 1149. The method of any one of embodiments 1146-1148, wherein the object and/or surface exhibits optical property changing properties as a function of the application of a magnetic field.

Embodiment 1150. A method of using a hollow yolk-shell particle (HYSP) of any one of claims 1001-1110 comprising: a) providing the HYSP of any one of claims 1001-1110; and b) formulating the HYSP into a fiber, thread, yarn, and/or twine substrate and/or material; and c) applying the fiber, thread, yarn, and/or twine substrate and/or material to an object and/or surface.

Embodiment 1151. The method of embodiment 1150, wherein applying further comprises weaving and/or embedding.

Embodiment 1152. The method of embodiment 1150 or 1151, wherein the object is polymer, paper, fabric, metal, clay board, ceramic, window, glass, plastic, computer chip, wood, construction material, and/or human or animal tissue.

Embodiment 1153. The method of any one of embodiments 1150-1152, wherein the object and/or surface exhibits optical property changing properties as a function of the application of a magnetic field.

Embodiment 1154. A method of authenticating a material comprising a) providing a formulation of an HYSP of any one of claims 1-14, wherein the formulation comprises: i) a fluid, suspension, ink, liquid film, and/or adhesive substrate and/or material; ii) a foil, film, thin plastic, and/or paper substrate and/or material; or iii) a fiber, thread, yarn, and/or twine substrate and/or material; and c) tagging an object and/or surface with the formulation; and d) reading the tagging.

Embodiment 1155. The method of embodiment 1154, wherein the tagging is configured to be read by a sensor and/or optical imaging device.

Embodiment 1156. The method of embodiment 1154 or 1155, wherein the reading comprises applying a magnetic field to determine an optical property change in the object and/or surface due to the presence of the HYSP.

Without further elaboration, it is believed that one skilled in the art can, based on the above description, utilize the present disclosure to its fullest extent. The following specific embodiments are, therefore, to be construed as merely illustrative, and not limiting of the remainder of the disclosure in any way whatsoever.

### EXAMPLES

### Example 1: Synthesis of Encapsulated Magnetochromic Particles

This Example describes, inter alia, illustrative core-shell HYSP syntheses.

Origami DNA Construction: A 450-nm diameter single-layer flat sheet of DNA origami with addressable nodes to bind cargo can be made as described in Wintersinger et al., (Wintersinger, C. M., et al., “Multi-micron crisscross structures grown from DNA-origami slats,” Nat. Nanotechnol. Vol. 18, 2023: pp. 281-289, doi: 0.1038/s41565-022-01283-1) using a 450-nm length 6-helix bundle as described in Mathieu et al. (Mathieu, et al., “Six-Helix Bundles Designed from DNA,” Nano Letters, Vol. 5, No. 4, 2005: pp. 661-665, doi: 10.1021/nl050084f).

Functionalization and attachment of colloidal gold nanoparticles (AuNPs): AuNPs of diameters of approximately 5 nm, 10 nm, and 15 nm (BBI International) can be treated by a citrate reduction method, as described in Dai, et al., “DNA Origami-Directed, Discrete Three-Dimensional Plasmonic Tetrahedron Nanoarchitectures with Tailored Optical Chirality,” ACS Applied Materials & Interfaces, Vol. 6, No. 8, 2014: pp. 5388-5392, doi: 10.1021/am501599f. Treated AuNPs can be functionalized with thiolated DNA 5′-thiolated DNA-oligonucleotides and/or 3′-thiolated DNA oligonucleotides. Thiolated DNA oligonucleotides can be added in a 200-fold molar excess to the AuNP solution, and the salt concentration can be increased stepwise to 600 mM NaCl. The AuNPs can then be purified from the excess DNA oligonucleotides via centrifugation filtration (AMICON, 100,000 MW cut-off spin filters). Thiolated DNA strands can be synthesized to be complementary to the DNA strands used in the previous origami DNA construction.

Preparation of DNA-decorated AuNPs: To the AuNPs solution, additional thiolated DNA can be added with molar ratio about 300:1 to form a AuNP-thiolated DNA mixture. The mixtures can be placed on an orbital shaker overnight (approximately 12 hours) at room temperature (approximately 20° C.). The mixtures can be added with phosphate buffer (PB) (0.1 M, pH 7.4) to obtain a final phosphate concentration of 10 mM (pH 7.4). After a 30-minute incubation period, 2 M NaCl can be added (within a time interval about 30 min) to achieve a final concentration of 100 mM NaCl in the mixture. The resulting solution can be placed on an orbital shaker overnight (approximately 12 hours) at room temperature (approximately 20° C.). The mixtures can then be centrifuged at 12,000 rpm, 4° C., 20 min for 15 nm AuNPs, 14,000 rpm, 4° C., 30 min for 5 nm and 10 nm AuNPs. After that, the supernatant can be removed with the precipitate re-dispersed in 10 mM of PB solution (pH 7.4). This process can be repeated, e.g., three times, and can be re-dispersed in a solution (0.1 M NaCl, 10 mM PB, pH 7.4) with the final phosphate concentration of 10 nM.

Hybridization of DNA-decorated AuNP and origami DNA: Purified DNA-coated AuNPs can be added to the DNA origami structure in a 5-fold excess of AuNPs to binding sites on the origami and the MgCl₂ concentration can be adjusted to 11 mM. The mixture can be incubated overnight for hybridization of the DNA-coated AuNPs to the complementary, hybridizable single-stranded DNA-oligonucleotide nodes on the origami structure. The origami DNA structure can then be hybridized to the thiolated DNA-coated AuNPs, to form DNA origami AuNPs.

The DNA origami AuNPs can then be characterized using a variety of techniques such as transmission electron microscopy (TEM), atomic force microscopy (AFM), and spectroscopy. The data from these experiments can provide details on sample homogeneity, particle size and symmetry, and/or degree of DNA hybridization.

Quantum Dot (QD) Oligo Particles: Quantum dot single-strand oligonucleotide reagents can be made as described in Shen, J., et al., “Valence-Engineering of Quantum Dots Using Programmable DNA Scaffolds,” Angewandte Chemie International Edition, Vol. 56, No. 50:2017: pp. 16077-16081. doi: 10.1002/anie.201710309. Reagents that can be used include organic QDs with emission at 520 nm and 560 nm (Ocean Nanotech, Inc.), chloroform (99.8% purity), 3-Mercaptopropionic acid (MAP) (99%), tetrabutylammonium bromide (TBAB, 98.0%), trioctylphosphine oxide (TOPO, 90%), 2,5,8,11,14,17,20-heptaoxadocosane-22-thiol (mPEG), molecular weight (MW) 356.5 g/mol, 95% purity) and 3-(azidotetra(ethyleneoxy)) propionic acid succinimidyl ester, HPLC-purified oligonucleotides, and ultrapure water (>18.0 MΩ·cm resistivity).

QDs can be transferred from an organic phase to aqueous phase and can be used to perform a ligand exchange to replace a portion of mercaptopropionic acid (MPA) with 2,5,8,11,14,17,20-heptaoxadocosane-22-thiol (mPEG). The prepared MPA/mPEG co-decorated QDs can be subsequently incubated with DNA for functionalization where QDs (20 μL in 500 μL chloroform) and trioctylphosphine oxide (TOPO) (40 μL, 1 g/10 mL) can be added. The mixture can be kept under an inert atmosphere for 30 min. Then MPA (500 μl, 11 mM in aqueous NaOH (0.2 M) can be added. The mixture can be briefly mixed by vortexing and then incubated for 30 s, with the aqueous layer being recovered. This procedure can be repeated 3 to 5 times with each aqueous layer collected and concentrated. MPA-protected QDs can be washed three times with ultrapure water. The QDs can be diluted into 2 mL of ultrapure water and incubated with mPEG (20 μL) for 4 days at room temperature (approximately 20° C.). The reacted QDs can be concentrated and washed three times using a centrifugal (30 kDa cutoff) device. Finally, the buffer can be exchanged by a NAP desalting column (GE Healthcare) into ultrapure water for further use. QD concentration can be determined by absorbance at 350 nm (extinction coefficients of QDs that emit at 520 nm, 560 nm are 1,590,000 M-1 cm-1 and 3,500,000 M-1 cm-1 respectively).

Preparation of Monovalent Quantum Dots (QDs): 100 μL of a QD solution (100 nM in 1×PBS buffer) can be added to monovalent DNA (molar ratio between QDs and DNA was 1:1.2). After a 2-hr. incubation period, the mixture can be analyzed by gel electrophoresis.

Yolk-Shell Construction: Materials: Tetraethyl orthosilicate (TEOS, 95%), titanium tetraisopropoxide (TTIP, 95%), acetonitrile (99.5%), ammonia aqueous solution (25 wt %), methylamine aqueous solution (40 wt %), ethanol (99.5%), styrene (St, 99%), p-styrenesulfonic acid sodium salt (NaSS, 80%), potassium persulfate (KPS, 95.0%), 3-Methacryloxypropyltrimethoxysilane (MPTMS, 95.0%). The inhibitor for St monomer can be removed by using an inhibitor removal column, polyvinylpyrrolidone (PVP, MW=360,000 g/mol), Poly(allylamine hydrochloride) (PAH, MW=15,000 g/mol), and the silane coupling agent 3-aminopropyltrimethoxysilane (APTES, 95%).

Hollow Silica Shell Synthesis Procedure: an illustrative yolk-shell construction with a silica shell is illustrated in FIG. 8. Submicrometer-sized silica cores, e.g., as illustrated in FIG. 8, step A, can be prepared with silica cores surface modified with MPTMS (2 mM) for a silica core concentration of 0.15 vol % (in deionized water) at 35° C. A suspension of the surface-modified cores, styrene (St, 50 mM) and an aqueous solution of NaSS can be added (e.g., step A→B of FIG. 8). After stirring for 30 min at 65° C., an aqueous solution of potassium persulfate (KPS) can be added to the suspension as an initiator. Formation of a PSt shell was conducted at [KPS]=2 mM, [NaSS]=0.25 mM, and a silica concentration of 0.15 vol %. To increase the thickness of the PSt shell, another round of polymerization of styrene (St) can be performed at a concentration of 100 mM or 200 mM with the KPS initiator (at 2 mM total concentration). The second formation of PSt shell can be performed at a core/shell particle concentration of 0.05 vol %. In the second step, (e.g., as shown in FIG. 8, step B→C), the doubly PSt-coated silica particles can be coated with silica. A suspension of the PSt-coated particles can be added to a solution containing PAH and NaCl. The concentrations of the doubly PSt-coated particles, PAH, and NaCl were 0.15 vol %, 0.71 kg/m3, and 36 mol/m3 in the mixture, respectively. After two centrifugation steps to remove non-adsorbed PAH and NaCl, the particles can be redispersed into 40 mL of an ethanolic solution containing 0.20 g of polyvinylpyrrolidone (PVP). Two more centrifugation steps can be conducted to remove excess PVP, and particles were redispersed into 9.59 mL of ethanol. Next, 10.6 mL of ammonia solution can be added, along with the silica precursors TEOS (1 mL) and APTES (37 μL). The resultant mixed silica precursors can be used to form a low-density silica shell suitable for the slight etching of silica, for example as seen in FIG. 8, step B→C. PSt particles coated with silica can be dried at 50° C., followed by heat treatment for 4 hr. in air in an oven at 500° C. (FIG. 8, step C→D). Particles obtained by the heat treatment can be immersed in 30 ml of ammonia solution (15-20 mM, approximately pH 11) to slightly etch the silica component of the particles (FIG. 8, step D→E). This step can detach the cores from the shells, resulting in hollow silica shells, for example like those described in Watanabe, et al., “Polyethylenimine-assisted synthesis of hollow silica spheres without shape deformation,” Mater. Chem. Phys. Vol. 262, No. 124267, 2021.

Yolk/Shell Particles Incorporating a Titania Core: The yolk/shell particles can also be prepared with a similar method as the above for incorporating the silica core, using titania cores (titanium oxide cores). Submicrometer-sized titanium oxide cores can be prepared and can be surface-modified with MPTMS at 35° C. After a 1-hour reaction under stirring, styrene monomer (St, 50 mM) and an aqueous solution of NaSS can be added to the suspension and the mixture can be stirred for 1 hr. An aqueous solution of KPS can be added as an initiator to the suspension at 65° C. The polymerization can be performed at [MPTMS]=2 mM, [KPS]=2 mM, [NaSS]=0.25 mM, and a titanium oxide concentration of 0.065 vol %.

Synthesis of Iron Oxide Core and Silica Shell Particles: Materials: Fe₃O₄ nanoparticles (NPs) protected by oleylamine (OMA) and oleic acid (OA), hydrogen tetrachloroaurate (HAuCl₄·H₂O, 99.99%), sodium borohydride (NaBH₄, 98%), cetyltrimethylammonium bromide (CTAB, 99%), silver nitrate (AgNO₃), ascorbic acid (AA, 99.7%), tetraethyl orthosilicate (TEOS, 98%), 3-aminopropyltrimethoxysilane (APTMS, 95%), Rhodamine B isothiocyanate (RITC), polyethyleneimine (PEI, branched, Mw 25000), and doxorubicin hydrochloride (DOX), N-hydroxysuccinimide (NHS), lactobionic acid (LA), 1-Ethyl-3-(3-dimethylaminopropyl) carbodiimide HCl (EDC). Glassware was cleaned with aqua regia (volume ratio HCl/HNO₃=3:1) and thoroughly rinsed with ultrapure water (18.0 MΩ·cm resistivity) prior to the experiments.

Fe₃O₄·SiO₂ core-shell NPs: RITC can be incorporated in the silica coating on the Fe₃O₄ NPs surface by first making a RITC/APTMS/ethanol solution. RITC (10 mg) can be covalently linked to APTMS (44 mL) in ethanol (0.75 mL) under dark conditions for 2 days. The prepared RITC-APTMS stock solution can be kept at 48° C. Fe₃O₄ NPs (400 mL of 10 mg/mL) in chloroform can be poured into a CTAB solution (8 mL of 0.2 M) and the solution can be mixed by vigorous stirring for 30 min. The resulting solution can then be heated up to 60° C. for approximately 30 min to evaporate the chloroform, and the resulting turbid brown solution can be turned to a transparent black Fe₃O₄/CTAB solution. The CTAB-stabilized Fe₃O₄ NPs can be diluted in 20 ml of ultrapure water and then can be mixed with 5 mL of the RITC/APTMS solution. The pH of the mixture can be adjusted to pH 8 with 0.1 M NaOH. Fe₃O₄·SiO₂ core-shell NPs with different shell thicknesses (18 nm and 35 nm, respectively), can be synthesized using 20% TEOS in ethanol (250 mL or 400 mL, respectively) injected at 30 min intervals with the reaction mixture gently stirred for 24 hr. Fe₃O₄·SiO₂ core-shell NPs can be obtained from the reaction mixed and can be centrifuged and rinsed with ethanol repeatedly to remove the excess precursors and CTAB molecules and then can be dispersed in ethanol (8 mL).

This process can result in metal-based cores with silica-based shells, for example like those described in Zhang, L., et al., “General Route to Multifunctional Uniform Yolk/Mesoporous Silica Shell Nanocapsules: A Platform for Simultaneous Cancer-Targeted Imaging and Magnetically Guided Drug Delivery,” Chemistry—A European Journal, Vol. 18, No. 39, 2012: pp. 12512-12521. doi: 10.1002/chem.201200030.

Synthesis of PEI coated SiO₂ NPs: The synthesis can be carried out following the Stçber method, using an alcohol/water mixture to control the hydrolysis and the condensation of tetraethyl orthosilicate (TEOS), where the hydrolysis and condensation reaction of TEOS can be catalyzed by ammonia. For preparing SiO₂ NPs, TEOS (2.3 mL) can be added to the mixture solution of ethanol (60 mL), ammonium hydroxide solution (3.0 mL), and water (1.0 mL). A sol-gel reaction can be performed for 6 hr. at 50° C. for synthesizing SiO₂ NPs. The resulting SiO₂ NPs can be collected and dispersed in ethanol. Next, the SiO₂ NPs (0.5 mg) can be mixed with polyethylenimine (PEI) (1 mL, 10 mg/mL) and can be incubated for 1 hr. with the resultant PEI-coated SiO₂ NPs being collected by centrifugation. PEI-coated SiO₂ NPs can be dispersed in water and etched at 50° C. for 90 min with the resultant particles evaluated by TEM and/or spectroscopy to assess particle homogeneity, size, symmetry, coating, etc.

### Example 2: DNA-Functionalized Magnetic Particles

DNA-functionalized iron oxide nanoparticles can be prepared, for example as described in Meyer et al., “Programmable Assembly of Iron Oxide Nanoparticles Using DNA Origami”, Nano Lett. Vol. 20, 2020: pp. 2799-2805, and as illustrated, e.g., in FIG. 9.

10 ml of azide-coated magnetic particles, approximately 500 nm in diameter at 10 mg/ml can be incubated with single-stranded DNA oligonucleotides modified at one terminus with dibenzyl cyclooctyne (DBCO) groups. The magnetic particles can be mixed with DBCO-modified DNA at a 1 DNA/nm² surface area ratio and left to incubate overnight at room temperature. The salinity of the reaction mixture can be increased step-wise by titrating 5 M NaCl to increase the total concentration by 100 mM every 1 hour, to reach a final concentration of 700 mM, where the mixture can be left at room temperature overnight (approximately 20° C. for 12 hr.) for DNA functionalization. The DNA-modified magnetic particles can then be purified from excess DNA using 3 rounds of ultracentrifugation (18,200×g, 1 hr.) and resuspension in 1×TE (tris-EDTA) buffer.

### Example 3: Synthesis of DNA Origami Assemblies with AuNPs and AgNPs as Colorants

DNA-functionalized, Silica-Coated Silver Nanoparticles (AgNPs): Oligo-functionalized, silica-coated 50-nm diameter Ag nanoparticles can be prepared, for example as described by Liu et al., “Gram Scale Synthesis and Biofunctionalization of Silica-coated Silver Nanoparticles for Fast Colorimetric DNA Detection”, Anal. Chem. Vol. 77, 2005: pp. 2595-2600, DOI: 10.1021/ac0482864, the entirety of which is hereby incorporated by reference.

Materials. AgNO₃ (99.995%), sodium citrate dihydrate (99+%), tetraethyl orthosilicate (TEOS, 99%), 11-triethoxysilylundecanaldehyde (>99%), 5-(and-6)-((N-(5-aminopentyl)amino) carbonyl)tetramethylrhodamine (A-1318), sodium cyanoborohydride (95%), dithiothreitol (99.9%), and 30 wt % ammonia.

Synthesis of Ag—SiO₂ NPs: AgNPs can be prepared by dropwise addition of 10 ml of 38.8 mM sodium citrate aqueous solution within 2 min into 490 mL of boiling aqueous solution containing 90 mg of AgNO₃ under vigorous stirring. After being boiled for 1 hr., the heat source can be removed, and the silver colloid reaction mixture can be cooled to room temperature (approx. 20° C.). The silver colloid can be centrifuged at 500 rpm for 1 hr. to remove larger NPs, and the remaining silver NPs can be suspended in solution and can have an average size of approx. 50 nm. The silver colloids can be equally transferred into 10 500-ml conical glass flasks, each containing 200 ml of ethanol and having their pH adjusted to approximately pH 10 through the addition of 6.25 mL of ˜30 wt % ammonia. Subsequently, 15 ml of 10 mM TEOS ethanol solution can be added into each 500-mL flask within 8 hr. at a time interval of 30 min under vigorous shaking, and the resulting solution can be allowed to react for 24 hr. at a constant temperature of 30° C. Ag—SiO₂ NPs can be collected by centrifugation at 3500 rpm for 30 min and can be washed with ethanol, e.g., 3 times. The ˜100-mg samples of purified Ag—SiO₂ NPs with a silica thickness of ˜40 nm can be redispersed into 500 ml of deionized water for further characterization and functionalization. Similarly, ˜1000-mg samples of Ag—SiO₂ NPs can be produced via silica coating 10 batches of silver colloids prepared using the synthetic procedure as described above.

Aldehyde-Functionalized Ag—SiO₂ NP: a 100-mL Ag—SiO₂ solution containing ˜6.6×10¹² particles can be mixed with 10 ml of 10 mM acetate buffer (pH 4.7) and 200 ml of ethanol followed by dropwise addition of 10 mL of 11-triethoxysilylundecanaldehyde for aldehyde functionalization. After being shaken at room temperature (approximately 20° C.) for 2 hr., the reaction mixture can be heated to 50° C. for 1 hr. and then cooled to room temperature (approximately 20° C.), after which the mixture can be washed thoroughly with 20 mL of ethanol four times followed by dispersing the mixture into 4 mL of deionized water (containing ˜6.6×10¹² aldehyde-functionalized Ag—SiO₂ NPs) for further bioconjugation.

Oligonucleotide-Modified Ag—SiO₂ NPs: a 2-mL aliquot of an aqueous solution containing ˜3.3×10¹² aldehyde-modified Ag—SiO₂ NPs can be mixed with 1 mL of an aqueous solution containing 300 nmol of 3′ or 5′ amine-modified single-stranded DNA, 7 mL of 50 mM borate buffer (pH 9.2), and 2 mL of 5 mM sodium cyanoborohydride. The reaction mixture can be incubated by shaking for 2 hr. at room temperature (approximately 20° C.). The supernatant can be removed by centrifugation at 4000 rpm for 10 min. The precipitate can be washed three times with pH 7 PBS buffer (0.3 M NaCl, 10 mM phosphate), resulting in oligo-modified Ag—SiO₂ NPs which can be dispersed into 2 mL of PBS buffer for further use.

DNA-Functionalized Gold Nanoparticles (AuNPs): Synthesis of AuNPs can be performed, for example as described in: Ma X, et al., “DNA-functionalized gold nanoparticles: Modification, characterization, and biomedical applications,” Front Chem. Vol. 10, No. 1095488, (2022) doi: 10.3389/fchem.2022.1095488. PMID: 36583149; PMCID: PMC9792995; Liu, et al., “Methods for DNA-functionalized gold nanoparticles, a key reagent of bioanalytical chemistry,” Analytical Methods, Vol. 9, No. 18, 2017: pp. 2633-43; Pal, et al., “DNA-Functionalized Gold Nanorods for Perioperative Optical Imaging and Photothermal Therapy of Triple-Negative Breast Cancer,” ACS Applied Nano Materials, Vol. 5, No. 7, 2022:9159-69, DOI: 10.1021/acsanm.2c01502; Liu, et al., Interface-Driven Hybrid Materials Based on DNA-Functionalized Gold Nanoparticles,” Matter, Vol. 1, 2019: pp. 825-57; Moros M, et al., “DNA-Coated Gold Nanoparticles for the Detection of mRNA in Live Hydra Vulgaris Animals,” ACS Appl Mater Interfaces, Vol. 11, No. 15, 2019: pp. 13905-13911. doi: 10.1021/acsami.8b17846. Epub 2018 Dec. 11. PMID: 30525369; and Dai, et al., “DNA Origami-Directed, Discrete Three-Dimensional Plasmonic Tetrahedron Nanoarchitectures with Tailored Optical Chirality,” ACS Applied Materials & Interfaces, Vol. 6, No. 8, 2014: pp. 5388-5392, doi: 10.1021/am501599f, the entire contents of which are herby incorporated in their entirety.

AuNPs of 13.9 nm±1.4 nm can be suspended in a solution of tetrachloroaurate (1 mM, 100 mL) and can be heated to boiling while stirring (700 rpm). Sodium citrate (2% wt, 5 mL) can be added to the AuNP solution to initiate a color change while stirring (700 rpm) for 15 min. The reaction can be cooled to room temperature (approx. 20° C.) and a solution of bis sulfonatophenylphosphine (BSPP, 42 mg in 2 mL ultrapure water) can be added, left to stir overnight to ensure successful ligand replacement. The resulting BSPP-coated spherical AuNPs can be filtered through a 0.45 μm filter to remove larger aggregates. The solution can be further purified by two rounds of centrifugation (10,000 rpm, 20 min). Purification can be assisted via the gradual addition of a concentrated NaCl solution until a color change from red to blue was observed, indicating particle precipitation. The resultant synthesized AuNPs can be dispersed in 3 mL of ultrapure water and stored at 4° C.

Construction of DNA origami-coated Gold and Silver NPs: DNA origami functionalization of AuNPs can be performed, for example as described in: Knappe, et al., “Functionalizing DNA origami to investigate and interact with biological systems”, Nature Reviews Materials, Volume 8, February 2023, 123-138, on world wide web at: doi.org/10.1038/s41578-022-00517-x; Yang et al., “Programmable site-specific functionalization of DNA origami with polynucleotide brushes,” Angew. Chem. Int. Ed. 10.1002/anie.202107829, on world wide web at: doi.org/10.1002/anie.202107829; Shaw et al., “Purification of Functionalized DNA Origami Nanostructures”, ACS Nano, Vol. 9, No. 5, 2015: pp. 4968-4975, on world wide web at: doi.org/10.1021/nn507035g; and Zhan, et al, “Recent Advances in DNA Origami-Engineered Nanomaterials and Applications, Chemical Reviews 2023 123 (7), 3976-4050, DOI: 10.1021/-acs.chemrev.3c00028, the entire contents of which are hereby incorporated in their entirety.

Referring to FIGS. 10 and 11, a solution containing a 10-fold stoichiometric excess of both DNA-coated AgNPs and DNA-coated AuNPs can be mixed with the DNA origami-magnetic particle construct (e.g., as synthesized in Example 2), and can be incubated overnight at room temperature. Unbound AuNPs and AgNPs can be removed by magnetic separation of the magnetic beads, decanting, redispersion in phosphate buffer with gentle mixing, and repeating the process until the decanted solution is optically clear, as observed by eye.

### Example 4: Synthesis of DNA Origami Assemblies with Quantum Dosts (QDs) and Titania (Titanium Dioxide) Nanoparticles as Colorants

Quantum Dot (QD)-Oligo Complexes: QD-oligo complexes can be synthesized, for example as described in: Deng, et al., “Robust DNA-Functionalized Core/Shell Quantum Dots with Fluorescent Emission Spanning from UV-vis to Near-IR and Compatible with DNA-Directed Self-Assembly,” Journal of the American Chemical Society, Vol. 134, No, 42, 2012: pp. 17424-17427, DOI: 10.1021/ja3081023; Banerjee, et al., “Quantum dots-DNA bioconjugates: synthesis to applications,” Interface Focus, Vol. 6, No. 20160064, 2016, on world wide web at: dx.doi.org/10.1098/rsfs.2016.0064; Chen, et al., “Nanoscale 3D spatial addressing and valence control of quantum dots using wireframe DNA origami,” Nat Comm. Vol. 13, No. 4935, 2022; and Shen, J., et al., “Valence-Engineering of Quantum Dots Using Programmable DNA Scaffolds,” Angewandte Chemie International Edition, Vol. 56, No. 50:2017: pp. 16077-16081. doi: 10.1002/anie.201710309, the entire contents of which are hereby incorporated in their entirety.

Materials: cadmium nitrate tetrahydrate (Cd(NO₃)₂: 4H2O, 99.8%), zinc nitrate tetrahydrate (Zn(NO₃)₂: 4H2O, 99.8%), zinc oxide (ZnO, 99.9%, powder <5 micron), cadmium oxide (CdO, 99.99+%, powder), tellurium (Te, powder, 200 mesh, ≥99%, powder), selenium (Se, powder, <100 mesh, 99.99%), Sulfur (S, 99.998% powder), paraffin liquid (CnH₂n+2, n=16-22), oleic acid (OLA, CH₃(CH₂)₇CH═CH(CH₂)₇COOH, 90%), 2-ethylhexanoic acid (EHA, CH₃(CH₂)₃CH(C₂H₅)COOH, 99+%), Thiourea (NH₂CSNH₂, ≥99.0%), Sodium borohydride (NaBH₄, powder, ≥99%), 3-Mercaptopropionic acid (HSCH₂CH₂CO₂H, ≥99%), isopropyl alcohol (IPA, 99%), hexane (≥95%), methanol (≥99.5%), Rhodamine 6G (QY=95% in ethanol), and Rhodamine 101 (λ em=589 nm, QY=100% in ethanol+0.01 HCl).

### Buffers:

1×PBS: 150 mM NaCl, 0.1 mM EDTA, 20 mM sodium phosphate, pH 4.0, 7.0, 10.0;
1×TAE/Mg2+: 40 mM Tris acetate, 2 mM EDTA, and 12.5 mM magnesium acetate, pH 8.0;
1×TBE/Mg2+: 50 mM Tris, 100 mM Borate, 10 mM EDTA, PH 8.2.

Synthesis of 1.6 nm CdTe core quantum dots (QDs): CdTe core QDs with 1.6 nm diameter can be synthesized, for example as described in Deng, et al., “Aqueous Synthesis of Zinc Blende CdTe/CdS Magic-Core/Thick-Shell Tetrahedral-Shaped Nanocrystals with Emission Tunable to Near-Infrared,” Journal of the American Chemical Society, Vol. 132, 2010: pp. 5592-5593, the entire contents of which are hereby incorporated by reference. A NaHTe solution (Te at 1.0 mol/L, 10 μL) can be injected through a syringe into a N₂-saturated Cd(NO₃)₂ solution (Cd, 0.005 mol/L, 50 mL) at room temperature (approximately 20° C.) in the presence of 3-mercaptopropionic acid (MPA, 37 μL) as a stabilizing agent. The pH can be adjusted to approx. pH 12.2 by adding 1 M NaOH. The molar ratio of Cd2+/MPA/NaHTe in the mixture can be fixed at 1:1.7:0.04. The solution can be subsequently incubated at 4° C. and CdTe clusters with photoluminescence emission peak at 480 nm formed overnight. The diameter of the resulting CdTe QDs can be approx. 1.6 nm. These QDs can be purified by adding isopropyl alcohol (IPA) (in a 1:1 in volume ratio), followed by centrifugation at 15,000 rpm for 15 minutes and the QDs subsequently re-dispersed in deionized water. In some cases, the crude, unpurified CdTe QD solutions (no centrifugation and resuspension) can also be used directly as the stock solution for the next shell growth step. Both the pure and unpurified QDs can be used as the cores for synthesizing the oligonucleotide-conjugated CdTe/CdS core/shell QDs.

Oligonucleotide functionalized CdTe/CdS core/shell QDs: The above precipitated 1.6 nm CdTe QDs (from 100 μL stock solution) can be re-suspended in 100 μL of ultrapure water. The concentration of the core CdTe QDs and amount of additional shell precursor to obtain specific shell thicknesses can be calculated, for example as described in Yu, et al., “Experimental determination of the extinction coefficient of CdTe, CdSe, and CdS nanocrystals,” Chem. Mater. Vol. 15, 2003: pp. 2854-2860, the entirety of which is hereby incorporated by reference. To synthesize CdTe/4 CdS core/shell QDs with 1.6 nm CdTe core diameter (0.25 nM in 100 μL DI water), 4.5 μL Cd2+ stock solution (25 mM), and 9.0 μL MPA stock solution (25 mM) can be combined with the core, vortexed and gently sonicated in a 1.5 mL plastic tube. Next, 50 μL of a complementary oligo stock solution (100 nM) can be added and gently vortexed. The molar ratio of QD: oligonucleotide was approximately 1:200. The pH can be adjusted to approx. pH 12.2 by adding 1 M NaOH. The reaction mixture can be incubated in a heating block at 90° C. for 40 minutes, and then cooled by submerging the tube in a room temperature (approx. 20° C.) water bath. The reacted solution can be filtered in a 0.5 mL centrifugal filter (MWCO 30 KDa), where 250 μL of deionized water can be added to the filter, and the sample can be subjected to centrifugation at 7000 rpm for 3 minutes. After the initial washing, several more rounds of adding 350 μL of deionized (DI) water and centrifugation can be repeated, e.g., four times. This ultrafiltration process can remove any free DNA and unreacted precursor from the QDs. Buffer exchange can also be performed using the centrifugation filtration method, where 350 μL of buffer, rather than DI water can be added. The final sample can be highly fluorescent and stable in the buffer or in DI water.

Quantum Dot (QD) Synthesis #2: Reagents that can be used include organic QDs with emission at 520 nm and 560 nm (Ocean Nanotech, Inc.), as well as PEG-coated QDs, chloroform (99.8% purity), 3-Mercaptopropionic acid (99%), tetrabutylammonium bromide (TBAB, 98.0%), Trioctylphosphine oxide (TOPO, 90%), 2,5,8,11,14,17,20-heptaoxadocosane-22-thiol (mPEG thiol, molecular weight (MW) 356.5 g/mol, 95% purity) and 3-(azidotetra (ethyleneoxy)) propionic acid succinimidyl ester, HPLC purified oligonucleotides, and ultrapure water (>18.0 MΩ·cm resistivity). Commercial QDs can be transferred from organic phase to aqueous phase and a ligand exchange can be performed to replace a portion of MPA with mPEG. The prepared MPA/mPEG co-decorated QDs can be subsequently incubated with DNA for functionalization. Organic QDs (20 μL in chloroform), chloroform (500 μL) and TOPO (40 μL, 1 g/10 mL) can be added. The mixture can be kept under inert atmosphere and incubated for 30 min. Then MPA (500 μL, 11 mM in aqueous NaOH (0.2 M)) can be added. The mixture can be vortexed and incubated for 30 s, after which the aqueous layer can be recovered. The vortex-incubation with MPA/NaOH can be repeated, for instance five times, with each aqueous layer being collected and concentrated. MPA-protected QDs can then be washed three times with ultrapure water. The QDs can then be diluted into 2 mL of ultrapure water and then incubated with mPEG (20 μL) for 4 days at room temperature (approx. 20° C.). The reacted QDs can be concentrated and washed three times using a centrifugal filter (30 kDa MWCO). The buffer can be exchanged by a NAP desalting column (GE Healthcare) into ultrapure water for further use. QD concentration can be determined by absorbance at 350 nm (extinction coefficients of QDs that emit at 520 nm, 560 nm are 1,590,000 M⁻¹ cm⁻¹, 3,500,000 M⁻¹ cm⁻¹, respectively).

To obtain monovalent DNA-functionalized QDs, monovalent DNA can be added in a molar ratio of QDs to DNA of approx. 1:1.2 into 100 μL of the QD solution (100 nM in 1×PBS buffer). The mixture can be incubated for 2 hr., and then be analyzed by gel electrophoresis to measure DNA-functionalization.

Synthesis of DNA-Functionalization on Titania NPs: titanium oxide (titania) particles with approx. 200 nm to 400 nm diameter can be prepared, for example as described in Wang et al., “Synthetic Strategies Toward DNA-Coated Colloids that Crystallize,” J. Am. Chem. Soc. Vol. 137, 2015: pp. 10760-10766, DOI: 10.1021/jacs.5b06607; and Tanaka et al., “Synthesis of highly-monodisperse spherical titania particles with diameters in the submicron range,” Journal of Colloid and Interface Science, Vol. 334, 2009: pp. 188-194, doi: 10.1016/j.jcis.2009.02.060, the entire contents of which are incorporated by reference in their entirety.

Materials: methanol, acetonitrile, ammonia solution (10 wt %), and titanium isoproproxide (TTIP), dodecyl amine (DDA).

Titania particles can be prepared by hydrolysis and condensation reaction of TTIP with ammonia or DDA as a catalyst in a co-solvent of methanol/acetonitrile. The molar compositions of the reaction mixtures can be in the range of 714 methanol/271 acetonitrile/2.8 water/1 TTIP/0-0.17 ammonia or 714 methanol/271 acetonitrile/0.8-16 water/1 TTIP/0-6.4 DDA. In a typical preparation, 0.18 ml of water can be added to 150 mL of methanol/acetonitrile solution and 0.28 g of DDA being dissolved in the solution. After stirring for 10 min, 1 mL of TTIP can be added and stirred for 12 hr. incubation period to allow for the hydrolysis and condensation reaction to proceed, and a suspension of titania particles can be obtained. The suspension was centrifuged at 1500 rpm for 10 min. The particles can be washed with methanol and centrifuged again; the process can be repeated, e.g., three times. No other sedimentation treatments need to be carried out for colloidal crystallization. The products can then be dried at 60° C. followed by calcination at 400° C. for 5 hr.

Next, after the addition of 500 μl of (3-iodopropyl) trimethoxysilane, the particles (5 ml of the particle suspension (˜1% w/v) can then be transferred to a glass vial with a magnetic stir bar and anhydrous acetonitrile for surface functionalization. The mixture can then be heated at 65° C. for 8 hr. before being quenched by cooling to room temperature (approx. 20° C.).

Particles with halogen groups on the surface can be treated with sodium azide (NaN₃) to obtain azide functional groups. A 20 mL of particle suspension (˜1% w/w) in aqueous PLURONIC F127 solution (0.25% w/w) can be added 100 mg of NaNs with a trace amount of potassium iodide. The suspension can be heated at 70° C. overnight (approx. 12 hr.). After washing by centrifugation/redispersion, the azide particles can be stored in 0.1% w/w Triton X-100 solution at 4° C.

5-NH₂-single-stranded DNA oligonucleotides with a sticky end can be modified such that the amine group can be converted to a dibenzyl cyclooctyne (DBCO) group by treating the DNA with DBCO-sulfo-NHS (Click Chemistry Tool) in phosphate buffered saline (PBS, 10 mM, pH 7.4, 100 mM sodium chloride). 33.3 μL of amine ssDNA (300 μM) can be mixed with 50 μl of 1 mM DBCO-sulfo-NHS in PBS and vigorously stirred overnight (approx. 20° C.). The modified DNA can be purified by passing through a MICROSPIN G-25 columns (GE Healthcare), diluted to 100 UM, and stored in PBS at −20° C.

Azide-functionalized particles can be first dispersed in 400 μL of PBS containing Triton X-100 (0.1% w/w) with a particle concentration of about 0.1% w/w, after which 20 μL of DBCO-DNA (100 μM) can be added, and the reaction mixture can then be stirred at 55° C. for 24 hr. The resultant particles can be washed and stored in PBS containing 1% w/w PLURONIC F127 for further use.

As illustrated in FIGS. 9 and 11, a solution containing a 10-fold stoichiometric excess of DNA-coated QDs can be mixed with the DNA origami-magnetic particle construct and incubated overnight at room temperature (approx. 12 hr at 20° C.). Unbound QDs can be removed by magnetic separation of the magnetic beads, decanting, redispersion in phosphate buffer with gentle mixing, and repeating the process until the decanted solution was optically clear by uv-vis. The QD-magnetic particle-origami assembly can be mixed with a 10-fold stoichiometric excess of DNA-coated titania and then incubated overnight at room temperature (approx. 12 hr at 20° C.). Unbound QDs can be removed by magnetic separation of the magnetic beads, decanting, redispersion in phosphate buffer with gentle mixing, and repeating the process until the decanted solution is optically clear by uv-vis.

Growth of Silica on DNA Origami-Particle Assemblies: Growth of silica on nanoparticles and microparticles can be performed, for example as described in Pastoriza-Santos and Liz-Marzán. (2013). Chapter 6: “Reliable Methods for Silica Coating of Au Nanoparticles,” In: Bergese, P., Hamad-Schifferli, K. (eds) Nanomaterial Interfaces in Biology. Methods in Molecular Biology, Vol. 1025. Humana Press, Totowa, NJ. on world wide web at: doi.org/10.1007/978-1-62703-462-3_6; Moreira et al., “Gold-core silica shell nanoparticles application in imaging and therapy: A review”, Microporous and Mesoporous Materials, Volume 270, 1 Nov. 2018, pp. 168-179, on world wide web at: doi.org/10.1016/j.micromeso.2018.05.022; Hankse et al. “Silica-Coated Plasmonic Metal Nanoparticles in Action”, Adv. Mater. 2018, 1707003, DOI: 10.1002/adma.201707003; and Sharafi et al. “Synthesis of Silica-coated Iron Oxide Nanoparticles: Preventing Aggregation without Using Additives or Seed Pretreatment”, Iranian Journal of Pharmaceutical Research (2018), 17 (1): 386-395. PMID: 29755569; PMCID: PMC5937108, the entire contents of which are incorporated herein by reference.

A protocol variant of the classic Stçber method can be performed using poly(vinylpyrrolidone), a widely used particle stabilizer, to simultaneously grow silica around the entire structure. 1 mL of a solution containing a particle-origami assembly (e.g., as synthesized in Examples 1 or 3) can be mixed 5 ml of a sonicated, aqueous solution of the polymer poly(vinylpyrrolidone) (PVP). The mixture can be gently stirred overnight at room temperature (approx. 12 hr. at 20° C.). The polymer coated particles can be centrifuged, and the supernatant can be collected, discarded. and then replaced with water. The process can be repeated until the supernatant is clear as observed by eye. The particles can then be resuspended in 8.25 mL of isopropanol, 1.44 mL of ultrapure water, 0.106 mL of NH₄OH (30% in water), and 0.204 mL of tetraethyl orthosilicate (TEOS) (5 vol. % of TEOS in isopropanol), under gentle stirring. The solution can be incubated and stirred for an additional 2 hr.

Etching of Silica to Produce a Yolk-Shell Structure: Generation of yolk-shell particles via etching can be performed, for example as described in: Purbia and Paria, “Yolk/shell nanoparticles: classifications, synthesis, properties, and applications,” Nanoscale, Vol. 7, 2015: pp. 19789-19873, on world wide web at: doi.org/10.1039/C5NR04729C; Priebe et al. “Nanorattles or Yolk-Shell Nanoparticles-What Are They, How Are They Made, and What Are They Good For?” Chemistry Europe, Vol. 21, 2015: pp. 3854-3874, on world wide web at: doi.org/10.1002/chem.201405285; Zhang, L., et al., “General Route to Multifunctional Uniform Yolk/Mesoporous Silica Shell Nanocapsules: A Platform for Simultaneous Cancer-Targeted Imaging and Magnetically Guided Drug Delivery,” Chemistry—A European Journal, Vol. 18, No. 39, 2012: pp. 12512-12521. doi: 10.1002/chem.201200030; and Watanabe, et al., “Polyethylenimine-assisted synthesis of hollow silica spheres without shape deformation,” Mater. Chem. Phys. Vol. 262, No. 124267, 2021, the entire contents of which are hereby incorporated by reference in their entirety.

A protocol follows using polyethyleneimine (PEI) as a low-temperature etchant of silica that can be used to generate hollow particles via the generation of hydroxide due to the amino groups of PEI. This process can lead to hydrolysis of the particle interior and generate soluble silicate species which then can recondense on the silica-PEI+ structures. The result is a hollow silica particle with a slightly expanded diameter.

Silica-coated particle-origami assemblies deriving from the previous Examples can be dispersed in an ethanolic solution of polyethyleneimine (PEI) (0.0025-0.01 g/L) for surface-modification of the particles. The volume fractions of the silica particles in the surface-modification process can range from 1.0×10⁻³ to 5.0×10⁻³ vol %. The particle solutions can be sonicated for 15 min, followed by stirring for 30 min at ambient temperature (approx. 20° C.). The suspensions of PEI-modified silica particles can be centrifuged at 8000 rpm for 15 min twice with ethanol and water before the silica dissolution to remove excess PEI molecules, and can then be redispersed in water. The aqueous suspensions of the PEI-modified silica particles can be stirred for 18 hr. at 50° C. for dissolution of the particle interiors. The volume fractions of the PEI-modified particles in the silica dissolution process can be the same as those in the surface modification process. After centrifugation at 8000 rpm for 15 min, the obtained hollow particles can be dispersed in water.

### Definitions

The following definitions are used in connection with the disclosure disclosed herein. Unless defined otherwise, all technical and scientific terms used herein have the same meaning as commonly understood to one of skill in the art to which this disclosure belongs.

As used herein, “a,” “an,” or “the” can mean one or more than one.

Further, the term “about” when used in connection with a referenced numeric indication means the referenced numeric indication plus or minus up to 10% of that referenced numeric indication. For example, the language “about 50” covers the range of 45 to 55.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the compositions and methods of this technology. Similarly, the terms “can” and “may” and their variants are intended to be non-limiting, such that recitation that an embodiment can or may comprise certain elements or features does not exclude other embodiments of the present technology that do not contain those elements or features.

Although the open-ended term “comprising,” as a synonym of terms such as including, containing, or having, is used herein to describe and claim the disclosure, the present disclosure, or embodiments thereof, may alternatively be described using alternative terms such as “consisting of” or “consisting essentially of.”

In embodiments, as used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

### EQUIVALENTS

While the disclosure has been described in connection with specific embodiments thereof, it will be understood that it is capable of further modifications and this application is intended to cover any variations, uses, or adaptations of the disclosure following, in general, the principles of the disclosure and including such departures from the present disclosure as come within known or customary practice within the art to which the disclosure pertains and as may be applied to the essential features hereinbefore set forth and as follows in the scope of the appended claims.

Those skilled in the art will recognize, or be able to ascertain, using no more than routine experimentation, numerous equivalents to the specific embodiments described specifically herein. Such equivalents are intended to be encompassed in the scope of the following claims.

### INCORPORATION BY REFERENCE

All patents and publications referenced herein are hereby incorporated by reference in their entireties.

The publications discussed herein are provided solely for their disclosure prior to the filing date of the present application. Nothing herein is to be construed as an admission that the present disclosure is not entitled to antedate such publication by virtue of prior disclosure.

As used herein, all headings are simply for organization and are not intended to limit the disclosure in any manner. The content of any individual section may be equally applicable to all sections.

What is claimed is:

1. A stimuli-responsive hollow yolk-shell particle (HYSP) comprising:
a) at least one multiphasic orientable yolk comprising at least two colorants and at least one stimuli-responsive element; and
b) at least one layer of a shell encapsulating the multiphasic orientable yolk, wherein at least a portion of the shell comprises a material that is transparent to at least a portion of the visible electromagnetic spectrum between about 380 nm to about 800 nm; and
wherein the multiphasic orientable yolk is configured to move inside the shell in response to an applied force.

2. The stimuli-responsive HYSP of claim 1, wherein the applied force is a magnetic field and wherein the at least one multiphasic orientable yolk is configured to rotate on its own axis upon exposure to the magnetic field.

3. The stimuli-responsive HYSP of claim 1 or 2, wherein the HYSP comprises a dimension of about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, about or at least about 20 μm, or about or at least about 50 μm;
wherein the at least one multiphasic orientable yolk comprises a dimension of about or at least about 2 nm, about or at least about 3 nm, about or at least about 4 nm, about or at least about 5 nm, about or at least about 6 nm, about or at least about 7 nm, about or at least about 8 nm, about or at least about 9 nm, about or at least about 10 nm, about or at least about 20 nm, about or at least about 30 nm, about or at least about 40 nm, about or at least about 50 nm, about or at least about 60 nm, about or at least about 70 nm, about or at least about 80 nm, about or at least about 90 nm, about or at least about 100 nm, about or at least about 150 nm, about or at least about 200 nm, about or at least about 250 nm, about or at least about 300 nm, about or at least about 350 nm, about or at least about 400 nm, about or at least about 450 nm, about or at least about 500 nm, about or at least about 550 nm, about or at least about 600 nm, about or at least about 650 nm, about or at least about 700 nm, about or at least about 750 nm, about or at least about 800 nm, about or at least about 850 nm, about or at least about 900 nm, about or at least about 950 nm, about or at least about 1000 nm (1 μm), about or at least about 2 μm, about or at least about 3 μm, about or at least about 4 μm, about or at least about 5 μm, about or at least about 6 μm, about or at least about 7 μm, about or at least about 8 μm, about or at least about 9 μm, about or at least about 10 μm, about or at least about 20 μm, or about or at least about 50 μm; and/or
wherein the at least one layer of shell comprises a thickness of about or at least about 1 nm, about or at least about 5 nm, about or at least about 10 nm, about or at least about 15 nm, about or at least about 20 nm, about or at least about 25 nm, about or at least about 30 nm, about or at least about 40 nm, about or at least about 50 nm, about or at least about 100 nm, about or at least about 200 nm, about or at least about 300 nm, about or at least about 400 nm, about or at least about 500 nm, about or at least about 600 nm, about or at least about 700 nm, about or at least about 800 nm, about or at least about 900 nm, about or at least about 1 μm, about or at least about 2 μm, about or at least about 3 μm, about or at least about 4 μm, about or at least about 5 μm, about or at least about 10 μm, about or at least about 15 μm, about or at least about 20 μm, about or at least about 25 μm, about or at least about 30 μm, about or at least about 35 μm, about or at least about 40 μm.

4. The stimuli-responsive HYSP of any one of the preceding claims, wherein the HYSP comprises a shape, geometry, and/or morphology of one or more of spherical, ellipsoidal, spindle, rodlike, cubic, starlike, cylindrical, plate, tetrahedron, and dodecahedron, and/or wherein the at least one multiphasic orientable yolk comprises a shape, geometry, and/or morphology that fits within a congruent shape, geometry, or morphology of an inner surface of at least one layer of the shell.

5. The stimuli-responsive HYSP of any one of the preceding claims, wherein the at least one multiphasic orientable yolk comprises a material comprising one or more of metals, metal oxides, silica, organic polymers, inorganic polymers, biological polymers, synthetic polymers, and combinations thereof;
optionally wherein the one or more biological polymers comprises nucleic acid (DNA, RNA), amino acid (peptide, protein), polysaccharide, and/or lipid.

6. The stimuli-responsive HYSP of any one of the preceding claims, wherein the at least one multiphasic orientable yolk is coated with a protective coating;
wherein the protective coating comprises a chemical functionalization, lubricant, surface treatment, coating, polishing agent, and/or combinations thereof;
optionally wherein the protective coating comprises silica, polymeric materials, inorganic oxides, carbon materials, polytetrafluoroethylene (PTFE), hydroxylated self-assembled monolayers, vitreous enamel, ceria (cerium oxide), ceramic, anodized metal, and/or combinations thereof.

7. The stimuli-responsive HYSP of any one of the preceding claims, wherein the at least one multiphasic orientable yolk is a solid nanoparticle, optionally suspended in a fluid media, a semi-solid media, non-Newtonian fluid or media, and/or a combination thereof, and configured to move in the response to a magnetic field; or wherein the at least one multiphasic orientable yolk comprises a fluid, ferrofluid, semi-solid, and/or non-Newtonian fluid.

8. The stimuli-responsive HYSP of any one of the preceding claims, wherein the at least one stimuli-responsive element comprises a magnetic material and/or comprises material configured to be magnetized and/or produce a magnetic field;
optionally wherein the magnetic material is ferromagnetic, ferrimagnetic, antiferromagnetic, diamagnetic, paramagnetic, superparamagnetic, and/or antiferromagnetic;
optionally wherein the magnetic material comprises iron (Fe), cobalt (Co), nickel (Ni), zinc (Zn), manganese (Mn), chromium (Cr), samarium (Sm), gold (Au), silver (Au), alloys or oxides thereof; alloys, intermetallic, and/or oxides of Fe, Co, Ni, Zn, Mn, Sm, Ag, Au; oxides of iron, Fe₂O₃, FeO, and/or Fe₃O₄; ferrite material and/or doped materials of Co, Ni, Zn, and/or Mn:FexOy, and/or magnetite; and/or
optionally wherein the magnetic material is organic, carbon-based, and/or biomolecule-based.

9. The stimuli-responsive HYSP of claim 8, wherein the magnetic material comprises magnetic particles and/or beads, optionally wherein the magnetic particles and/or beads comprise a dimension of about or at least about 5 nm, about or at least about 10 nm, about or at least about 50 nm, about or at least about 100 nm, about or at least about 500 nm, about or at least about 1 μm, about or at least about 5 μm, about or at least about 10 μm, about or at least about 50 μm, or comprise a range of dimensions from about or at least about 5 nm to about or at least about 50 nm, about or at least about 5 nm to about or at least about 100 nm, about or at least about 5 nm to about or at least about 500 nm, about or at least about 5 rim to about or at least about 1,000 nm, about or at least about 5 nm to about or at least about 2,000 nm, about or at least about 5 nm to about or at least about 5,000 nm, about or at least about 10 nm to about or at least about 5,000 nm, about or at least about 100 nm to about or at least about 5,000 nm, about or at least about 1,000 nm to about or at least about 5,000 nm.

10. The stimuli-responsive HYSP of claim 8 or 9, wherein the magnetic material is configured to create a magnetic field of about or at least about 200 gauss, about or at least about 500 gauss, about or at least about 800 gauss, about or at least about 1,000 gauss, about or at least about 2,500 gauss, about or at least about 12,500 gauss, about or at least about 15,000 gauss, about or at least about 20,000 gauss, or about or at least about 25,000 gauss; or a magnetic field having a range of about or at least about 200 gauss to about or at least about 25,000 gauss.

11. The stimuli-responsive HYSP of any one of the preceding claims, wherein the at least two colorants comprise a color in the visible electromagnetic spectrum comprising an extinction, absorption, emission, reflectance, scattering, and/or interference at a wavelength from about or at least about 350 nm to about or at least about 800 nm, optionally wherein the color comprises one or more of white, black, red, orange, yellow, green, blue, indigo, violet, and variations of hue, shade, and intensity therebetween.

12. The stimuli-responsive HYSP of any one of the preceding claims, wherein the at least two colorants comprise a dye, pigment, stain, fluorophore, metallic salt, and/or chromophore, optionally wherein the at least two colorants comprise one or more of a transparent effect pigment, goniochromatic pigment, pearlescent pigment, metallic pigment, interference pigment, metallic effect pigment, fluorescent pigment, luminescent pigment, phosphorescent pigment, magnetic pigment, and anticorrosive pigment.

13. The stimuli-responsive HYSP of any one of the preceding claims, wherein the at least one layer of shell comprises at least a portion that is optically opaque and absorbs, deflects, blocks, and/or scatters light in at least a portion of the visible electromagnetic range of about 380 nm to about 800 nm.

14. The stimuli-responsive HYSP of any one of the preceding claims, wherein the at least one layer of shell comprises a material comprising one or more of glass, quartz, plastic, polyethylene terephthalate, polycarbonate, polymethyl methacrylate (acrylic), polyethylene, polyurethane, polypropylene, thermoplastic elastomers (TPE), acrylonitrile butadiene styrene (ABS), epoxies and epoxy-based photoresists, hydrogels, cyclic olefin copolymer (COC) cyclic olefin polymer (COP), poly dimethyl siloxane (PDMS), poly ether ester ketone (PEEK), polyetherimide (ULTEM), nylon, thermally responsive polymer, and combinations thereof;
optionally wherein the at least one layer of shell is composed of and/or has disposed thereon one or more of polysaccharides, lipids, amino acids, DNA, RNA, plastics, thermally responsive polymers, hydrocarbon, crude oil, or petroleum derivatives, and combinations thereof;
optionally wherein the at least one layer of shell comprises one or more indentations, grooves, and spaces located on an internal surface to affix the at least one orientable multiphasic yolk; and/or
optionally wherein the at least one layer of shell comprises one or more materials to reduce friction between an internal surface and the at least one orientable multiphasic yolk.

15. A method of manufacturing a hollow yolk-shell particle (HYSP) of any one of claims 1-14 comprising:
i) preparing at least one multiphasic orientable yolk, wherein the at least one multiphasic orientable yolk comprises at least two colorants and at least one stimuli-responsive element;
ii) forming a dissolution layer disposed on the at least one multiphasic orientable yolk;
iii) forming at least one layer of a shell encapsulating the multiphasic orientable yolk, wherein the at least one layer of shell comprises pores;
iv) repositioning the dissolution layer through the pores in the at least one layer of shell to form a cavity between the at least one multiphasic orientable yolk and the at least one layer of a shell; and
v) hardening the at least one layer of a shell to form a non-porous shell,
wherein the multiphasic orientable yolk is configured to move inside the shell in response to an applied force.

16. The method of claim 15, wherein the applied force is a magnetic field, and wherein the at least one multiphasic orientable yolk is configured to rotate on its own axis upon exposure to the magnetic field.

17. The method of claim 15 or 16, further comprising applying a coating to the at least one multiphasic orientable yolk prior to forming the dissolution layer, optionally wherein the coating comprises one or more of a protective coating, a chemical functionalization, lubricant, surface treatment, and/or polishing agent.

18. The method of any one of claims 15-17, further comprising forming one or more additional shells encapsulating the at least one layer of shell.

19. The method of any one of claims 15-18, further comprising disposing one or more materials into the cavity formed from the removing, optionally wherein the one or more materials comprise thermally responsive polymers and/or a fluid media.

20. The method of any one of claims 15-19, wherein one or more of: i) preparing at least one multiphasic orientable yolk, ii) forming a dissolution layer, and iii) forming at least one layer of a shell comprises assembling, gluing, and/or affixing two or more components; injection molding, and/or micro-injection molding; self-assembly, adsorption, coacervation, and/or mixing; polymerization, extrusion, and/or manipulation of polymers; additive manufacturing, CNC machining (Computer Numerical Control machining), urethane casting, microcontact printing, dip pen lithography, beam pen lithography, photolithography, e-beam lithography, and/or 3D printing.

21. The method of any one of claims 15-20, wherein forming the at least one layer of shell comprises performing one or more of mesoporous material synthesis, soft-templating, calcination, and/or extraction, optionally wherein the at least one layer of shell comprising pores comprises a mesoporous silica and/or a porous organic framework.

22. The method of any one of claims 15-21, wherein repositioning the dissolution layer comprises dissolving, removing, and/or etching the dissolution layer.

23. The method of any one of claims 15-22, wherein hardening the at least one layer of a shell to form a non-porous shell comprises compacting and forming a solid mass of shell material by heat and/or pressure.

24. The method of any one of claims 15-23, wherein preparing the at least one multiphasic orientable yolk comprises a DNA origami technique, optionally wherein the DNA origami technique comprises self-assembly of at least two DNA-coated colorants and at least one DNA-coated stimuli-responsive element.

25. The method of any one of claims 15-24, wherein one or more of the at least one multiphasic orientable yolk, the dissolution layer, and the at least one layer of shell comprises one or more of a thermally responsive polymer, resin, metal, ceramic, glass, quartz, plastic, polyethylene terephthalate, polycarbonate, polymethyl methacrylate (acrylic), polyethylene, polyurethane, polypropylene, thermoplastic elastomers (TPE), acrylonitrile butadiene styrene (ABS), epoxies and epoxy-based photoresists, hydrogels, cyclic olefin copolymer (COC) cyclic olefin polymer (COP), poly dimethyl siloxane (PDMS), poly ether ester ketone (PEEK), polyetherimide (ULTEM), nylon, and combinations thereof, optionally wherein the one or more thermally responsive polymers and resins comprise one or more of poloxamers, styrene-butadiene block copolymers, polymethylmethacrylate, polybutylmethacrylate, plasticized polyvinyl chloride, plasticized nylon, plasticized polyethylene terephthalate, polyethylene, polyacrylonitrile, polychlorotrifluoroethylene, poly-4,4′-isopropylidenediphenylene carbonate, polyethylene vinyl ester, polyvinyl chloride-diethyl fumarate, and combinations thereof.

26. The method of any one of claims 15-25, wherein preparing the at least one multiphasic orientable yolk comprises forming Janus particles, optionally wherein the Janus particles comprise one or more of poly(tert-butyl acrylate)-poly(3-(triethoxysilyl)propyl methacrylate) (PtBA-PTPM), polystyrene latex polymer, carboxylated latex polymer, aminated latex polymer, colored polystyrene polymer (dye-infused and/or pigment-infused), colored polystyrene-based carboxylated latex polymer (dye-infused and/or pigment-infused), fluorescent polystyrene-based polymers, fluorescent polystyrene-based carboxylated latex polymers, fluorescent aminated polystyrene-based polymer, surfactant-free polystyrene, carboxylated surfactant-free polymer, polymethyl methacrylate (PMMA) latex polymer, divinylbenzene (DVB)-crosslinked polystyrene latex polymer, and combinations thereof.

27. The method of any one of claims 15-26, further comprising formulating the HYSP into:
a fluid, suspension, ink, liquid film, and/or adhesive substrate and/or material, optionally wherein the fluid, suspension, ink, liquid film, and/or adhesive substrate and/or material is suitable to be applied to a surface of an object;
a foil, film, thin plastic, and/or paper substrate and/or material, optionally wherein the foil, film, thin plastic, and/or paper substrate and/or material is suitable to be affixed to, or embedded in, an object; or
a fiber, thread, yarn, and/or twine substrate and/or material, optionally wherein the fiber, thread, yarn, and/or twine substrate, material, and/or surface is suitable to be woven into an article of clothing, a cloth, and/or a tarp.

28. A method of using a hollow yolk-shell particle (HYSP) of any one of claims 1-14 comprising:
a) providing the HYSP of any one of claims 1-14;
b) formulating the HYSP into:
i) a fluid, suspension, ink, liquid film, and/or adhesive substrate and/or material;
ii) a foil, film, thin plastic, and/or paper substrate and/or material; or
iii) a fiber, thread, yarn, and/or twine substrate and/or material; and
c) applying the formulation to an object and/or surface,
wherein the object and/or surface exhibits optical property changing properties as a function of the application of a magnetic field.

29. The method of claim 28, wherein applying further comprises spraying, gluing, weaving, embedding, writing, printing, and/or blotting.

30. The method of claim 28 or 29, wherein the object is polymer, paper, fabric, metal, clay board, ceramic, window, glass, plastic, computer chip, wood, construction material, and/or human or animal tissue.

31. A method of authenticating a material comprising:
a) providing a formulation of an HYSP of any one of claims 1-14, wherein the formulation comprises:
i) a fluid, suspension, ink, liquid film, and/or adhesive substrate and/or material;
ii) a foil, film, thin plastic, and/or paper substrate and/or material; or
iii) a fiber, thread, yarn, and/or twine substrate and/or material; and
c) tagging an object and/or surface with the formulation; and
d) reading the tagging.

32. The method of claim 31, wherein the tagging is configured to be read by a sensor and/or optical imaging device.

33. The method of claim 31 or 32, wherein the reading comprises applying a magnetic field to determine an optical property change in the object and/or surface due to the presence of the HYSP.
